(19) United States
(12) Patent Application Publication
(10) Pub. No.: US 2024/0406710 A1
(43) Pub. Date: Dec. 5, 2024

(54) METHOD AND APPARATUS FOR TRANSMITTING UE CAPABILITY REPORT ON MULTIPLE TIMING ADVANCE AND SIMULTANEOUS TRANSMISSION OF MULTIPLE PANELS IN WIRELESS COMMUNICATION SYSTEM

(71) Applicant: SAMSUNG ELECTRONICS CO., LTD., Suwon-si (KR)

(72) Inventors: Seongmok LIM, Suwon-si (KR); Ameha Tsegaye ABEBE, Suwon-si (KR); Youngrok JANG, Suwon-si (KR); Hyoungju JI, Suwon-si (KR); Kyungjun CHOI, Suwon-si (KR); Heedon GHA, Suwon-si (KR); Taehan BAE, Suwon-si (KR)

(21) Appl. No.: 18/661,445

(22) Filed: May 10, 2024

(30) Foreign Application Priority Data
May 12, 2023 (KR) 10-2023-0062010

(51) Int. Cl. H04W 8/20; H04L 5/00

(52) U.S. Cl. CPC H04W 8/20; H04L 5/0035; H04L 5/0051

(57) ABSTRACT

The disclosure relates to a 5G or 6G communication system for supporting a higher data transmission rate. The disclosure relates to a method of reporting a UE capability and an apparatus for performing the same in a wireless communication system. In accordance with an aspect of the disclosure, a method performed by a user equipment (UE) in a wireless communication system is provided. The method includes: transmitting, to a base station, UE capability information indicating that the UE supports a receiving (Rx) timing difference larger than a cyclic prefix (CP) length; and performing a parallel processing for multi-transmission and reception point (TRP) transmission and/or reception, wherein each of the multi-TRP is associated with a respective timing advance (TA), wherein the Rx timing difference is a period between a first downlink (DL) reference timing and a second DL reference timing.

### CROSS-REFERENCE TO RELATED APPLICATION

This application is based on and claims priority under 35 U.S.C. § 119 to Korean Patent Application No. 10-2023-0062010, filed on May 12, 2023, in the Korean Intellectual Property Office, the disclosure of which is herein incorporated by reference in its entirety.

### BACKGROUND

### 1. Field

The disclosure relates to operations of a user equipment (UE) and a base station (BS) in a wireless communication system. More particularly, the disclosure relates to a method of reporting a UE capability and an apparatus for performing the same in a wireless communication system.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Disclosed embodiments provide a method of reporting UE capability information in a wireless communication system and an apparatus thereof.

In accordance with an aspect of the disclosure, a method performed by a user equipment (UE) in a wireless communication system is provided. The method includes: transmitting, to a base station, UE capability information indicating that the UE supports a receiving (Rx) timing difference larger than a cyclic prefix (CP) length; and performing a parallel processing for multi-transmission and reception point (TRP) transmission and/or reception, wherein each of the multi-TRP is associated with a respective timing advance (TA), wherein the Rx timing difference is a period between a first downlink (DL) reference timing and a second DL reference timing.

In accordance with an aspect of the disclosure, a method performed by a base station in a wireless communication system is provided. The method includes: receiving, from a user equipment (UE), UE capability information indicating that the UE supports a receiving (Rx) timing difference larger than a cyclic prefix (CP) length; scheduling multi-transmission and reception point (TRP) transmission and/or reception for the UE; and performing transmission and/or reception for the UE based on the multi-TRP scheduling, wherein the Rx timing difference is a period between a first downlink (DL) reference timing and a second DL reference timing.

In accordance with an aspect of the disclosure, a user equipment (UE) in a wireless communication system is provided. The UE includes: at least one transceiver; and at least one controller coupled with the at least one transceiver and configured to: transmit, to a base station, UE capability information indicating that the UE supports a receiving (Rx) timing difference larger than a cyclic prefix (CP) length; and perform a parallel processing for multi-transmission and reception point (TRP) transmission and/or reception, wherein each of the multi-TRP is associated with a respective timing advance (TA), wherein the Rx timing difference is a period between a first downlink (DL) reference timing and a second DL reference timing

In accordance with an aspect of the disclosure, a base station in a wireless communication system is provided. The base station includes: at least one transceiver; and at least one controller coupled with the at least one transceiver and configured to: receive, from a user equipment (UE), UE capability information indicating that the UE supports a receiving (Rx) timing difference larger than a cyclic prefix (CP) length; schedule multi-transmission and reception point (TRP) transmission and/or reception for the UE; and perform transmission and/or reception for the UE based on the multi-TRP scheduling, wherein the Rx timing difference is a period between a first downlink (DL) reference timing and a second DL reference timing.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency domain in a wireless communication system according to an embodiment of the disclosure;

FIG. 2 illustrates a structure of frames, subframes, and slots in a wireless communication system according to an embodiment of the disclosure;

FIG. 3 illustrates an example of bandwidth part configuration in a wireless communication system according to an embodiment of the disclosure;

FIG. 4 illustrates radio protocol structures of a base station and a UE in single cell, carrier aggregation, and dual connectivity situations according to an embodiment of the disclosure;

FIG. 5 illustrates an example of a UL/DL configuration in a wireless communication system according to an embodiment of the disclosure;

FIG. 6 illustrates an absolute timing advance command MAC CE format according to an embodiment of the disclosure;

FIG. 7 illustrates a timing advance command MAC CE format according to an embodiment of the disclosure;

FIG. 8 illustrates time difference between a downlink frame and an uplink frame when timing advance is applied according to an embodiment of the disclosure;

FIG. 9 illustrates an example of base station beam allocation according to TCI state configuration in a wireless communication system according to an embodiment of the disclosure;

FIG. 10 illustrates an example of a beam application time when a unified TCI scheme is used in a wireless communication system according to an embodiment of the disclosure;

FIG. 11 illustrates another MAC-CE format for activating and indicating a joint TCI state or a separate DL or UL TCI state in a wireless communication system according to an embodiment of the disclosure;

FIG. 12 illustrates an example of control resource set configuration with regard to a downlink control channel in a wireless communication system according to an embodiment of the disclosure;

FIG. 13 illustrates a structure of a downlink control channel in a wireless communication system according to an embodiment of the disclosure;

FIG. 14 illustrates an example of frequency domain resource allocation with regard to a PDSCH in a wireless communication system according to an embodiment of the disclosure;

FIG. 15 illustrates an example of time domain resource allocation with regard to a PDSCH in a wireless communication system according to an embodiment of the disclosure;

FIG. 16 illustrates a process for beam configuration and activation with regard to a PDSCH;

FIG. 17 illustrates an example of a MACCE for activating the spatial relation based on a PUCCH resource group in a wireless communication system according to an embodiment of the disclosure.

FIG. 18 illustrates an example of a PUSCH repeated transmission type B in a wireless communication system according to an embodiment of the disclosure;

FIG. 19 illustrates a MAC CE format including single PHR information according to an embodiment of the disclosure;

FIG. 20 illustrates a MAC CE format including a plurality of pieces of PHR information according to an embodiment of the disclosure;

FIG. 21 illustrates a configuration of antenna ports and an example of resource allocation for cooperative communication in a wireless communication system according to an embodiment of the disclosure;

FIG. 22 illustrates an example for a configuration of downlink control information (DCI) for cooperative communication in a wireless communication system according to an embodiment of the disclosure;

FIG. 23 illustrates an enhanced PDSCH TCI state activation/deactivation MAC-CE format according to an embodiment of the disclosure;

FIG. 24 illustrates another MAC-CE format for activating and indicating a plurality of joint TCI states or separate DL or UL TCI states in a wireless communication system according to an embodiment of the disclosure;

FIG. 25 illustrates another MAC-CE format for activating and indicating a plurality of joint TCI states or separate DL or UL TCI states in a wireless communication system according to an embodiment of the disclosure;

FIG. 26 illustrates an example of supporting multiple TRPs based on multiple DCI by using a plurality of Tas according to an embodiment of the disclosure;

FIG. 27 illustrates an example of scheduling of simultaneous uplink transmission of PUSCHs through respective panels based on multiple DCI according to an embodiment of the disclosure;

FIG. 28 illustrates is a flowchart of an operation of a UE for supporting a multi-TRP transmission and reception scheme based on a plurality of Tas or a simultaneous uplink transmission scheme based on multiple panels in a multi-DCI system according to an embodiment of the disclosure;

FIG. 29 illustrates a flowchart of an operation of a BS for supporting a multi-TRP transmission and reception scheme based on a plurality of TAs or a simultaneous uplink transmission scheme based on multiple panels in a multi-DCI system according to an embodiment of the disclosure;

FIG. 30 illustrates a structure of a UE in a wireless communication system according to an embodiment of the disclosure; and

FIG. 31 illustrates a structure of a BS in a wireless communication system according to an embodiment of the disclosure.

### DETAILED DESCRIPTION

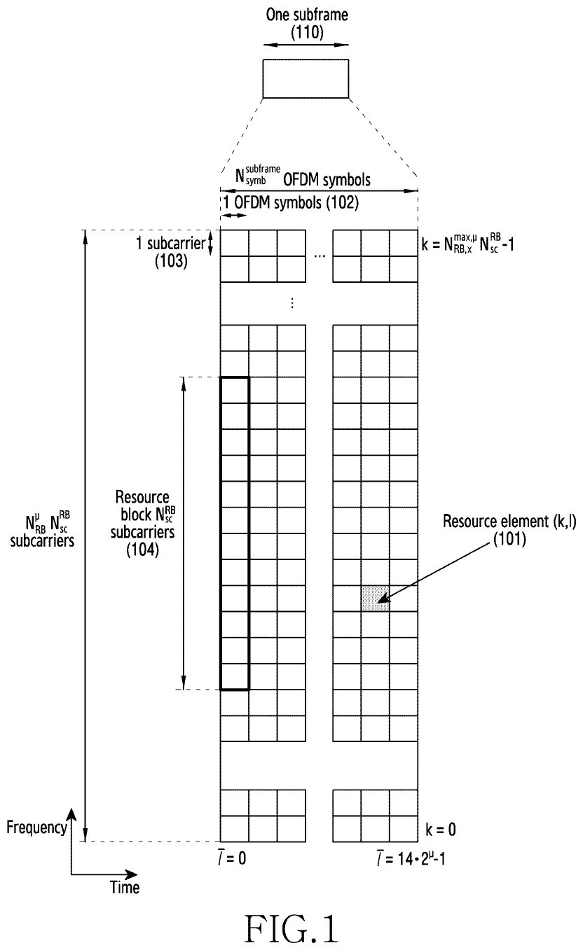

FIGS. 1 through 31, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings. In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are provided with the same or corresponding reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types to the embodiments of the disclosure. Examples of such communication systems may include 5^{th} generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” or may be implemented to reproduce one or more CPUs within a device or a security multimedia card. Furthermore, the “unit” in the embodiments may include one or more processors.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink indicates a radio link through which a user equipment (UE) or a mobile station (MS) transmits data or control signals to a base station (BS) or eNode B, and the downlink indicates a radio link through which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km² in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time, such as 10 to 15 years, because it is difficult to frequently replace the battery of the UE.

Lastly, URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and also requires a packet error rate of 10-5 or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

In the following description, the term “a/b” may be understood as at least one of a and b.

### [NR Time-Frequency Resources]

Hereinafter, a frame structure of a 5G system will be described in more detail with reference to the accompanying drawings.

FIG. 1 illustrates a basic structure of a time-frequency domain in a wireless communication system according to an embodiment of the disclosure. Specifically, FIG. 1 illustrates ae basic structure of a time-frequency domain, which is a radio resource domain used to transmit data or control channels, in a 5G system.

In FIG. 1, the horizontal axis denotes a time domain, and the vertical axis denotes a frequency domain. The basic unit of resources in the time and frequency domains is a resource element (RE) 101, which may be defined as one orthogonal frequency division multiplexing (OFDM) symbol 102 along the time axis and one subcarrier 103 along the frequency axis. In the frequency domain, N_{SC}^{RB}. (for example, 12) consecutive REs may constitute one resource block (RB) 104. In the time domain, one subframe 110 may include multiple OFDM symbols 102. For example, the length of one subframe may be 1 ms.

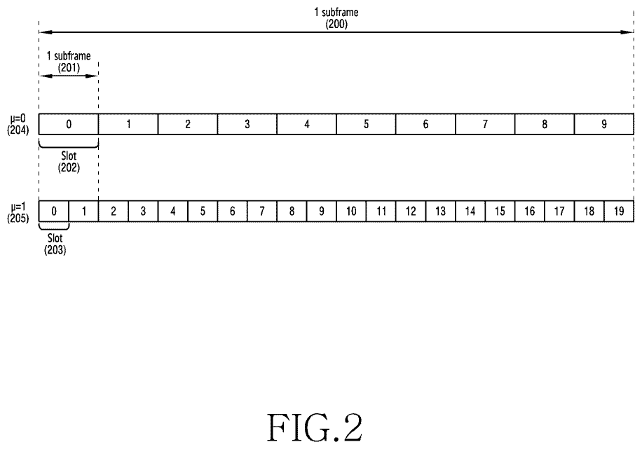

FIG. 2 illustrates a structure of frames, subframes, and slots in a wireless communication system according to an embodiment of the disclosure.

FIG. 2 illustrates an example of a structure of a frame 200, a subframe 201, and a slot 202. One frame 200 may be defined as 10 ms. One subframe 201 may be defined as 1 ms, and thus, one frame 200 may include a total of ten subframes 201. One slot 202 or 203 may be defined as 14 OFDM symbols (that is, the number of symbols per one slot N_{symb}^{slot}=14). One subframe 201 may include one or multiple slots 202 and 203, and the number of slots 202 and 203 per one subframe 201 may vary depending on configuration values u for the subcarrier spacing 204 or 205. The example in FIG. 2 illustrates a case in which the subcarrier spacing configuration value is μ=0 (204), and a case in which μ=1 (205). In the case of u-0 (204), one subframe 201 may include one slot 202, and in the case of μ=1 (205), one subframe 201 may include two slots 203. That is, the number of slots per one subframe Nₛₗₒₜ^{subframe,μ} may differ depending on the subcarrier spacing configuration value μ, and the number of slots per one frame Nₛₗₒₜ^{frame,μ} differ accordingly. Nₛₗₒₜ^{sunframe,μ} and Nₛₗₒₜ^{frame,μ} may be defined according to each subcarrier spacing configuration u as in Table 1 below.

TABLE 1

| μ | N_{symb}^{slot} | Nₛₗₒₜ^{frame,μ} | Nₛₗₒₜ^{subframe,μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

Next, bandwidth part (BWP) configuration in a 5G communication system will be described in detail with reference to the accompanying drawings.

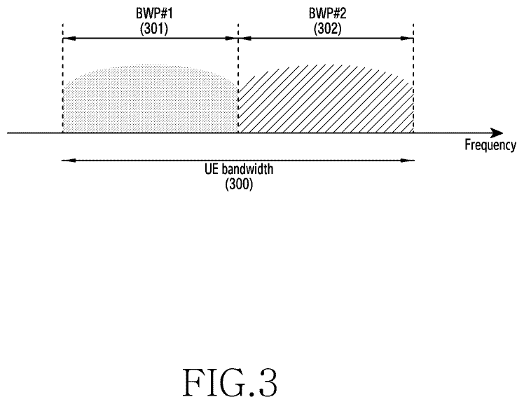

FIG. 3 illustrates an example of bandwidth part configuration in a wireless communication system according to an embodiment of the disclosure.

FIG. 3 illustrates an example in which a UE bandwidth 300 is configured to include two bandwidth parts, that is bandwidth part #1 (BWP #1) 301 and bandwidth part #2 (BWP #2) 302. A base station may configure one or multiple bandwidth parts for a UE, and may configure the following pieces of information with regard to each bandwidth part.

TABLE 2

| | |
|---|---|
| BWP ::= | SEQUENCE { |
| bwp-Id | BWP-Id, |

(bandwidth part identifier)

| | |
|---|---|
| locationAndBandwidth | INTEGER (1..65536), |

(bandwidth part location)

| | |
|---|---|
| subcarrierSpacing | ENUMERATED {n0, n1, n2, n3, n4, n5}, |

(subcarrier spacing)

| | |
|---|---|
| cyclicPrefix | ENUMERATED { extended } |

(cyclic prefix)
}

Obviously, the above example is not limiting, and various parameters related to the bandwidth part may be configured for the UE, in addition to the above configuration information. The pieces of information in the above example may be transferred from the base station to the UE through upper layer signaling (for example, radio resource control (RRC) signaling). One configured bandwidth part or at least one bandwidth part among multiple configured bandwidth parts may be activated. Whether or not to activate a configured bandwidth part may be transferred from the base station to the UE semi-statically through RRC signaling, or dynamically

According to an embodiment, before a radio resource control (RRC) connection, an initial bandwidth part (BWP) for initial access may be configured for the UE by the base station through a master information block (MIB). To be more specific, the UE may receive configuration information regarding a control resource set (CORESET) and a search space, which may be used to transmit a PDCCH for receiving system information (remaining system information (RMSI) or system information block 1 (SIB1)) necessary for initial access, through the MIB in the initial access step. Each of the control resource set and the search space configured through the MIB may be considered as identity (ID) 0. The base station may notify the UE of configuration information, such as frequency assignment information, time assignment information, and numerology, regarding control resource set #0 through an MIB. In addition, the base station may notify the UE of configuration information regarding the monitoring cycle and occasion of control resource set #0 (for example, configuration information regarding search space 0) through the MIB. The UE may consider that a frequency domain configured by control resource set #0 acquired from the MIB is an initial bandwidth part for initial access. The ID of the initial bandwidth part may be considered to be 0.

The bandwidth part-related configuration supported by 5G may be used for various purposes.

According to an embodiment, if the bandwidth supported by the UE is smaller than the system bandwidth, this may be supported through the bandwidth part configuration. For example, the base station may configure the frequency location (for example, configuration information 2) of the bandwidth part for the UE such that the UE can transmit/receive data at a specific frequency location within the system bandwidth.

In addition, according to some embodiments, the base station may configure multiple bandwidth parts for the UE for the purpose of supporting different numerologies. For example, in order to support a UE's data transmission/reception using both a subcarrier spacing of 15 kHz and a subcarrier spacing of 30 kHz, two bandwidth parts may be configured as subcarrier spacings of 15 kHz and 30 kHz, respectively. Different bandwidth parts may be subjected to frequency division multiplexing (FDM), and when data is to be transmitted/received at a specific subcarrier spacing, the bandwidth part configured as the corresponding subcarrier spacing may be activated.

In addition, according to an embodiment, the base station may configure bandwidth parts having different sizes of bandwidths for the UE for the purpose of reducing power consumed by the UE. For example, if the UE supports a substantially large bandwidth (for example, 100 MHz) and always transmits/receives data with the corresponding bandwidth, a substantially large amount of power consumption may occur. Particularly, it may be substantially inefficient from the viewpoint of power consumption to unnecessarily monitor the downlink control channel with a large bandwidth of 100 MHz in the absence of traffic. In order to reduce power consumed by the UE, the base station may configure a bandwidth part of a relatively small bandwidth (for example, a bandwidth part of 20 MHz) for the UE. The UE may perform a monitoring operation in the 20 MHz bandwidth part in the absence of traffic, and may transmit/receive data with the 100 MHz bandwidth part as instructed by the base station if data has occurred.

In connection with the bandwidth part configuration method, UEs, before being RRC-connected, may receive configuration information regarding the initial bandwidth part (initial BWP) through a master information block (MIB) in the initial access step. To be more specific, a UE may have a control resource set (CORESET) configured for a downlink control channel, which may be used to transmit downlink control information (DCI) for scheduling a system information block (SIB), from the MIB of a physical broadcast channel (PBCH). The bandwidth of the control resource set configured by the MIB may be considered as the initial bandwidth part, and the UE may receive, through the configured initial bandwidth part, a physical downlink shared channel (PDSCH) through which an SIB is transmitted. The initial bandwidth part may be used not only for the purpose of receiving the SIB, but also for other system information (OSI), paging, random access, or the like.

### [Bandwidth Part (BWP) Change]

If a UE has one or more bandwidth parts configured therefor, the base station may instruct to the UE to change (or switch) the bandwidth parts by using a bandwidth part indicator field inside DCI. As an example, if the currently activated bandwidth part of the UE is bandwidth part #1 301 in FIG. 3, the base station may indicate bandwidth part #2 302 with a bandwidth part indicator inside DCI, and the UE may change the bandwidth part to bandwidth part #2 302 indicated by the bandwidth part indicator inside received DCI.

As described above, DCI-based bandwidth part changing may be indicated by DCI for scheduling a PDSCH or a PUSCH, and thus, upon receiving a bandwidth part change request, the UE needs to be able to receive or transmit the PDSCH or PUSCH scheduled by the corresponding DCI in the changed bandwidth part with no problem. To this end, requirements for the delay time (T_{BWP}) required during a bandwidth part change are specified in standards, and may be defined, for example, as follows.

TABLE 3

| | | BWP switch delay | |
|---|---|---|---|
| | NR Slot | TBWP (slots) | |
| μ | length (ms) | Type 1^{Note 1} | Type 2^{Note 1} |
| 0 | 1 | 1 | 3 |
| 1 | 0.5 | 2 | 5 |
| 2 | 0.25 | 3 | 9 |
| 3 | 0.125 | 6 | 18 |

Note 1:
Depends on UE capability.
Note 2:
If the BWP switch involves changing of SCS, the BWP switch delay is determined by the larger one between the SCS before BWP switch and the SCS after BWP switch.

The requirements for the bandwidth part change delay time may support type 1 or type 2, depending on the capability of the UE. The UE may report the supportable bandwidth part delay time type to the base station.

If the UE has received DCI including a bandwidth part change indicator in slot n, according to the above-described requirement regarding the bandwidth part change delay time, the UE may complete a change to the new bandwidth part indicated by the bandwidth part change indicator at a timepoint not later than slot n+T_{BWP}. In addition, the UE may transmit/receive a data channel scheduled by the corresponding DCI in the newly changed bandwidth part. If the base station wants to schedule a data channel by using the new bandwidth part, the base station may determine time domain resource allocation regarding the data channel in consideration of the UE's bandwidth part change delay time (T_{BWP}). For example, when scheduling a data channel by using the new bandwidth part, the base station may schedule the corresponding data channel after the bandwidth part change delay time, in connection with the method for determining time domain resource allocation regarding the data channel. Accordingly, the UE may not expect that the DCI that indicates a bandwidth part change may indicate a slot offset (K0 or K2) value smaller than the bandwidth part change delay time (T_{BWP}).

For example, if the UE has received DCI (for example, DCI format 1_1 or 0_1) indicating a bandwidth part change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a bandwidth part change in slot n, and if the slot offset value indicated by the corresponding DCI is K, the UE may perform no transmission or reception from the third symbol of slot n to the symbol before slot n+K (for example, the last symbol of slot n+K−1).

### [Regarding CA/DC]

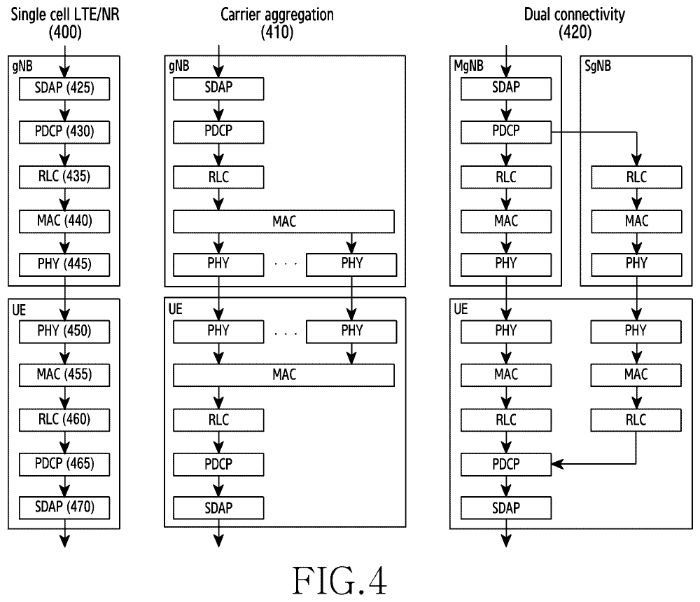

FIG. 4 illustrates radio protocol structures of a base station and a UE in single cell, carrier aggregation, and dual connectivity situations according to an embodiment of the disclosure.

Referring to FIG. 4, a radio protocol of a wireless communication system may include NR service data adaptation protocols (SDAPs) S25 and S70, NR packet data convergence protocols (PDCPs) S30 and S65, NR radio link controls (RLCs) S35 and S60, and NR medium access controls (MACs) S40 and S55, in a UE and an NR base station, respectively.

The main functions of the NR SDAPs S25 and S70 may include at least one of the following functions:
Transfer of user plane data;
Mapping between a QoS flow and a DRB for both DL and UL;
Marking QoS flow ID in both DL and UL packets; and/or
Reflective QoS flow to DRB mapping for the UL SDAP PDUs.

With respect to the SDAP layer device, whether to use a header of the SDAP layer device or whether to use a function of the SDAP layer device for each PDCP layer device, each bearer, or each logical channel may be configured for the UE through an RRC message. If an SDAP header is configured, the NAS QoS reflection configuration 1-bit indicator (NAS reflective QoS) of the SDAP header and the AS QoS reflection configuration 1-bit indicator (AS reflective QoS) thereof may be indicated by the base station, so that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

The main functions of the NR PDCPs S30 and S65 may include at least one of the following functions:
Header compression and decompression: ROHC only;
Transfer of user data;
In-sequence delivery of upper layer PDUs;
Out-of-sequence delivery of upper layer PDUs;
PDCP PDU reordering for reception;
Duplicate detection of lower layer SDUs;
Retransmission of PDCP SDUs;
Ciphering and deciphering; and/or
Timer-based SDU discard in uplink.

The above-mentioned reordering function of the NR PDCP device may refer to a function of reordering PDCP PDUs received from a lower layer in an order based on the PDCP sequence number (SN), and may include a function of transferring data to an upper layer in the reordered sequence. Alternatively, the reordering function of the NR PDCP device may include a function of instantly transferring data without considering the order, may include a function of recording PDCP PDUs lost as a result of reordering, may include a function of reporting the state of the lost PDCP PDUs to the transmitting side, or may include a function of requesting retransmission of the lost PDCP PDUs.

The main functions of the NR RLCs S35 and S60 may include at least one of the following functions:
Transfer of upper layer PDUs;
In-sequence delivery of upper layer PDUs;
Out-of-sequence delivery of upper layer PDUs;
Error Correction through ARQ;
Concatenation, segmentation and reassembly of RLC SDUs;
Re-segmentation of RLC data PDUs;
Reordering of RLC data PDUs;
Duplicate detection;
Protocol error detection;
RLC SDU discard; and/or
RLC re-establishment.

The above-mentioned in-sequence delivery of the NR RLC device may refer to a function of successively delivering RLC SDUs received from the lower layer to the upper layer. The in-sequence delivery of the NR RLC device may include a function of reassembling and delivering multiple RLC SDUs received, into which one original RLC SDU has been segmented, may include a function of reordering the received RLC PDUs with reference to the RLC sequence number (SN) or PDCP sequence number (SN), may include a function of recording RLC PDUs lost as a result of reordering, may include a function of reporting the state of the lost RLC PDUs to the transmitting side, and may include a function of requesting retransmission of the lost RLC PDUs. The in-sequence delivery of the NR RLC device may include a function of, if there is a lost RLC SDU, successively delivering only RLC SDUs before the lost RLC SDU to the upper layer, and may include a function of, if a predetermined timer has expired although there is a lost RLC SDU, successively delivering all RLC SDUs received before the timer was started to the upper layer. Alternatively, the in-sequence delivery of the NR RLC device may include a function of, if a predetermined timer has expired although there is a lost RLC SDU, successively delivering all currently received RLC SDUs to the upper layer. In addition, the RLC PDUs may be processed in the received order (regardless of the sequence number order, in the order of arrival) and delivered to the PDCP device regardless of the order (out-of-sequence delivery), and in the case of segments, segments which are stored in a buffer or are to be received later may be received, reconfigured into one complete RLC PDU, processed, and delivered to the PDCP device. The NR RLC layer may include no concatenation function, which may be performed in the NR MAC layer or replaced with a multiplexing function of the NR MAC layer.

The out-of-sequence delivery of the NR RLC device refers to a function of instantly delivering RLC SDUs received from the lower layer to the upper layer regardless of the order, may include a function of reassembling and delivering multiple RLC SDUs received, into which one original RLC SDU has been segmented, and may include a function of storing the RLC SN or PDCP SN of received RLC PDUs, and recording RLC PDUs lost as a result of reordering.

The NR MACs S40 and S55 may be connected to multiple NR RLC layer devices configured in one UE, and the main functions of the NR MACs may include some of the following functions:
Mapping between logical channels and transport channels;
Multiplexing/demultiplexing of MAC SDUs;
Scheduling information reporting;
Error correction through HARQ;
Priority handling between logical channels of one UE;
Priority handling between UEs by means of dynamic scheduling;
MBMS service identification;
Transport format selection; and/or
Padding.

The NR PHY layers S45 and S50 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

The detailed structure of the radio protocol structure may be variously changed according to the carrier (or cell) operating scheme. As an example, assuming that the base station transmits data to the UE based on a single carrier (or cell), the base station and the UE may use a protocol structure having a single structure with regard to each layer, such as the radio protocol structure S00. On the other hand, if the base station transmits data to the UE based on carrier aggregation (CA) which uses multiple carriers in a single TRP, the base station and the UE may use a protocol structure which has a single structure up to the RLC, such as S10, but multiplexes the PHY layer through a MAC layer. As another example, if the base station transmits data to the UE based on dual connectivity (DC) which uses multiple carriers in multiple TRPs, the base station and the UE may use a protocol structure which has a single structure up to the RLC, such as S20, but multiplexes the PHY layer through a MAC layer.

### [Related to Slot Format Indication]

A method by which a BS indicates a slot format to a UE is described. In the 5G communication system, a downlink signal transmission interval and an uplink signal transmission interval may be dynamically changed. To this end, the BS may indicate whether each of the OFDM symbols included in one slot is a downlink symbol, an uplink symbol, or a flexible symbol to the UE through a slot format indicator (SFI). The flexible symbol may be a symbol which is neither a downlink symbol nor an uplink symbol but can be changed to a downlink or uplink symbol by UE-specific control information or scheduling information. At this time, the flexible symbol may include a gap guard required for a process of switching from the downlink to the uplink.

According to an embodiment, the UE receiving the slot format indicator may perform an operation of receiving a downlink signal from the BS in a symbol indicated as the downlink symbol and perform an operation of transmitting an uplink signal to the BS in a symbol indicated as the uplink symbol. For the symbol indicated as the flexible symbol, the UE may perform a PDCCH monitoring operation, and may perform an operation of receiving a downlink signal from the BS (for example, in the case in which DCI format 1_0 or 1_1 is received) or perform an operation of transmitting an uplink signal to the BS (for example, in the case in which DCI format 0_0 or 0_1 is received) in the flexible symbol through another indicator, for example, DCI.

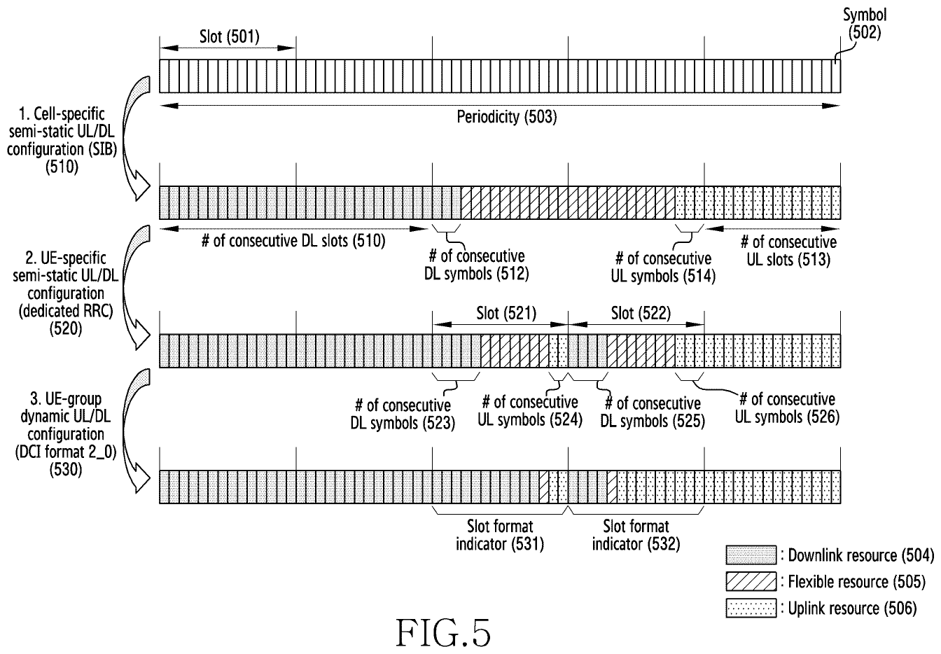

FIG. 5 illustrates an example of an uplink-downlink (UL/DL) configuration in a wireless communication system according to an embodiment of the disclosure.

Referring to FIG. 5, three stages of a downlink-uplink configuration of symbols/slots are illustrated. Referring to FIG. 5, in units of slots 501 or symbols 502, an example of a format including downlink symbol resources 504, flexible symbol resources 505, and uplink symbol resources 506 is illustrated.

In a first stage, cell-specific configuration information 510 for semi-statically configuring the uplink-downlink (for example, system information such as an SIB) configures the uplink-downlink of symbols/slots. Specifically, the cell-specific uplink-downlink configuration information 510 within the system information may include information indicating uplink-downlink pattern information and reference subcarrier spacing. The uplink-downlink pattern information may indicate a transmission periodicity 503 of each pattern, the number of consecutive downlink slots at the beginning of each pattern (number of consecutive full DL slots from the beginning of each DL-UL pattern) 511, the number of consecutive downlink symbols from the beginning of the next slot 512 (number of consecutive DL symbols in the beginning of the slot following the last full DL slot), the number of consecutive uplink slots from the end of each pattern 513 (number consecutive full UL slots at the end of each DL-UL pattern), and the number of symbols of the previous slot 514 (number of consecutive UL symbols in the end of the slot preceding the first full UL slot). At this time, the UE may determine that the slot/symbol which is not indicated as the uplink or the downlink is the flexible slot/symbol.

In a second stage, UE-specific configuration information 520 transmitted through UE-dedicated higher layer signaling (that is, RRC signaling) may indicate symbols to be configured as the downlink or the uplink within the flexible slot or slots 521 and 522 including the flexible symbols. For example, the UE-specific uplink-downlink configuration information 520 may include a slot index indicating the slot 521 or 522 including the flexible symbol, the number of consecutive downlink symbols from the beginning of each slot 523 or 525 (number of consecutive DL symbols in the beginning of the slot), or the number of consecutive uplink symbols from the end of each slot 524 or 526 (number of consecutive UL symbols in the end of the slot) or include at least one piece of information indicating the entire downlink or information indicating the entire uplink for each slot. At this time, the symbol/slot configured as the uplink or the downlink through the cell-specific configuration information 510 in the first stage cannot be changed to the downlink or the uplink through UE-specific higher layer signaling 520.

Last, in order to dynamically change a downlink signal transmission interval and an uplink signal transmission interval, downlink control information 530 of a downlink control channel may include a slot format indicator 531 or 532 indicating whether each symbol is a downlink symbol, an uplink symbol, or a flexible symbol in each of a plurality of slots, starting at the slot in which the UE detects the downlink control information. At this time, the slot format indicator 531 or 532 cannot indicate that the symbol/slot configured as the uplink or the downlink in the first and second stages is the downlink or the uplink. In the first and second stages, a slot format of each slot including at least one symbol which is not configured as the uplink or the downlink cannot be indicated by corresponding downlink control information.

The slot format indicator may indicate an uplink-downlink configuration for 14 symbols in one slot as shown in [Table 4] below. The slot format indicator may be simultaneously transmitted to a plurality of UEs through a UE group (or cell) common control channel. For example, the downlink control information including the slot format indicator may be transmitted through a PDCCH which is CRC-scrambled by an identifier (for example, an SFI-RNTI) different from a UE-specific cell-radio network temporary identifier (C-RNTI). The downlink control information may include slot format indicators for one or more slots (for example, N slots). A value of N may be an integer value larger than 0 or may be a value which the UE receives from the BS through higher layer signaling among a set of predefined available values such as 1, 2, 5, 10, and 20. The size of the slot format indicator may be configured in the UE by the BS through higher layer signaling.

TABLE 4

| | Symbol number in a slot | | | | | | | | | | | | | |
|---|---|---|---|---|---|---|---|---|---|---|---|---|---|---|
| Format | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | F | F | F | F | F | F | F | F | F | F | F | F | F | F |
| 3 | D | D | D | D | D | D | D | D | D | D | D | D | D | F |
| 4 | D | D | D | D | D | D | D | D | D | D | D | D | F | F |
| 5 | D | D | D | D | D | D | D | D | D | D | D | F | F | F |
| 6 | D | D | D | D | D | D | D | D | D | D | F | F | F | F |
| 7 | D | D | D | D | D | D | D | D | D | F | F | F | F | F |
| 8 | F | F | F | F | F | F | F | F | F | F | F | F | F | U |
| 9 | F | F | F | F | F | F | F | F | F | F | F | F | U | U |
| 10 | F | U | U | U | U | U | U | U | U | U | U | U | U | U |
| 11 | F | F | U | U | U | U | U | U | U | U | U | U | U | U |
| 12 | F | F | F | U | U | U | U | U | U | U | U | U | U | U |
| 13 | F | F | F | F | U | U | U | U | U | U | U | U | U | U |
| 14 | F | F | F | F | F | U | U | U | U | U | U | U | U | U |
| 15 | F | F | F | F | F | F | U | U | U | U | U | U | U | U |
| 16 | D | F | F | F | F | F | F | F | F | F | F | F | F | F |
| 17 | D | D | F | F | F | F | F | F | F | F | F | F | F | F |
| 18 | D | D | D | F | F | F | F | F | F | F | F | F | F | F |
| 19 | D | F | F | F | F | F | F | F | F | F | F | F | F | U |
| 20 | D | D | F | F | F | F | F | F | F | F | F | F | F | U |
| 21 | D | D | D | F | F | F | F | F | F | F | F | F | F | U |
| 22 | D | F | F | F | F | F | F | F | F | F | F | F | U | U |
| 23 | D | D | F | F | F | F | F | F | F | F | F | F | U | U |
| 24 | D | D | D | F | F | F | F | F | F | F | F | F | U | U |
| 25 | D | F | F | F | F | F | F | F | F | F | F | U | U | U |
| 26 | D | D | F | F | F | F | F | F | F | F | F | U | U | U |
| 27 | D | D | D | F | F | F | F | F | F | F | F | U | U | U |
| 28 | D | D | D | D | D | D | D | D | D | D | D | D | F | U |
| 29 | D | D | D | D | D | D | D | D | D | D | D | F | F | U |
| 30 | D | D | D | D | D | D | D | D | D | D | F | F | F | U |
| 31 | D | D | D | D | D | D | D | D | D | D | D | F | U | U |
| 32 | D | D | D | D | D | D | D | D | D | D | F | F | U | U |
| 33 | D | D | D | D | D | D | D | D | D | F | F | F | U | U |
| 34 | D | F | U | U | U | U | U | U | U | U | U | U | U | U |
| 35 | D | D | F | U | U | U | U | U | U | U | U | U | U | U |
| 36 | D | D | D | F | U | U | U | U | U | U | U | U | U | U |
| 37 | D | F | F | U | U | U | U | U | U | U | U | U | U | U |
| 38 | D | D | F | F | U | U | U | U | U | U | U | U | U | U |
| 39 | D | D | D | F | F | U | U | U | U | U | U | U | U | U |
| 40 | D | F | F | F | U | U | U | U | U | U | U | U | U | U |
| 41 | D | D | F | F | F | U | U | U | U | U | U | U | U | U |
| 42 | D | D | D | F | F | F | U | U | U | U | U | U | U | U |
| 43 | D | D | D | D | D | D | D | D | D | F | F | F | F | U |
| 44 | D | D | D | D | D | D | F | F | F | F | F | F | U | U |
| 45 | D | D | D | D | D | D | F | F | U | U | U | U | U | U |
| 46 | D | D | D | D | D | F | U | D | D | D | D | D | F | U |
| 47 | D | D | F | U | U | U | U | D | D | F | U | U | U | U |
| 48 | D | F | U | U | U | U | U | D | F | U | U | U | U | U |
| 49 | D | D | D | D | F | F | U | D | D | D | D | F | F | U |
| 50 | D | D | F | F | U | U | U | D | D | F | F | U | U | U |
| 51 | D | F | F | U | U | U | U | D | F | F | U | U | U | U |
| 52 | D | F | F | F | F | F | U | D | F | F | F | F | F | U |
| 53 | D | D | F | F | F | F | U | D | D | F | F | F | F | U |
| 54 | F | F | F | F | F | F | F | D | D | D | D | D | D | D |
| 55 | D | D | F | F | F | U | U | U | D | D | D | D | D | D |

| | |
|---|---|
| 56-254 | Reserved |
| 255 | UE determines the slot format for the slot based on TDD-UL-DL-ConfigurationCommon, or TDD-UL- |
| | DL-ConfigDedicated and, if any, on detected DCI formats |

In [Table 4], D may be a downlink symbol, U may be an uplink symbol, and F may be a flexible symbol. According to [Table 4], the total number of slot formats that can be supported for one slot may be 256. In an NR system, the maximum size of information bits that can be used to indicate the slot formats may be 128 bits. The BS may configure information on the slot formats in the UE through higher-layer signaling (for example, dci-PayloadSize).

At this time, for a cell operating in a licensed or an unlicensed band, the BS may introduce one or more additional slot formats or modify one or more of the existing slot formats, so as to configure and indicate the additional slot formats as shown in [Table 5]. [Table 5] shows an example of additional slot formats in which one slot includes only uplink symbols and flexible symbols (F).

TABLE 5

| | numbers (or indexes) of symbols within one slot | | | | | | | | | | | | | |
|---|---|---|---|---|---|---|---|---|---|---|---|---|---|---|
| format | 0 | 1 | 2 | 3 | 4 | 5 | 6 | 7 | 8 | 9 | 10 | 11 | 12 | 13 |
| 56 | F | U | U | U | U | U | U | U | U | U | U | U | U | U |
| 57 | F | F | U | U | U | U | U | U | U | U | U | U | U | U |
| 58 | U | U | U | U | U | U | U | U | U | U | U | U | U | F |
| 59 | U | U | U | U | U | U | U | U | U | U | U | U | F | F |
| . . . | | | | | | | | | | | | | | |

In an embodiment, downlink control information used for indicating a slot format may indicate slot format(s) for a plurality of serving cells, and slot format(s) for the serving cell may be separated by a serving cell ID. Further, for each serving cell, a slot format combination of one or more slots may be indicated by the downlink control information. For example, when the size of one slot format indicator index field within downlink control information is 3 bits and indicates a slot format for one serving cell, the 3-bit slot format indicator index field may indicate one of a total of 8^{slot} formats (or slot format combinations), and the BS may indicate the slot format indicator index field through UE common downlink control information (DCI).

In an embodiment, at least one slot format indicator index field included in the downlink control information may include a slot format combination indicator of a plurality of slots. For example, [Table 6] shows 3-bit slot format combination indicators including slot formats in [Table 4] and [Table 5]. Among the values of the slot format combination indicators, {0, 1, 2, 3, 4} indicate slot formats for one slot. The three remaining values {5, 6, 7} indicate slot formats for four slots, and the UE may apply the indicated slot format to the four slots sequentially from the slot in which downlink control information including the slot format combination indicators is detected.

TABLE 6

| Slot format | |
|---|---|
| combination ID | Slot Formats |
| 0 | 0 |
| 1 | 1 |
| 2 | 2 |
| 3 | 19 |
| 4 | 9 |
| 5 | 0 0 0 0 |
| 6 | 1 1 1 1 |
| 7 | 2 2 2 2 |

In an embodiment, for example, when the UE is not configured to monitor DCI format 2_0, some symbols of a specific slot are configured as flexible symbols (F) according to a slot format configured through higher-layer signaling, or a slot format of a specific slot is not configured, the UE may receive DCI, an RAR UL grant, a fallbackRAR UL grant, or a successRAR for some corresponding symbols within the corresponding slot and transmit at least one of a PUSCH, a physical uplink control channel (PUCCH), a physical random access channel (PRACH), or a sounding reference signal (SRS) indicated by the received information.

In an embodiment, for example, when some symbols of a specific slot are configured as flexible symbols (F), based on a slot format configured through higher-layer signaling, the UE may not expect reception of an uplink transmission configuration (for example, a configured grant-based PUSCH, PUCCH, or SRS) to be transmitted in some corresponding symbols of the corresponding slot, based on higher-layer signaling.

In an embodiment, for example, when the UE receives scheduling of PUSCH transmission for a plurality of slots in DCI format 0_1 and at least one of the symbols through which the PUSCH should be transmitted are configured as the DL in one slot among a plurality of corresponding slot through higher-layer signaling, the UE may not perform PUSCH transmission in the corresponding slot.

In an embodiment, for example, when some symbols of a specific slot are configured as flexible symbols (F) through higher-layer signaling or a slot format for a specific slot is not configured, the UE receives DCI format 2_0, a slot format indicator value is not 255, flexible symbols (F) are indicated for some symbols of the corresponding slot, and the UE receives a DCI format, an RAR UL grant, or a successRAR indicating a PUSCH, a PUCCH, a PRACH, or an SRS within the corresponding flexible symbols, the UE may transmit the PUSCH, the PUCCH, the PRACH, or the SRS within the corresponding flexible symbols in the corresponding slot.

In some embodiments, for example, when some symbols of a specific slot are configured as flexible symbols (F) through higher-layer signaling or a slot format for a specific slot is not configured, the UE receives DCI format 2_0, a slot format indicator value is not 255, and the UE is configured to transmit a PUCCH, a PUSCH, or a PRACH through higher-layer signaling for some symbols within the corresponding slot, the UE may transmit the preset PUCCH, PUSCH, or PRACH only when some corresponding symbols within the corresponding slot are indicated as uplink symbols (UL) through DCI format 2_0.

### [Timing Advance]

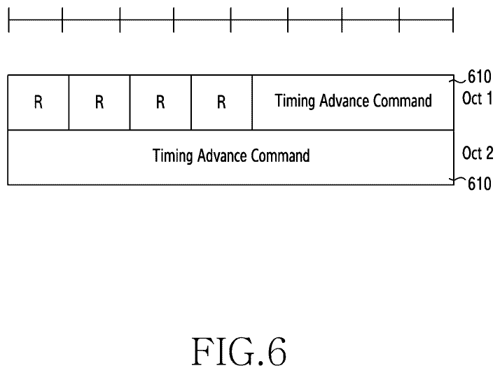

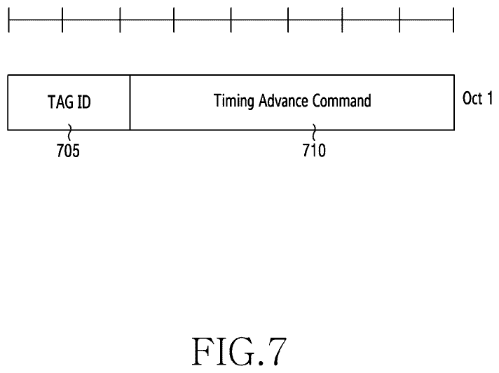

FIG. 6 illustrates an absolute timing advance command MAC CE format according to an embodiment of the disclosure. FIG. 7 illustrates a timing advance command MAC CE format according to an embodiment of the disclosure.

Timing advance (TA) may be used to control transmission timing of an uplink signal transmitted from the UE to the BS. For example, a timing advance offset value N_{TA,offset} for timing advance may be configured in the UE by the BS. The BS may configure the timing advance offset value N_{TA,offset} for a cell supporting the UE in the UE through a higher-layer parameter n-TimingAdvanceOffset. N-TimingAdvanceOffset may be selectively configured in a higher-layer parameter ServingCellConfigCommon or ServingCellConfigCommonSIB.

The timing advance offset value N Aoffset according to an embodiment of the disclosure may be determined as a default timing advance offset value defined in the standard. For example, when the UE does not receive a configuration of n-TimingAdvance Offset for the support cell from the BS, the UE may determine a default N_{TA,offset} value by using a method of determining the default timing advance offset value N_{TA,offset} defined in technical standard 38.133. A detailed embodiment in which the UE determines the default N_{TA,offset} value is described below.
When the UE does not receive the configuration of n-TimingAdvanceOffset, the UE may configure the default N_{TA,offset} value as 25600 for a band of FRI and configure the default N_{TA,offset} value as 13792 for a band of FR2. N_{TA,offset} having the value of 25600 may be a timing advance offset value applied to an FDD or TDD band in FRI that does not correspond to any of the coexistence case between LTE and NR (the case where LTE and NR coexist) or the coexistence case between NB-IoT and NR (the case where NB-IoT and NR coexist).
When a plurality of uplink carriers are included in the same timing advance group (TAG), the UE may expect that the same n-TimingAdvanceOffset is configured for all of the included uplink carriers, and n-TimingAdvanceOffset may be configured as 39936 rather than 0 for an FDD supporting cell. N_{TAoffset} having the value of 39936 may be a timing advance offset value applied to a TDD band in FRI that corresponds to at least one of the coexistence case between LTE and NR or the coexistence case between NB-IoT and NR.
When two uplink carriers are configured in the UE for the corresponding support cell, the same timing advance offset value may be applied to the two carriers.
When the UE receives a timing advance command for one TAG, the UE may control uplink timing for PUSCH/SRS/PUCCH transmission for all support cells within the corresponding TAG, based on specific values. At this time, the UE may control uplink timing, based on the (configured) timing advance offset and the received timing advance command. The UE may expect that the same timing advance offset is configured to all support cells within the corresponding TAG. For all support cells within the corresponding TAG, the UE may control uplink timing such that the PUSCH/SRS/PUCCH for all support cells within the TAG can be transmitted with the same uplink timing by using the timing advance command received from the BS. For example, when subcarrier spacing is 2^{μ}·15 kHz, the timing advance command for the corresponding TAG may indicate to change (control) the current uplink timing for the TAG to be a multiple of 16·16·T_{c}/2μ. T_{c} may be T_{c}=1(Δfₘₐₓ·N_{f}), Δfₘₐₓ may be 480·10³ Hz, and, may be defined as 4096.
In the case of a random access response or the case in which an absolute timing advance command is used for the TAG, the timing advance command T_{A} may be indicated as one index value among 0 to 3846. The BS may indicate the timing advance command T_{A} to the UE by using a timing advance command area (for example, a timing advance command area 610 in FIG. 6) including 12 bits within the MAC CE. The indicated timing advance command T_{A} may be used to calculate N_{TA} that means an amount of the time alignment when subcarrier spacing is 2^{μ}·15 kHz in the support cells within the TAG. At this time, the UE may calculate N_{TA} as N_{TA}=T_{A}·16·64/2^{μ}.
The timing advance command T_{A} indicated through the MAC CE may be used to update previous uplink timing Ara ode to current uplink timing N_{TA new}. At this time, the BS may indicate the timing advance command T_{A} for the TAG indicated as a TAG area 705 in FIG. 7 to the UE by using a timing advance command area 710 including 6 bits within the MAC CE, and the UE may calculate current uplink timing N_{TA new}=N_{TA old}+(T_{A}−31)·16·64/2^{μ} by using the indicated T_{A} when subcarrier spacing is 2^{μ}·15 KHz.
When a plurality of activated uplink bandwidth parts (active UL BWPs) is configured in the UE within the same TAG (at this time, a UL BWP in which two uplink carriers are configured for one support cell may be included), the timing advance command may be applied based on the largest subcarrier spacing among the plurality of active UL BWPs. For example, when the current timing N_{TA new} is applied to the UL BSP having smaller subcarrier spacing, N_{TA} www may be rounded off and applied such that timing advance granularity matches for the UL BWP having smaller subcarrier spacing. At this time, the applied uplink timing may meet timing advance accuracy requirements as defined in [Table 7] below.

TABLE 7

| UL SCS (kHz) | 15 | 30 | 60 | 120 | 480 | 960 |
|---|---|---|---|---|---|---|
| UE TA adjustment | ±256T_{c} | ±256T_{c} | ±128T_{c} | ±32T_{c} | ±10T_{c} | ±6T_{c} |
| accuracy | | | | | | |

For example, when uplink timing is controlled to be N_{TA} that is a positive amount, the UE may quickly control the uplink timing for the corresponding TAG by the corresponding amount (advancing). For example, when uplink timing is controlled to be N_{TA} that is a negative amount, the UE may slowly control the uplink timing for the corresponding TAG by the corresponding amount (advancing).

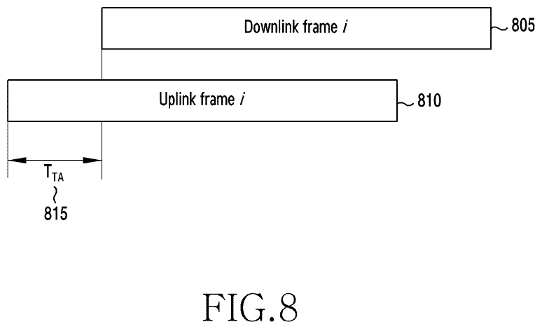

FIG. 8 illustrates timing difference T_{TA} 815 between a downlink frame 805 and an uplink frame 810 when timing advance is applied according to an embodiment of the disclosure.

Referring to FIG. 8, a time point at which the UE applies timing advance and transmits an uplink frame may be a time point earlier than a downlink frame at which the UE receives a downlink frame by T_{TA}=(N_{TA}+N_{TAoffset})·T_{C}.

When an uplink signal (for example, an uplink signal other than a PUCCH scheduled by a random access response (RAR) UL grant or a fallbackRAR UL grant or a PUCCH including HARQ information that is a response to successARA) is transmitted through the application of a timing advance command received in uplink slot n (slot n), the control of the uplink transmission timing according to the corresponding timing advance command may be applied from a start time point of uplink slot n+k+1+2^{μ}·K_{offset}.

k is [Nₛₗₒₜ^{subframe,μ}·(N_{T,1}+N_{T,2}+N_{TAmax}+0.5)/T_{sf}], N_{T,1} is a time of msec units of symbol N₁ corresponding to a PDSCH processing time for UE processing capability 1 when an additional PDSCH DM-RS is configured, N_{T,2} is a unit of msec units of symbol N₂ corresponding to a PUSCH processing time for UE processing capability 1, N_{TAmax} is a maximum timing advance value of msec units indicated by a T_{A} command area of 12 bits within the MAC CE, Nₛₗₒₜ^{subframe,μ} is the number of slots per subframe, T_{sf} is a subframe duration time that is 1 msec, and K_{offset} is defined as K_{offset}=K_{celloffset}−K_{UEoffset}. K_{celloffset} may be a scheduling offset value for controlling timing of non-terrestrial networks (NTN) configured by a higher-layer parameter cellSpecifickoffset, and K_{UE,offset} may be Differential Koffset of 6 bits indicated by the MAC CE. When K_{cell,offset} is not configured and K_{UE,offset} is not indicated, the UE may assume that Band K_{celloffset}=0 and K_{UEoffset}=0·N₁ and N₂ may be determined based on minimum SCS among SCS of all uplink BSPs configured for all uplink carriers and SCS of all downlink BWPs configured for all corresponding downlink carriers. In the case of μ=0, the UE assumes that N_{1,0} corresponding to a PDSCH processing time is 14 when dmrs-AdditionalPosition within a higher-layer parameter DMRS-DownlinkConfig for a downlink DMRS for a DMRS type (for example, MappingTypeA or MappingTypeB for a PDSCH scheduling by DCI format 1_1 or MappingTypeA or MappingTypeB for a PDSCH scheduling by DCI format 1_2) is not configured as “pos0” or dmrs-AdditionalPosition is not configured. Slot n and Nₛₗₒₜ^{subframe,μ} are determined based on minimum SCS among SCS of all uplink BWPs configured for all uplink carriers within the TAG. N_{TAmax} is determined based on minimum SCS among SCS of all uplink BWPs configured for all uplink carriers within the TAG or all initial UL BWPs configured in InitialUplinkBWP. Uplink slot n (slot n) is the last slot among uplink slot(s) overlapping a slot for receiving a PDSCH including a timing advance command, based on the assumption of T_{TA}=0.

If the UE changes the active UL BWP to be between the time at which the timing advance command is received and the time at which the corresponding control value is applied to the uplink transmission timing, the UE determines the timing advance command value, based on SCS of a new active UL BWP. If the UE changes the active UL BWP after controlling the uplink transmission timing, the UE assumes that absolute timing advance command values before and after the change in the active UL BWP are the same.

If the received downlink timing is changed and the received downlink timing is not compensated by the control of uplink timing without any timing advance command or is partially compensated, the UE changes N_{TA} according thereto.

When two adjacent slots overlap due to the T_{A} command, latter slots are reduced by intervals for the previous slots. The UE does not change N_{TA} during an actual transmission time window for PUSCH or PUCCH transmission.

[Rel-15/16 TCI state]
[QCL, TCI state]

In a wireless communication system, one or more different antenna ports (which may be replaced with one or more channels, signals, and combinations thereof, but may be referred to as different antenna ports, as a whole, for convenience of description of the disclosure) may be associated with each other by a quasi-co-location (QCL) configuration as in Table 8 below. A transmission configuraion indicator (TCI) state is for publishing the QCL relation between a PDCCH (or a PDCCH DRMS) and another RS or channel, and the description that a reference antenna port A (reference RS #A) and another target antenna port B (target RS #B) are QCLed with each other means that the UE is allowed to apply some or all of large-scale channel parameters estimated in the antenna port A to channel measurement form the antenna port B. The QCL needs to be associated with different parameters according to the situation such as 1) time tracking influenced by average delay and delay spread, 2) frequency tracking influenced by Doppler shift and Doppler spread, 3) radio resource management (RRM) influenced by average gain, or 4) beam management (BM) influenced by a spatial parameter. Accordingly, four types of QCL relations are supported in NR as in Table 8 below.

TABLE 8

| QCL type | Large-scale characteristics |
|---|---|
| A | Doppler shift, Doppler spread, |
| | average delay, delay spread |
| B | Doppler shift, Doppler spread |
| C | Doppler shift, average delay |
| D | Spatial Rx parameter |

The spatial RX parameter may refer to some or all of various parameters as a whole, such as angle of arrival (AoA), power angular spectrum (PAS) of AoA, angle of departure (AoD), PAS of AoD, transmit/receive channel correlation, transmit/receive beamforming, and spatial channel correlation.

The QCL relations may be configured for the UE through RRC parameter TCI-state and QCL-info as in Table 14 below. Referring to Table 9, the base station may configure one or more TCI states for the UE, thereby informing of a maximum of two kinds of QCL relations (qcl-Type1, qcl-Type2) regarding the RS that refers to the ID of the TCI state, that is, the target RS. Each piece of QCL information (QCL-Info) that each TCI state includes the serving cell index and the BWP index of the reference RS indicated by the corresponding QCL information, the type and ID of the reference BS, and a QCL type as in Table 8 above.

TABLE 9

| | |
|---|---|
| TCI-State ::= | SEQUENCE |
| tci-StateId | TCI-StateId, |

(ID of corresponding TCI state)

| | |
|---|---|
| qcl-Type1 | QCL-Info, |

(QCL information of first refernece RS of RS (target RS) referring to
corresponding TCI state ID)

| | | |
|---|---|---|
| qcl-Type2 | QCL-Info | OPTIONAL, - |

```
- Need R
  (QCL information of second refernece RS of RS (target RS) referring to
corresponding TCI state ID)
  ...
}
```

| QCL-Info ::= | SEQUENCE { | |
|---|---|---|
| cell | ServCellIndex | OPTIONAL, -- |

Need R
(serving cell index of reference RS indicated by corresponding QCL information)

| | |
|---|---|
| bwp-Id | BWP-Id |

```
  OPTIONAL, -- Cond CSI-RS-Indicated
  (BWP index of reference RS indicated by corresponding QCL information)
```

| | |
|---|---|
| referenceSignal | CHOICE { |
| csi-rs | NZP-CSI-RS-ResourceId, |
| ssb | SSB-Index |

```
    (one of CSI-RS ID or SSB ID indicated by corresponding QCL information)
  },
```

| | |
|---|---|
| qcl-Type | ENUMERATED {typeA, typeB, typeC, |

typeD},
...
}

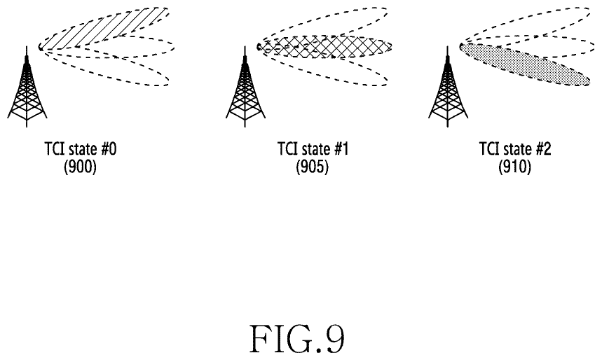

FIG. 9 illustrates an example of base station beam allocation according to transmission configuration indicator (TCI) state configuration in a wireless communication system according to an embodiment of the disclosure.

Referring to FIG. 9, the base station may transfer information regarding N different beams to the UE through N different TCI states. For example, in the case of N=3 as in FIG. 9, the base station may configure qcl-Type2 parameters included in three TCI states 900, 905, and 910 in QCL type D while being associated with CSI-RSs or SSBs corresponding to different beams. The base station may announce that antenna ports referring to the different TCI states 900, 905, and 910 are associated with different spatial Rx parameters (for example, different beams).

Tables 10 to 14 below may enumerate valid TCI state configurations according to the target antenna port type.

Table 10 may enumerate valid TCI state configurations when the target antenna port is a CSI-RS for tracking (TRS). The TRS may refer to an NZP CSI-RS which has no repetition parameter configured therefor, and trs-Info of which is configured as “true,” among CRI-RSs. In Table 10, configuration no. 3 may be used for an aperiodic TRS.

TABLE 10
Valid TCI state configurations when the target
antenna port is a CSI-RS for tracking (TRS)

| Valid TCI state | | | DL RS 2 | qcl-Type2 |
|---|---|---|---|---|
| Configuration | DL RS 1 | qcl-Type1 | (If configured) | (If configured) |
| 1 | SSB | QCL-TypeC | SSB | QCL-TypeD |
| 2 | SSB | QCL-TypeC | CSI-RS (BM) | QCL-TypeD |
| 3 | TRS | QCL-TypeA | TRS (same as | QCL-TypeD |
| | (periodic) | | DL RS 1) | |

Table 11 may enumerate valid TCI state configurations when the target antenna port is a CSI-RS for CSI. The CSI-RS for CSI may refer to an NZP CSI-RS which has no parameter indicating repetition (for example, repetition parameter) configured therefor, and trs-Info of which is not configured as “true,” among CRI-RSs.

TABLE 11
Valid TCI state configurations when the
target antenna port is a CSI-RS for CSI

| Valid TCI | | | DL RS 2 | qcl-Type2 |
|---|---|---|---|---|
| state | | | (If | (If |
| Configurations | DL RS 1 | qcl-Type1 | configured) | configured) |
| 1 | TRS | QCL-TypeA | SSB | QCL-TypeD |
| 2 | TRS | QCL-TypeA | CSI-RS for BM | QCL-TypeD |
| 3 | TRA | QCL-TypeA | TRS (same as | QCL-TypeD |
| | | | DL RS 1) | |
| 4 | TRS | QCL-TypeB | | |

Table 12 may enumerate valid TCI state configurations when the target antenna port is a CSI-RS for beam management (BM) (which has the same meaning as CSI-RS for L1 RSRP reporting). The CSI-RS for BM may refer to an NZP CSI-RS which has a repetition parameter configured to have a value of “on” or “off,” and trs-Info of which is not configured as “true,” among CRI-RSs.

TABLE 12
Valid TCI state configurations when the target
antenna port is a CSI-RS for BM (for L1 RSRP reporting)

| Valid TCI state | | | DL RS 2 | qcl-Type2 |
|---|---|---|---|---|
| Configuration | DL RS 1 | qcl-Type1 | (If configured) | (If configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | SS/PBCH | QCL-TypeC | SS/PBCH Block | QCL-TypeD |
| | Block | | | |

Table 13 may enumerate valid TCI state configurations when the target antenna port is a PDCCH DMRS.

TABLE 13
Valid TCI state configurations when the
target antenna port is a PDCCH DMRS

| Valid | | | | |
|---|---|---|---|---|
| TCI state | | | | |
| Config- | | | DL RS 2 | qcl-Type2 |
| uration | DL RS 1 | qcl-Type1 | (If configured) | (If configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | CSI-RS | QCL-TypeA | CSI-RS (same as | QCL-TypeD |
| | (CSI) | | DL RS 1) | |

Table 14 may enumerate valid TCI state configurations when the target antenna port is a PDSCH DMRS.

TABLE 14
Valid TCI state configurations when the
target antenna port is a PDSCH DMRS

| Valid | | | | |
|---|---|---|---|---|
| TCI state | | | | |
| Config- | | | DL RS 2 | qcl-Type2 |
| uration | DL RS 1 | qcl-Type1 | (If configured) | (If configured) |
| 1 | TRS | QCL-TypeA | TRS | QCL-TypeD |
| 2 | TRS | QCL-TypeA | CSI-RS (BM) | QCL-TypeD |
| 3 | CSI-RS | QCL-TypeA | CSI-RS (CSI) | QCL-TypeD |
| | (CSI) | | | |

A representative QCL configuration method based on Tables 10 to 14 above may include configuring and operating the target antenna port and reference antenna port for each step “s “ ” SB″ “> “ ” RS″ “> “CSI-RS for CSI, or CSI-RS for BM, or PDCCH DMRS, or PDSCH DMRS.” Accordingly, it is possible to help the UE's receiving operation by associating statistical characteristics that can be measured from the SSB and TRS with respective antenna ports.

[Rel-17 unified TCI state]
[Unified TCI state]

Hereinafter, a method of indicating and activating a single TCI state based on a unified TCI scheme is described. The unified TCI scheme may be a scheme of unifying and managing transmission and reception beam managemetn schemes divided into the TCI state scheme used for downlink reception of the UE and the spatial relation info scheme used for uplink transmission in the conventional Rel-15 and 16 according to the TCI state. Accordingly, when receiving an indication from the BS, based on the unified TCI scheme, the UE may perform beam management for uplink transmission by using the TCI state. When the UE receives a configuration of a TCI-State which is higher layer signaling having higher-layer signlaing tci-stateId-r17 from the BS, the UE may perform an operation based on the unified TCI scheme by using the corresponding TCI-State. The TCI-State may exist in two forms such as a joint TCI state or a separate TCI state.

The first form is the joint TCI state, and the UE may receive an indication of all TCI states to be applied to both uplink transmission and downlink reception from the BS through one TCI-State. When the UE receives an indication of a TCI-State based on the joint TCI state, the UE may receive an indication of a parameter to be used for downlink channel estimation by using an RS corresponding to qcl-Type1 and a parameter to be used as a downlink reception beam or reception filter by using an RS corresponding to qcl-Type2 within the corresponding TCI-State based on the joint TCI state. If the UE receives an indication of the TCI-State based on the joint TCI state, the UE may receive an indication of a parameter to be used as an uplink transmission beam or transmission filter by using an RS corresponding to qcl-Type2 within the corresponding TCI-State based on the joint DL/UL TCI state. At this time, if the UE receives an indication of the joint TCI state, the UE may receive the application of the same beam to uplink transmission and downlink reception.

The second form is the separate TCI state, and the UE may individually receive indications of the UL TCI state to be applied to uplink transmission and the DL TCI state to be applied to downlink reception from the BS. When the UE receives an indication of the UL TCI state, the UE may receive an indication of a parameter to be used as an uplink transmission beam or transmission filter by using a reference RS or a source RS configured within the corresponding UL TCI state. When the UE receives an indication of the DL TCI state, the UE may receive an indication of a parameter to be used for downlink channel estimation by using an RS corresponding to qcl-Type1 and a parameter to be used as a downlink reception beam or reception filter by using an RS corresponding to qcl-Type2 within the corresponding DL TCI state.

When the UE receives indications of the DL TCI state and the UL TCI state together, the UE may receive an indication of a parameter to be used as an uplink transmission beam or transmission filter by using a reference RS or a source RS configured within the corresponding UL TCI state and receive an indication of a parameter to be used for downlink channel estimation by using an RS corresponding to qcl-Type1 and a parameter to be used as a downlink reception beam or reception filter by using an RS corresponding to qcl-Type2 configured within the corresponding DL TCI state. At this time, reference RSs or source RSs configured within the DL TCI state and the UL TCI state which the UE received are different, the UE may individually apply the beam to uplink transmission and downlink reception, based on the received UL TCI state and DL TCI state.

The UE may receive a configuration of a maximum of 128 joint TCI states for each specific bandwidth part within a specific cell from the BS through higher-layer signaling. Alternatively, the UE may receive a configuration of a maximum of 64 or 128 DL TCI states of the separate TCI states for each specific bandwidth part within a specific cell, based on a UE capability report, and the DL TCI states of the separate TCI states and the joint TCI states may use the same higher-layer signaling format. For example, when 128 joint TCI states are configured and 64 DL TCI states in the separate TCI states are configured, the 64 DL TCI states may be included in the 128 joint TCI states.

According to an embodiment, in the separate TCI states, a maximum of 32 or 64 UL TCI states may be configured for each specific bandwidth part within a specific cell, based on a UE capability report, through higher-layer signaling. Like the relationship between the DL TCI states of the separate TCI states and the joint TCI states, the UL TCI states of the separate TCI states and the joint TCI states may also use the same higher-layer signaling structure, and the UL TCI states of the separate TCI states may use a higher-layer signaling structure which is different from that of the joint TCI states and the DL TCI states of the separate TCI states.

As described above, using different or the same higher-layer signaling structure may be defined in the standard, and may be divided through other higher-layer signaling configured by the BS, based on a UE capability report containing information on a usage scheme that can be supported by the UE between the two schemes.

According to an embodiment, the UE may receive a transmission/reception beam-related indication through a unified TCI scheme by using one scheme among the joint TCI states and the separate TCI states configured by the BS. The UE may receive a configuration indicating whether to use one of the joint TCI states and the separate TCI states from the BS through higher layer signaling.

According to an embodiment, the UE may receive a transmission/reception beam-related indication by using one scheme selected from the joint TCI states and the separate TCI states through higher-layer signaling, in which case there are two methods of indicating a transmission/reception beam from the BS, such as a MAC-CE-based indication method and a MAC-CE-based activation and DCI-based indication method.

According to an embodiment, when the UE receives a transmission/reception beam-related indication by using the joint TCI state scheme through higher-layer signaling, the UE may receive a MAC-CE indicating the joint TCI states from the BS and perform a transmission/reception beam application operation, and the BS may schedule reception for a PDSCH including the corresponding MAC-CE to the UE through a PDCCH. If the number of joint TCI states included in the MAC-CE is one, the UE may determine an uplink transmission beam or transmission filter and a downlink reception beam or reception filter by using the joint TCI state indicated from 3 ms after transmission of a PUCCH including HARQ-ACK information indicating whether the PDSCH including the corresponding MAC-CE has been successfully received. If the number of joint TCI states included in the MAC-CE is two or more, the UE may identify that a plurality of joint TCI states indicated by the MAC-CE corresponds to respective codepoints in a TCI state field of DCI format 1_1 or DCI format 1_2 from 3 ms after transmission of the PUCCH including HARQ-ACK information indicating whether the PDSCH including the corresponding MAC-CE has been successfully received, and activate the indicated joint TCI states. Thereafter, the UE may receive DCI format 1_1 or 1_2 and apply one joint TCI state indicated by the TCI state field within the corresponding DCI to the uplink transmission and downlink reception beams. At this time, DCI format 1_1 or 1_2 may include downlink data channel scheduling information (with DL assignment) or may not include the same (without DL assignment).

According to an embodiment, when the UE receives a transmission/reception beam-related indication by using the separate TCI state scheme through higher-layer signaling, the UE may receive a MAC-CE indicating the separate TCI states from the BS and perform a transmission/reception beam application operation, and the BS may schedule reception for a PDSCH including the corresponding MAC-CE to the UE through a PDCCH. If the number of separate TCI state sets included in the MAC-CE is one, the UE may determine an uplink transmission beam or transmission filter and a downlink reception beam or reception filter by using the separate TCI states included in the separate TCI state sets from 3 ms after transmission of a PUCCH including HARQ-ACK information indicating whether the corresponding PDSCH has besuccessfulully received. At this time, the separate TCI state sets may be a single or a plurality of separate TCI states that one codepoint in the TCI state field of DCI format 1_1 or 1_2 may have, and one separate TCI state set may include one DL TCI state, one UL TCI state, or one DL TCI state and one UL TCI state. If the number of separate TCI state sets included in the MAC-CE is two or more, the UE may identify that a plurality of separate TCI state sets indicated by the MAC-CE correspond to respective codepoints in the TCI state field of DCI format 1_1 or 1_2 from 3 ms after transmission of the PUCCH including HARQ-ACK information indicating whether the corresponding PDSCH has been successfully received, and activate the indicated separate TCI state sets. At this time, respective codepoints in the TCI state field of DCI format 1_1 or 1_2 may indicate one DL TCI state, one UL TCI state, or one DL TCI state and one UL TCI state. The UE may receive DCI format 1_1 or 1_2 and apply separate TCI state sets indicated by the TCI state field within the corresponding DCI to the uplink transmission and downlink reception beams. At this time, DCI format 1_1 or 1_2 may include downlink data channel scheduling information (with DL assignment) or may not include the same (without DL assignment).

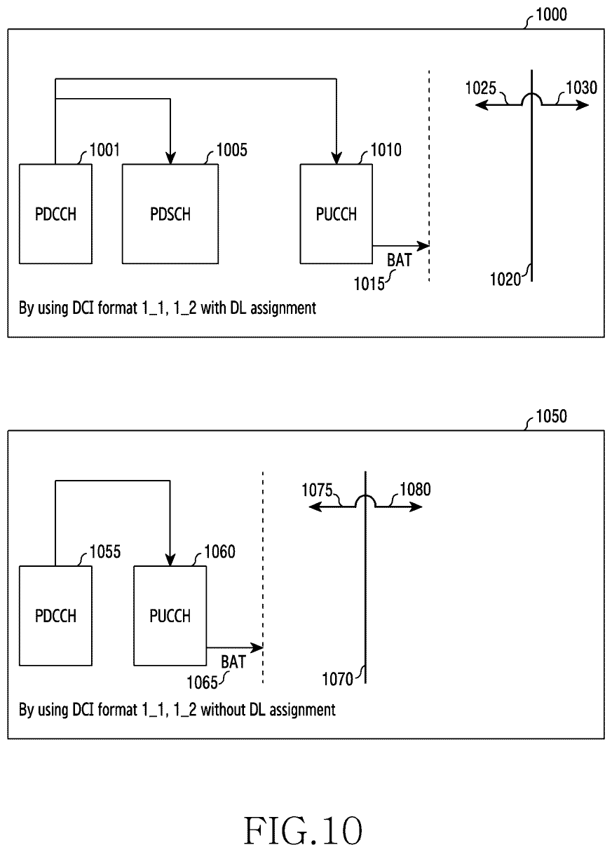

FIG. 10 illustrates an example of a beam application time when a unified TCI scheme is used in a wireless communication system according to an embodiment of the disclosure. As described above, the UE may receive DCI format 1_1 or 1_2 that includes downlink data channel scheduling information (with DL assignment) or does not include the same (without DL assignment) from the BS and apply one joint TCI state set or one separate TCI state set indicated by the TCI state field within the corresponding DCI to the uplink transmission and downlink reception beams.

DCI format 1_1 or 1_2 with DL assignment 1000: if the UE receives DCI format 1_1 or 1_2 including downlink data channel scheduling information from the BS as indicated by reference numeral 1001 and indicates one joint TCI state set or one separate TCI state set based on the unified TCI scheme, the UE may receive a PDSCH scheduled based on the received DCI as indicated by reference numeral 1005 and transmit a PUCCH including HARQ-ACK indicating whether the DCI and the PDSCH have been successfully received as indicated by reference numeral 1010. At this time, the HARQ-ACK may include information indicating whether the DCI has been successfully received and the PDSCH has been successfully received, and the UE may transmit NACK if one of the DCI and the PDSCH has not been received, and may transmit ACK if both of them have been successfully received.

DCI format 1_1 or 1_2 without DL assignment 1050: if the UE receives DCI format 1_1 or 1_2 that does not include downlink data channel scheduling information from the BS as indicated by reference numeral 1055 and indicates one joint TCI state set or one separate TCI state set based on the unified TCI scheme, the UE may assume at least one combination among the following matters for the corresponding DCI:
1) CRC scrambled using a CS-RSNTI is included;
2) Values of all bits allocated to all fields used as a redundancy version (RV) are 1;
3) Values of all bits allocated to all fields used as a modulation and coding scheme (MCS) field are 1;
4) Values of all bits allocated to all fields used as a new data indication (NDI) field are 0; and/or
5) Values of all bits allocated to a frequency domain resource allocation (FDRA) field are 0 in the case of FDRA type 0, values of all bits allocated to the FDRA field are 1 in the case of FDRA type 1, and values of all bits allocated to the FDRA field are 0 in the case where the FDRA type is dynamicSwitch.

The UE may transmit a PUCCH including HARQ-ACK indicating whether DCI format 1_1 or 1_2 in which the above-described matters are assumed has been successfully received as indicated by reference numeral 1060.
If a new TCI state indicated through DCI 1001 and 1055 is the same as the TCI state that was previously already indicated and is applied to uplink transmission and downlink reception beams for both DCI format 1_1 or 1_2 with DL assignment 1000 and DCI format 1_1 or 1_2 without DL assignment 1050, the UE may maintain the existing applied TCI state. If the new TCI state is different from the previously indicated TCI state, the UE may determine an application time point of a joint TCI state or separate TCI state set which can be indicated from a TCI state field included in the DCI as an interval 1030 or 1080 after an initial slot 1020 or 1070 after a beam application time (BAT) 1015 or 1065 from PUCCH transmission and use the previously indicated TCI-state until an interval 1025 or 1075 before the corresponding slot 1020 or 1070.

For both DCI format 1_1 or 1_2 with DL assignment 1000 and DCI format 1_1 or 1_2 without DL assignment 1050, the BAT is the specific number of OFDM symbols and may be configured through higher layer signaling based on UE capability report information, and numerology for the BAT and a first slot after the BAT may be determined based on the smallest numerology among all cells to which the joint TCI state or separate TCI state set indicated through the DCI is applied.

The UE may apply one joint TCI state indicated through the MAC-CE or the DCI to reception of resource control sets connected to all UE-specific search spaces, reception of a PDSCH scheduled by a PDCCH transmitted from the corresponding control resource sets, transmission of the PUSCH, and transmission of all PUCHC resources.

When one separate TCI state set indicated through the MAC-CE or the DCI includes one DL TCI state, the UE may apply the one separate TCI state set to reception of control resource sets connected to all UE-specific search spaces and reception of a PDSCH scheduled by a PDCCH transmitted from the corresponding control resource sets and may be applied to all PUSCH and PUSCH resources, based on the previously indicated UL TCI state.

When one separate TCI state set indicated through the MAC-CE or the DCI includes one UL TCI state, the UE may apply the one separate TCI state set to all PUSCH and PUCCH resources, and apply the same to reception of control resource sets connected to all UE-specific search spaces and reception of a PDSCH scheduled by a PDCCH transmitted from the corresponding control resource sets, based on the existing indicated DL TCI states.

When one separate TCI state set indicated through the MAC-CE or the DCI includes one DL TCI state and one UL TCI state, the UE may apply the DL TCI state set to reception of control resource sets connected to all UE-specific search spaces and reception of a PDSCH scheduled by a PDCCH transmitted from the corresponding control resource sets, and apply the UL TCI state to all PUSCH or PUCCH resources.

[Unified TCI state MAC-CE]

Hereinafter, a method of indicating and activating a single TCI state based on a unified TCI scheme is described. The UE may receive scheduling of a PDSCH including the following MAC-CE from the BS and analyze each codepoint in a TCI state field within DCI format 1_1 or 1_2 after three slots for transmitting HARQ-ACK for the corresponding PDSCH to the BS, based on information within the MAC-CE received from the BS. For example, the UE may activate each entry of the MAC-CE received from the BS in each codepoint in the TCI state field within DCI format 1_1 or 1_2.

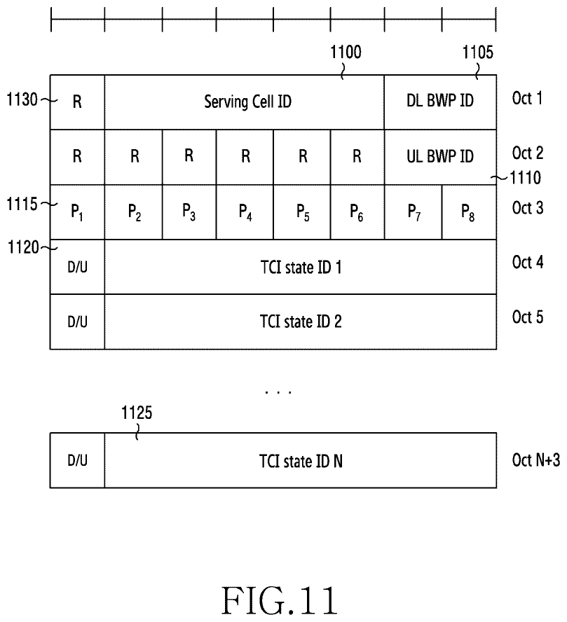

FIG. 11 illustrates another medium access control-control element (MAC-CE) format for activating and indicating a joint TCI state or a separate DL or UL TCI state in a wireless communication system according to an embodiment of the disclosure. The meaning of each field within the corresponding MAC-CE format is described below.
Serving cell ID 1100: this field may indicate a service cell to which the corresponding MAC-CE is to be applied. The length of this field may be 5 bits. If the serving cell indicated by this field is included in one or more of simultaneousU-TCI-UpdateList1, simultaneousU-TCI-UpdateList2, simultaneousU-TCI-UpdateList3, or simultaneousU-TCI-UpdateList4 which is higher-layer signaling, the corresponding MAC-CE may be applied to all serving cells included in a list of one or more of simultaneousU-TCI-UpdateList1, simultaneousU-TCI-UpdateList2, simultaneousU-TCI-UpdateList3, and simultaneousU-TCI-UpdateList4 including the serving cell indicated by this field.
DL BWP ID 1105: this field may indicate a DL BWP to which the corresponding MAC-CE is to be applied, and the meaning of each codepoint in this field may correspond to each codepoint of a bandwidth part indicator within DCI. The length of this field may be 2 bits.
UL BWP ID 1110: this field may indicate a UL BWP to which the corresponding MAC-CE is to be applied, and the meaning of each codepoint in this field may correspond to each codepoint of a bandwidth part indicator within DCI. The length of this field may be 2 bits.
Pᵢ 1115: this field may indicate whether each codepoint in the TCI state field within DCI format 1_1 or 1_2 has a plurality of TCI states or one TCI state. If a value of Pᵢ is 1, it may mean that an i^{th} codepoint has a plurality of TCI states, which may imply that the corresponding codepoint may include separate DL TCI states and separate UL TCI states. If a value of Pᵢ is 0, it may mean that an i^{th} codepoint has a single TCI state, which may imply that the corresponding codepoint may include one of the joint TCI state, the separate DL TCI state, or the separate UL TCI state.
D/U 1120: this field may indicate whether a TCI state ID field within the same octet is a joint TCI state, a separate DL TCI state, or a separate UL TCI state. If this field is 1, the TCI state ID field within the same octet may be the joint TCI state or the separate DL TCI state and, if this field is 0, the TCI state ID within the same octet may be the separate UL TCI state.
TCI state ID 1125: this field may indicate a TCI state that can be detected by a TCI-StateId corresponding to higher-layer signaling. If a D/U field is configured as 1, this field may be used to express the TCI-StateId that can be expressed by 7 bits. If the D/U field is configured as 0, a most significant bit (MSB) of this field may be considered as being reserved, and the remaining 6 bits may be used to express the UL-TCIState-Id corresponding to higher layer signaling. The maximum of TCI states that can be activated may be 8 in the case of the joint TCI state and 16 in the case of the separate DL or UL TCI state.
R 1130: indicates a reserved bit and may be configured as 0.

For the MAC-CE format in FIG. 11, the UE may insert a third octet including fields P₁, P₂, . . . , P₈ into the corresponding MAC-CE format in FIG. 11 regardless of whether unifiedTCI-StateType-r17 in MIMOparam-r17 within ServingCellConfig corresponding to higher-layer signaling is configured as joint or separate. In this case, the UE may perform TCI state activation by using the fixed MAC-CE format regardless of higher layer signaling configured by the BS. According to an embodiment, for the MAC-CE format in FIG. 11, when unifiedTCI-StateType-r17 in MIMOparam-r17 within ServingCellConfig corresponding to higher-layer signaling is configured as joint, the UE may omit the third octet including the fields P₁, P₂, . . . , P₈ in FIG. 11. In this case, the UE may save a maximum of 8 bits of payload of the corresponding MAC-CE according to higher layer signaling configured by the BS. Further, all D/U fields located in first bits from the fourth octet in FIG. 11 may be considered as R fields, and all of the corresponding R fields may be configured as 0 bits.

### [Downlink: PDCCH]

[PDCCH: regarding DCI]

Next, downlink control information (DCI) in a 5G communication system will be described in detail.

In a 5G system, scheduling information regarding uplink data (or physical uplink shared channel (PUSCH)) or downlink data (or physical downlink shared channel (PDSCH)) is transferred from a base station to a UE through DC1. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

According to an embodiment, the DCI may be subjected to channel coding and modulation processes and then transmitted through a physical downlink control channel (PDCCH) after a channel coding and modulation process. A cyclic redundancy check (CRC) may be attached to the payload of a DCI message, and the CRC may be scrambled by a radio network temporary identifier (RNTI) corresponding to the identity of the UE. Different RNTIs may be used according to the purpose of the DCI message, for example, UE-specific data transmission, power control command, or random access response. For example, the RNTI may not be explicitly transmitted, but may be transmitted while being included in a CRC calculation process. Upon receiving a DCI message transmitted through the PDCCH, the UE may identify the CRC by using the allocated RNTI, and if the CRC identification result is right, the UE may identify that the corresponding message has been transmitted to the UE.

According to an embodiment, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. The DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling the PUSCH, and the CRC may be scrambled by a C-RNTI. DCI format 0_0 in which the CRC is scrambled by a C-RNTI may include the following pieces of information in Table 15 below, for example.

TABLE 15
Identifier for DCI formats - [1] bit
Frequency domain resource assignment -[┌log₂(N_{RB}^{UL,BWP}(N_{RB}^{UL,BWP} +
1)/2┐] bits
Time domain resource assignment - X bits
Frequency hopping flag - 1 bit.
Modulation and coding scheme - 5 bits
New data indicator - 1 bit
Redundancy version - 2 bits
HARQ process number - 4 bits
Transmit power control (TPC) command for scheduled PUSCH- [2] bits
Uplink/supplementary uplink indicator (UL/SUL indicator) - 0 or 1 bit

DCI format 0_1 may be used as non-fallback DCI for scheduling the PUSCH, and the CRC may be scrambled by a C-RNTI. DCI format 0_1 in which the CRC is scrambled by a C-RNTI may include the following pieces of information in Table 16 below, for example.

```
TABLE 16
Carrier indicator - 0 or 3 bits
UL/SUL indicator - 0 or 1 bit
Identifier for DCI formats - [1] bits
Bandwidth part indicator - 0, 1 or 2 bits
Frequency domain resource assignment
      For resource allocation type 0, ┌N_{RB}^{UL,BWP}/P┐ bits
      For resource allocation type 1, ┌log₂ (N_{RB}^{UL,BWP}(N_{RB}^{UL,BWP} +
      1)/2)┐ bits
Time domain resource assignment - 1, 2, 3, or 4 bits
virtual resource block-to-physical resource block (VRB-to-PRB) mapping -
0 or
1 bit, only for resource allocation type 1.
      0 bit if only resource allocation type 0 is configured;
      1 bit otherwise.
Frequency hopping flag - 0 or 1 bit, only for resource allocation type 1.
      0 bit if only resource allocation type 0 is configured;
      1 bit otherwise.
Modulation and coding scheme - 5 bits
New data indicator - 1 bit
Redundancy version - 2 bits
HARQ process number - 4 bits
1st downlink assignment index- 1 or 2 bits
      1 bit for semi-static HARQ-ACK codebook;
      2 bits for dynamic HARQ-ACK codebook with single HARQ-ACK
      codebook.
2nd downlink assignment index - 0 or 2 bits
      2 bits for dynamic HARQ-ACK codebook with two HARQ-ACK
      sub-codebooks;
      0 bit otherwise.
TPC command for scheduled PUSCH - 2 bits
$SRS resource indicator ‐ ⌈ {log}_{2} ( {\sum }_{k = 1}^{{L}_{max} Σ} ( \begin{matrix}{N}_{SRS} \\ k\end{matrix} ) ) ⌉ or ⌈ {log}_{2} ( {N}_{SRS} ) ⌉ bits$
      $⌈ {log}_{2} ( {\sum }_{k = 1}^{{L}_{max} Σ} ( \begin{matrix}{N}_{SRS} \\ k\end{matrix} ) ) ⌉ bits for non ‐ codebook based PUSCH$
      transmission;
      ┌log₂(N_{SRS})┐ bits for codebook based PUSCH transmission.
Precoding information and number of layers-up to 6 bits
Antenna ports - up to 5 bits
SRS request - 2 bits
CSI request - 0, 1, 2, 3, 4, 5, or 6 bits
Code block group (CBG) transmission information - 0, 2, 4, 6, or 8 bits
Phase tracking reference signal (PTRS)-demodulation reference signal
(DMRS) association- 0 or 2 bits.
beta_offset indicator- 0 or 2 bits
DMRS sequence initialization- 0 or 1 bit
```

DCI format 1_0 may be used as fallback DCI for scheduling the PDSCH, and the CRC may be scrambled by a C-RNTI. DCI format 1_0 in which the CRC is scrambled by a C-RNTI may include the following pieces of information in Table 17 below, for example.

TABLE 17
Identifier for DCI formats - [1] bit
Frequency domain resource assignment -[┌log₂(N_{RB}^{DL,BWP}(N_{RB}^{DL,BWP} +
1)/2┐] bits
Time domain resource assignment - X bits
VRB-to-PRB mapping - 1 bit.
Modulation and coding scheme - 5 bits
New data indicator - 1 bit
Redundancy version - 2 bits
HARQ process number - 4 bits
Downlink assignment index - 2 bits
TPC command for scheduled PUCCH - [2] bits
Physical uplink control channel (PUCCH) resource indicator- 3 bits
PDSCH-to-HARQ feedback timing indicator- [3] bits

DCI format 1_I may be used as non-fallback DCI for scheduling the PDSCH, and the CRC may be scrambled by a C-RNTI. DCI format 1_1 in which the CRC is scrambled by a C-RNTI may include the following pieces of information in Table 18 below, for example.

TABLE 18
Carrier indicator - 0 or 3 bits
Identifier for DCI formats - [1] bits
Bandwidth part indicator - 0, 1 or 2 bits
Frequency domain resource assignment
For resource allocation type 0, ┌N_{RB}^{DL,BWP}/P┐ bits
For resource allocation type 1, ┌log₂(N_{RB}^{DL,BWP}(N_{RB}^{DL,BWP} + 1)/2┐
bits
Time domain resource assignment -1, 2, 3, or 4 bits
VRB-to-PRB mapping - 0 or 1 bit, only for resource allocation type 1.
0 bit if only resource allocation type 0 is configured;
1 bit otherwise.
PRB bundling size indicator - 0 or 1 bit
Rate matching indicator - 0, 1, or 2 bits
ZP CSI-RS trigger - 0, 1, or 2 bits
For transport block 1:
Modulation and coding scheme - 5 bits
New data indicator - 1 bit
Redundancy version - 2 bits
For transport block 2:
Modulation and coding scheme - 5 bits
New data indicator - 1 bit
Redundancy version - 2 bits
HARQ process number - 4 bits
Downlink assignment index - 0 or 2 or 4 bits
TPC command for scheduled PUCCH - 2 bits
PUCCH resource indicator - 3 bits
PDSCH-to-HARQ_feedback timing indicator - 3 bits
Antenna ports - 4, 5 or 6 bits
Transmission configuration indication- 0 or 3 bits
SRS request - 2 bits
CBG transmission information - 0, 2, 4, 6, or 8 bits
CBG flushing out information - 0 or 1 bit
DMRS sequence initialization - 1 bit

### [PDCCH: CORESET, REG, CCE, Search Space]

Hereinafter, a downlink control channel in a 5G communication system will be described in more detail with reference to the accompanying drawings.

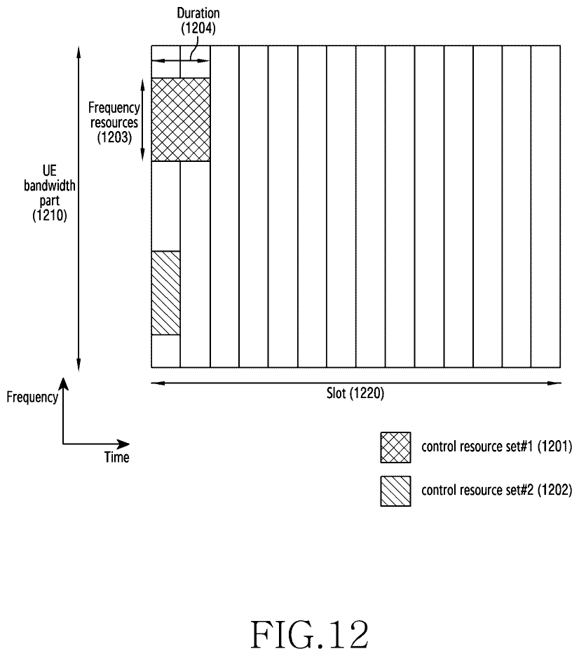

FIG. 12 illustrates an example of control resource set configuration with regard to a downlink control channel in a 5G wireless communication system according to an embodiment of the disclosure. To be specific, FIG. 12 illustrates an example of a control resource set (CORESET) used to transmit a downlink control channel in a 5G wireless communication system. FIG. 12 illustrates an example in which a UE bandwidth part 1210 is configured along the frequency axis, and two control resource sets (control resource set #1 1201 and control resource set #2 1202) are configured within one slot 1220 along the time axis. The control resource sets 1201 and 1202 may be configured in a specific frequency resource 1205 within the entire UE bandwidth part 1210 along the frequency axis. One or multiple OFDM symbols may be configured along the time axis, and this may be defined as a control resource set duration 1204. Referring to the example illustrated in FIG. 12, control resource set #1 1201 is configured to have a control resource set duration corresponding to two symbols, and control resource set #2 1202 is configured to have a control resource set duration corresponding to one symbol.

The control resource set in 5G as described above may be configured for a UE by a base station through upper layer signaling (for example, system information, master information block (MIB), radio resource control (RRC) signaling). The description that a control resource set is configured for a UE may mean that information such as a control resource set identity, the control resource set's frequency location, and the control resource set's symbol duration is provided. For example, the control resource set may include the following pieces of information in Table 19 below.

TABLE 19

| | |
|---|---|
| ControlResourceSet ::= | SEQUENCE { |

-- Corresponds to L1 parameter ‘CORESET-ID’

| | |
|---|---|
| controlResourceSetId | ControlResourceSetId, |

(control resource set identity))

| | |
|---|---|
| frequencyDomainResources | BIT STRING (SIZE (45)), |

(frequency domain resource assignment information)

| | |
|---|---|
| duration | INTEGER (1..maxCoReSetDuration), |

(time domain resource assignment information)

| | |
|---|---|
| cce-REG-MappingType | CHOICE { |

(CCE-to-REG mapping type)

| | |
|---|---|
| interleaved | SEQUENCE { |
| reg-BundleSize | ENUMERATED {n2, n3, n6}, |

(REG bundle size)

| | |
|---|---|
| precoderGranularity | ENUMERATED {sameAsREG- |

bundle, allContiguousRBs},

| | |
|---|---|
| interleaverSize | ENUMERATED {n2, n3, n6} |

```
    (interleaver size)
    shiftIndex
    INTEGER(0..maxNrofPhysicalResourceBlocks-1)
    OPTIONAL
    (interleaver shift)
  },
```

| | |
|---|---|
| nonInterleaved | NULL |

},

| | |
|---|---|
| tci-StatesPDCCH | SEQUENCE(SIZE |

```
  (1..maxNrofTCI-StatesPDCCH)) OF TCI-StateId
    OPTIONAL,
  (QCL configuration information)
```

| | |
|---|---|
| tci-PresentInDCI | ENUMERATED {enabled} |
| | OPTIONAL, -- Need S |

}

In Table 19, tci-StatesPDCCH (simply referred to as transmission configuration indication (TCI) state) configuration information may include information of one or multiple synchronization signal (SS)/physical broadcast channel (PBCH) block index or channel state information reference signal (CSI-RS) index, which is quasi-co-located with a DMRS transmitted in a corresponding control resource set.

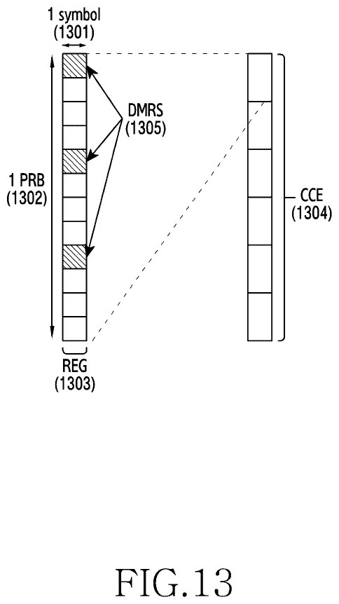

FIG. 13 illustrates a structure of a downlink control channel in a wireless communication system according to an embodiment of the disclosure. To be specific, FIG. 13 illustrates an example of a basic unit of time and frequency resources constituting a downlink control channel available in 5G. According to FIG. 13, the basic unit of time and frequency resources constituting a control channel may be referred to as a resource element group (REG) 1303, and the REG 1303 may be defined by one OFDM symbol 1301 along the time axis and one physical resource block (PRB) 1302 (for example, 12 subcarriers) along the frequency axis. The base station may configure a downlink control channel allocation unit by concatenating the REGs 1303.

Provided that the basic unit of downlink control channel allocation in 5G is a control channel element (CCE) 1304 as illustrated in FIG. 13, one CCE 1304 may include multiple REGs 1303. To describe the REG 1303 illustrated in FIG. 13, for example, the REG 1303 may include 12 REs, and if one CCE 1304 may include six REGs 1303, one CCE 1304 may include 72 REs. A downlink control resource set, once configured, may include multiple CCEs 1304, and a specific downlink control channel may be mapped to one or multiple CCEs 1304 and then transmitted according to the aggregation level (AL) in the control resource set. The CCEs 1304 in the control resource set are distinguished by numbers, and the numbers of CCEs 1304 may be allocated according to a logical mapping scheme.

The basic unit of the downlink control channel illustrated in FIG. 13 (for example, the REG 1303 may include both REs to which DCI is mapped, and an area to which a reference signal (DMRS 505) for decoding the same is mapped). As in FIG. 13, three DRMSs 1305 may be transmitted inside one REG 1303. The number of CCEs necessary to transmit a PDCCH may be 1, 2, 4, 8, or 16 according to the aggregation level (AL), and different number of CCEs may be used to implement link adaption of the downlink control channel. For example, in the case of AL=L, one downlink control channel may be transmitted through L CCEs. The UE needs to detect a signal while having no information regarding the downlink control channel, and a search space indicating a set of CCEs may thus be defined for blind decoding. The search space is a set of downlink control channel candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured ALs.

According to an embodiment, search spaces may be classified into common search spaces and UE-specific search spaces. A group of UEs or all UEs may investigate a common search space of the PDCCH in order to receive cell-common control information such as a paging message or dynamic scheduling regarding system information. For example, PDSCH scheduling allocation information for transmitting an SIB including a cell operator information or the like may be received by searching the common search space of the PDCCH. In the case of a common search space, a group of UEs or all UEs need to receive the PDCCH, and the same may thus be defined as a pre-promised set of CCEs. Scheduling allocation information regarding a UE-specific PDSCH or PUSCH may be received by investigating the UE-specific search space of the PDCCH. The UE-specific search space may be defined UE-specifically as a function of various system parameters and the identity of the UE.

In 5G, a parameter regarding a search parameter regarding a PDCCH may be configured for the UE by the base station through upper layer signaling (for example, SIB, MIB, RRC signaling). For example, the base station may provide the UE with configurations such as the number of PDCCH candidates at each aggregation level L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, a control resource set index for monitoring the search space, and the like. For example, the configuration information configured by the base station may include the following pieces of information in Table 20 below.

TABLE 20

| | |
|---|---|
| SearchSpace ::= | SEQUENCE { |

```
  -- Identity of the search space. SearchSpaceId = 0 identifies the SearchSpace
    configured via PBCH (MIB) or ServingCellConfigCommon.
```

| | |
|---|---|
| searchSpaceId | SearchSpaceId, |

(search space identity)

| | |
|---|---|
| controlResourceSetId | ControlResourceSetId, |

(control resource set identity)

| | |
|---|---|
| monitoringSlotPeriodicity AndOffset | CHOICE { |

(monitoring slot level cycle)

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |

}

| | |
|---|---|
| | OPTIONAL, |
| duration(monitoring duration) | INTEGER (2..2559) |
| monitoringSymbolsWithinSlot | BIT STRING (SIZE (14)) |
| | OPTIONAL, |

(monitoirng symbols within slot)

| | |
|---|---|
| nrofCandidates | SEQUENCE { |

(number of PDCCH candidates per aggregation level)

| | |
|---|---|
| aggregationLevel1 | ENUMERATED {n0, n1, n2, n3, n4, |

n5, n6, n8 },

| | |
|---|---|
| aggregationLevel2 | ENUMERATED {n0, n1, n2, n3, n4, |

n5, n6, n8},

| | |
|---|---|
| aggregationLevel4 | ENUMERATED {n0, n1, n2, n3, n4, |

n5, n6, n8},

| | |
|---|---|
| aggregationLevel8 | ENUMERATED {n0, n1, n2, n3, n4, |

n5, n6, n8},

| | |
|---|---|
| aggregationLevel16 | ENUMERATED {n0, n1, n2, n3, n4, |

```
    n5, n6, n8 }
  },
```

| | |
|---|---|
| search Space Type | CHOICE { |

```
  (search space type)
    -- Configures this search space as common search space (CSS) and DCI formats
    to monitor.
```

| | |
|---|---|
| common | SEQUENCE { |

```
  (common search space)
  }
```

| | |
|---|---|
| ue-Specific | SEQUENCE { |

```
  (UE-specific search space)
    -- Indicates whether the UE monitors in this USS for DCI formats 0-0 and 1-
    0 or for formats 0-1 and 1-1.
```

| | |
|---|---|
| formats | ENUMERATED {formats0-0-And- |

```
    1-0, formats0-1-And-1-1},
    ...
    }
```

According to configuration information, the base station may configure one or multiple search space sets for the UE. According to an embodiment, the base station may configure search space set I and search space set 2 for the UE, may configure DCI format A scrambled by an X-RNTI to be monitored in a common search space in search space set 1, and may configure DCI format B scrambled by a Y-RNTI to be monitored in a UE-specific search space in search space set 2.

According to the configuration information transmitted by the base station, a common search space or a UE-specific search space may include one or multiple search space sets. For example, search space set #1 and search space set #2 may be configured as a common search space, and search space set #3 and search space set #4 may be configured as a UE-specific search space.

Combinations of DCI formats and RNTIs given below may be monitored in a common search space. Obviously, the example given below is not limiting:
DCI format 0_0/1_0 with CRC scrambled by C-RNTI, CS-RNTI, SP-CSI-RNTI, RA-RNTI, TC-RNTI, P-RNTI, SI-RNTI;
DCI format 2_0 with CRC scrambled by SFI-RNTI;
DCI format 2_1 with CRC scrambled by INT-RNTI;
DCI format 2_2 with CRC scrambled by TPC-PUSCH-RNTI, TPC-PUCCH-RNTI; and/or
DCI format 2_3 with CRC scrambled by TPC-SRS-RNTI.

Combinations of DCI formats and RNTIs given below may be monitored in a UE-specific search space. Obviously, the example given below is not limiting:
DCI format 0_0/1_0 with CRC scrambled by C-RNTI, CS-RNTI, TC-RNTI; and/or
DCI format 1_0/1_1 with CRC scrambled by C-RNTI, CS-RNTI, TC-RNTI.

RNTIs not enumerated may follow the definition and usage given below:
Cell RNTI (C-RNTI): used to schedule a UE-specific PDSCH;
Temporary cell RNTI (TC-RNTI): used to schedule a UE-specific PDSCH;
Configured scheduling RNTI (CS-RNTI): used to schedule a semi-statically configured UE-specific PDSCH;
Random access RNTI (RA-RNTI): used to schedule a PDSCH in a random access step;
Paging RNTI (P-RNTI): used to schedule a PDSCH in which paging is transmitted;
System information RNTI (SI-RNTI): used to schedule a PDSCH in which system information is transmitted;
Interruption RNTI (INT-RNTI): used to indicate whether a PDSCH is punctured;
Transmit power control for PUSCH RNTI (TPC-PUSCH-RNTI): used to indicate a power control command regarding a PUSCH;
Transmit power control for PUCCH RNTI (TPC-PUCCH-RNTI): used to indicate a power control command regarding a PUCCH; and/or
Transmit power control for SRS RNTI (TPC-SRS-RNTI): used to indicate a power control command regarding an SRS.

The DCI formats enumerated above may follow the definitions in Table 21 below.

TABLE 21

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for PUCCH and |
| | PUSCH |
| 2_3 | Transmission of a group of TPC commands for |
| | SRS transmissions by one or more UEs |

In 5G, the search space at aggregation level L in connection with control resource set p and search space set s may be expressed by Equation 2 below

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad [ Equation 1 ]$$

L: aggregation level;
n_{ci}: carrier index;
N_{CCE,p}: total number of CCEs existing in control resource set p;
n_{s,f}^{μ}: slot index;
M_{s,max}^{(L)}: number of PDCCH candidates at aggregation level L;
m_{s,n}_{_{Cl}}=0, . . . , M_{s,max}^{(L)}−1: PDCCH candidate index at aggregation level L;
i=0, . . . , L−1;
Y_{p,n}_{_{s,f}}^{μ}=(Aₚ·Y_{p,n}_{_{s,f}}−1μ)mod D, Y_{p,-1}=n_{RNTI}≠0, Aₚ=39827 for pmod3=0 Aₚ=39829 for pmod3=1, Aₚ=39839 for pmod 3=2, D=65537; and
n_{RNTI}: UE identity

The Y_{p,n}_{_{s,f}}^{μ} value may correspond to 0 in the case of a common search space.

The Y_{p,n}_{_{s,f}}^{μ} value may correspond to a value changed by the UE's identity (C-RNTI or ID configured for the UE by the base station) and the time index in the case of a UE-specific search space.

In 5G, multiple search space sets may be configured by different parameters (for example, parameters in Table 20), and the group of search space sets monitored by the UE at each timepoint may differ. For example, if search space set #1 is configured at by X-slot cycle, if search space set #2 is configured at by Y-slot cycle, and if X and Y are different, the UE may monitor search space set #1 and search space set #2 both in a specific slot, and may monitor one of search space set #1 and search space set #2 both in another specific slot.

### [Downlink: PDSCH]

[PDSCH: regarding frequency resource allocation]

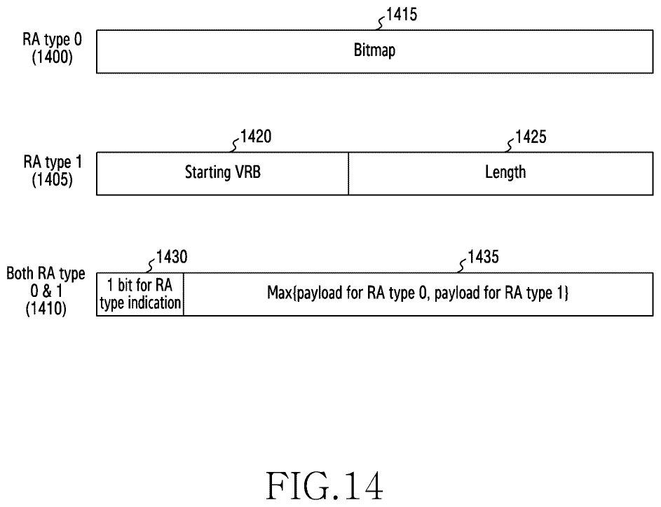

FIG. 14 illustrates an example of time domain resource allocation with regard to a physical downlink shared channel (PDSCH) in a wireless communication system according to an embodiment of the disclosure.

FIG. 14 illustrates three frequency domain resource allocation methods of type 0 1400, type 1 1405, and dynamic switch 1410 which can be configured through an upper layer in an NR wireless communication system.

Referring to FIG. 14, in the case 1400 in which a UE is configured to use only resource type 0 1400 through upper layer signaling, partial downlink control information (DCI) for allocating a PDSCH to the UE include a bitmap 1415 including NRBG bits. The condition for this will be described in detail later. As used herein, NRBG refers to the number of resource block groups (RBGs) determined according to the BWP size allocated by a BWP indicator and upper layer parameter rbg-Size, as in Table 22 below, and data is transmitted in RBGs indicated as “1” by the bitmap.

TABLE 22

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

In the case 1405 in which the UE is configured to use only resource type 1 through upper layer signaling, partial DCI includes frequency domain resource allocation information including [log₂(N_{RB}^{DL,BWP}(N_{RB}^{DL,BWP}+1)/2] i bits. The condition for this will be described in detail later. The base station may thereby configure a starting VRB 1420 and the length 1425 of a frequency domain resource allocated continuously therefrom.

In the case 1410 in which the UE is configured to use both resource type 0 and resource type 1 through upper layer signaling, partial DCI for allocating a PDSCH to the corresponding UE may include frequency domain resource allocation information including as many bits as the larger value 1435 between the payload 1415 for configuring resource type 0 and the payload 1420 and 1425 for configuring resource type 1. The condition for this will be described in detail later. One bit may be added to the foremost part (MSB) of the frequency domain resource allocation information inside the DCI. If the bit has the value of “0,” use of resource type 0 may be indicated, and if the bit has the value of “1,” use of resource type 1 may be indicated.

### [PDSCH/PUSCH: Regarding Time Resource Allocation]

Hereinafter, a time domain resource allocation method regarding a data channel in a next-generation mobile communication system (5G or NR system) will be described.

A base station may configure table regarding time domain resource allocation information regarding a physical downlink shared channel (PDSCH) and a physical uplink shared channel (PUSCH) for a UE through upper layer signaling (for example, RRC signaling). A table including a maximum of maxNrofDL-Allocations=16 entries may be configured for the PDSCH, and a table including a maximum of maxNrofUL-Allocations=16 entries may be configured for the PUSCH. In an embodiment, the time domain resource allocation information may include PDCCH-to-PDSCH slot timing (corresponding to a slot-unit time interval between a timepoint at which a PDCCH is received and a timepoint at which a PDSCH scheduled by the received PDCCH is transmitted; labeled KO), PDCCH-to-PUSCH slot timing (corresponding to a slot-unit time interval between a timepoint at which a PDCCH is received and a timepoint at which a PUSCH scheduled by the received PDCCH is transmitted; labeled K2), information regarding the location and length of the start symbol by which a PDSCH or PUSCH is scheduled inside a slot, the mapping type of a PDSCH or PUSCH, and the like. For example, information such as in Table 23 or Table 24 below may be transmitted from the base station to the UE.

TABLE 23
PDSCH-TimeDomainResourceAllocationList information element

```
  PDSCH-TimeDomainResourceAllocationList ::= SEQUENCE (SIZE(1..maxNrofDL-
Allocations)) OF
  PDSCH-TimeDomainResourceAllocation
  PDSCH-TimeDomainResourceAllocation ::= SEQUENCE {
    k0 INTEGER(0..32)
  OPTIONAL, -- Need S
    (PDCCH-to-PDSCH timing, slot unit)
      mappingType ENUMERATED {typeA, typeB},
  (PDSCH mapping type)
    startSymbolAndLength INTEGER (0..127)
    (start symbol and length of PDSCH)
  }
```

TABLE 24
PUSCH-TimeDomainResourceAllocationList information element

```
  PUSCH-TimeDomainResourceAllocationList ::= SEQUENCE (SIZE(1..maxNrofUL-
Allocations))
  OF PUSCH-TimeDomainResourceAllocation
  PUSCH-TimeDomainResourceAllocation ::= SEQUENCE
    k2 INTEGER(0..32)
  OPTIONAL, -- Need S
      (PDCCH-to-PUSCH timing, slot unit)
    mappingType ENUMERATED {typeA, typeB },
    (PUSCH mapping type)
      startSymbolAndLength INTEGER (0..127)
    (start symbol and length of PUSCH)
  }
```

The base station may notify the UF of one of the entries of the table regarding time domain resource allocation information described above through L1 signaling (for example, DCI) (for example, “time domain resource allocation” field in DCI may indicate the same). The UE may acquire time domain resource allocation information regarding a PDSCH or PUSCH, based on the DCI acquired from the base station.

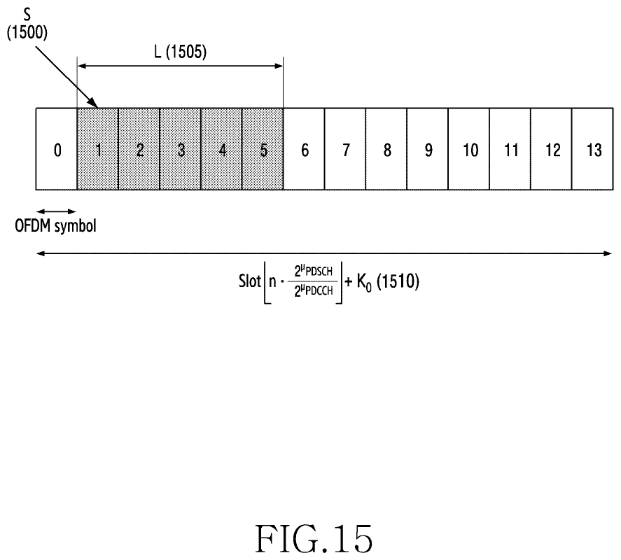

FIG. 15 illustrates an example of time domain resource allocation with regard to a PDSCH in a wireless communication system according to an embodiment of the disclosure.

Referring to FIG. 15, the base station may indicate the time domain location of a PDSCH resource according to the subcarrier spacing (SCS) (UPDSCH, UPDCCH) of a data channel and a control channel configured by using an upper layer, the scheduling offset (K0) value, and the start location 1500 and length 1505 of an OFDM symbol inside one slot 1510 dynamically indicated through DCI.

### [PDSCH: TCI State Activation MAC-CE]

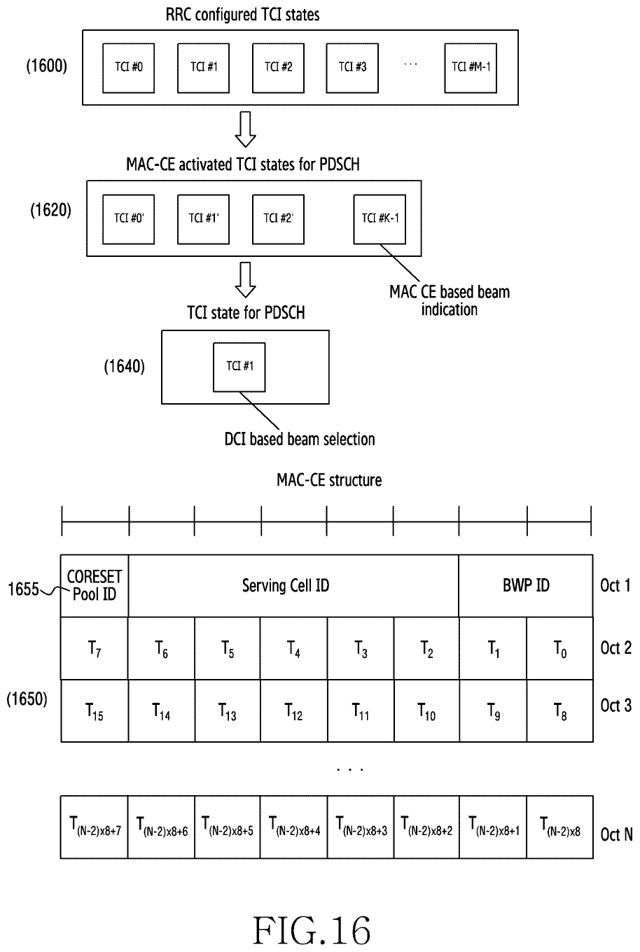

FIG. 16 illustrates a process for beam configuration and activation with regard to a PDSCH. To be specific, a list of TCI states regarding a PDSCH may be indicated through an upper layer list such as RRC (1600). The list of TCI states may be indicated by tci-StatesToAddModList and/or tci-StatesToReleaseList inside a BWP-specific PDSCH-Config 1E, for example. Subsequently, a part of the list of TCI states may be activated through an MAC-CE (1620). Among the TCI states activated through the MAC-CE, a TCI state for the PDSCH may be indicated by DCI (1640). The maximum number of activated TCI states may be determined by the capability reported by the UE. Referring to FIG. 16, the MAC CE structure 1650 including a CORESET Pool ID index 1655 illustrates an example of an MAC CE structure for the PDSCH TCI state activation/deactivation.

TABLE 25
Serving Cell ID: This field indicates the identity of the Serving Cell for which the
MAC CE applies. The length of the field is 5 bits. If the indicated Serving Cell is
configured as part of a simultaneousTCI-UpdateList1 or simultaneousTCI-UpdateList2
as specified in TS 38.331 [5], this MAC CE applies to all the Serving Cells configured
in the set simultaneousTCI-UpdateList1 or simultaneousTCI-UpdateList2,
respectively;
BWP ID: This field indicates a DL BWP for which the MAC CE applies as the
codepoint of the DCI bandwidth part indicator field as specified in TS 38.212 [9]. The
length of the BWP ID field is 2 bits. This field is ignored if this MAC CE applies to a
set of Serving Cells;
Tᵢ (TCI state ID): If there is a TCI state with TCI-StateId i as specified in TS 38.331
[5], this field indicates the activation/deactivation status of the TCI state with TCI-
StateId i, otherwise MAC entity may ignore the Ti field. The Ti field is set to 1 to
indicate that the TCI state with TCI-StateId i may be activated and mapped to the
codepoint of the DCI Transmission Configuration Indication field, as specified in TS
38.214 [7]. The Ti field is set to 0 to indicate that the TCI state with TCI-StateId i may
be deactivated and is not mapped to the codepoint of the DCI Transmission
Configuration Indication field. The codepoint to which the TCI State is mapped is
determined by its ordinal position among all the TCI States with Ti field set to 1, i.e.,
the first TCI State with Ti field set to 1 may be mapped to the codepoint value 0, second
TCI State with Ti field set to 1 may be mapped to the codepoint value 1 and so on. The
maximum number of activated TCI states is 8; and
CORESET Pool ID: This field indicates that mapping between the activated TCI
states and the codepoint of the DCI Transmission Configuration Indication set by field
Ti is specific to the ControlResourceSetId configured with CORESET Pool ID as
specified in TS 38.331 [5]. This field set to 1 indicates that this MAC CE may be
applied for the DL transmission scheduled by CORESET with the CORESET pool ID
equal to 1, otherwise, this MAC CE may be applied for the DL transmission scheduled
by CORESET pool ID equal to 0. If the coresetPoolIndex is not configured for any
CORESET, MAC entity may ignore the CORESET Pool ID field in this MAC CE when
receiving the MAC CE. If the Serving Cell in the MAC CE is configured in a cell list
that contains more than one Serving Cell, the CORESET Pool ID field may be ignored
when receiving the MAC CE.

### [Downlink: RS]

### [Ss/PBCH Block]

Next, synchronization signal (SS)/PBCH blocks in 5G will be described.

An SS/PBCH block may refer to a physical layer channel block including a primary SS (PSS), a secondary SS (SSS), and a PBCH. Details thereof are as follows:
PSS: a signal which becomes a reference of downlink time/frequency synchronization, and provides partial information of a cell ID;
SSS: becomes a reference of downlink time/frequency synchronization, and provides remaining cell ID information not provided by the PSS. Additionally, the SSS may play the role of a reference signal for PBCH demodulation;
PBCH: provides essential system information necessary for the UE's data channel and control channel transmission/reception. The essential system information may include search space-related control information indicating a control channel's radio resource mapping information, scheduling control information regarding a separate data channel for transmitting system information, and the like; and
SS/PBCH block: the SS/PBCH block includes a combination of a PSS, an SSS, and a PBCH. One or multiple SS/PBCH blocks may be transmitted within a time of 5 ms, and each transmitted SS/PBCH block may be distinguished by an index.

The UE may detect the PSS and the SSS in the initial access stage, and may decode the PBCH. The UE may acquire an MIB from the PBCH, and this may be used to configure control resource set (CORESET) #0 (which may correspond to a control resource set having a control resource set index of 0). The UE may monitor control resource set #0 by assuming that the demodulation reference signal (DMRS) transmitted in the selected SS/PBCH block and control resource set #0 is quasi-co-located (QCL). The UE may receive system information with downlink control information transmitted in control resource set #0. The UE may acquire configuration information related to a random access channel (RACH) necessary for initial access from the received system information. The UE may transmit a physical RACH (PRACH) to the base station in view of a selected SS/PBCH index, and the base station, upon receiving the PRACH, may acquire information regarding the SS/PBCH block index selected by the UE. The base station may know which block the UE has selected from respective SS/PBCH blocks, and the fact that control resource set #0 associated therewith is monitored.

### [Uplink: PUCCH]

### [PUSCH: Related to Transmission]

In the NR system, the UE may transmit control information (uplink control information (UCI)) to the BS through the PUCCH. The control information transmitted by the UE may include at least one of HARQ-ACK indicating whether demodulation/decoding of a transport block (TB) which the UE received through the PDSCH is successful, a scheduling request (SR) made by the UE to allocate resources to the BS for uplink data transmission of the PUSCH, and channel state information (CSI) which is information for reporting a channel state of the UE.

The PUCCH resources may be largely divided into a long PUCCH and a short PUCCH according to the length of allocated symbols. In the NR system, the long PUCCH has the length longer than or equal to 4 symbols within the slot and the short PUCCH has the length equal to or shorter than 2 symbols within the slot.

More specifically, the long PUCCH may be used to improve uplink cell coverage. Accordingly, the long PUCCH may be transmitted through a discrete Fourier transform (DFT)-spread(S)-OFDM scheme that is single carrier transmission rather than OFDM transmission. The long PUCCH may support transmission formats such as PUCCH format 1, PUCCH format 3, and PUCCH format 4 according to the number of supportable control information bits and whether UE multiplexing is supported through supporting of Pre-DFT OCC resources at an IFFT front end.

First, PUCCH format 1 is a DFT-S-OFDM-based long PUCCH format which can support control information up to 2 bits and may use frequency resources of 1 RB. The control information may include a combination of HARQ-ACK and SR or each thereof. In PUCCH format 1, an OFDM symbol including a demodulation reference signal (DMRS) (or a reference signal) and an OFDM symbol including a UCI may be repeated.

For example, when the number of transmission symbols of PUCCH format 1 is 8, the 8 symbols may sequentially include a DMRS symbol, a UCI symbol, a DMRS symbol, a UCI symbol, a DMRS symbol, a UCI symbol, a DMRS symbol, and a UCI symbol from the first start symbol. The DMRS symbol may be spread using an orthogonal code (or orthogonal sequence or spreading code w; (33)) in the time axis to the sequence corresponding to the length of 1 RB in the frequency axis within one OFDM symbol and transmitted after inverse after Fourier transform (IFFT) is performed.

The UCI symbol may be transmitted after the UE generates d(0) by modulating 1-bit control information to binary phase-shift keying (BPSK) and 2-bit control information to quadrature phase-shift keying (QPSK), multiplies the generated d(0) by the sequence corresponding to the length of 1 RB in the frequency axis to perform scrambling, spreads the scrambling sequence by using an orthogonal code (or orthogonal sequence or spreading code, w; (m)) in the time axis, and perform IFFT.

The UE may generate the sequence, based on a group hopping or sequence hopping configuration made by the BS through higher-layer signaling and a configured ID, perform cyclic shift on the generated sequence by using an initial cyclic shift (CS) value configured by a higher-layer signal, and generate the sequence corresponding to the length of 1 RB.

When the length of the spreading code (NSF) is given, w (m) may be determined as

$${w}_{i} ( m ) = {e}^{\frac{j 2 π ( m )}{{N}_{SF}}}$$

and indicated as shown in [Table 26] below in detail. i denotes an index of the spreading code itself, and m denotes indexes of elements of the spreading code. In [Table 26], numbers in [ ] denote Φ(m) and, for example, when the length of the spreading code is 2 and index I of the configured spreading code is 0, the spreading code W; (m) may be W (m)=[1 1] because of wⱼ(O)=e^{j2π·O/NSp}=1 and wᵢ(1)=e^{j2π·O/Ngf}=1.

TABLE 26
spreading code for PUCCH format 1

| | φ(m) | | | | | | |
|---|---|---|---|---|---|---|---|
| N_{SF} | i = 0 | i = 1 | i = 2 | i = 3 | i = 4 | i = 5 | i = 6 |
| | [0] | — | — | — | — | — | — |
| 2 | [0 0] | [0 1] | — | — | — | — | — |
| 3 | [0 0 0] | [0 1 2] | [0 2 1] | — | — | — | — |
| 4 | [0 0 0 0] | [0 2 0 2] | [0 0 2 2] | [0 2 2 0] | — | — | — |
| 5 | [0 0 0 0 0] | [0 1 2 3 4] | [0 2 4 1 3] | [0 3 1 4 2] | [0 4 3 2 1] | — | — |
| 6 | [0 0 0 0 0 0] | [0 1 2 3 4 5] | [0 2 4 0 2 4] | [0 3 0 3 0 3] | [0 4 2 0 4 2] | [0 5 4 3 2 1] | — |
| 7 | [0 0 0 0 0 0 0] | [0 1 2 3 4 5 6] | [0 2 4 6 1 3 5] | [0 3 6 2 5 1 4] | [0 4 1 5 2 6 3] | [0 5 3 1 6 4 2] | [0 6 5 4 3 2 1] |

PUCCH format 3 is a DFT-S-OFDM-based long PUCCH which can support control information larger than 2 bits, and the number of used RBs can be configured through a higher layer. The control information may include a combination of HARQ-ACK, SR, and CSI, or each thereof. In PUCCH format 3, the DMRS symbol location is presented in [Table 27] below according to whether frequency hopping is performed within the slot and whether an additional DMRS symbol is configured.

TABLE 27

| PUCCH | DMRS location in PUCCH format ¾ transmission | | | |
|---|---|---|---|---|
| | additional DMRS | | additional DMRS | |
| format | is not configured | | is configured | |
| ¾ | frequency | frequency | frequency | frequency |
| trans- | hopping is not | hopping is | hopping is not | hopping is |
| mission | | | | |
| length | configured | configured | configured | configured |
| 4 | 1 | 0, 2 | 1 | 0, 2 |

| | | |
|---|---|---|
| 5 | 0, 3 | 0, 3 |
| 6 | 1, 4 | 1, 4 |
| 7 | 1, 4 | 1, 4 |
| 8 | 1, 5 | 1, 5 |
| 9 | 1, 6 | 1, 6 |
| 10 | 2, 7 | 1, 3, 6, 8 |
| 11 | 2, 7 | 1, 3, 6, 9 |
| 12 | 2, 8 | 1, 4, 7, 10 |
| 13 | 2, 9 | 1, 4, 7, 11 |
| 14 | 3, 10 | 1, 5, 8, 12 |

For example, when the number of transmission symbols of PUCCH format 3 is 8, the 8 symbols have the first start symbol of 0, and the DMRS is transmitted in first and fifth symbols. [Table 27] is applied to the DMRS symbol location of PUCCH format 4 in the same way.

PUCCH format 4 is a DFT-S-OFDM-based long PUCCH format which can support control information larger than 2 bits and uses frequency resources of 1 RB. The control information may include a combination of HARQ-ACK, SR, and CSI, or each thereof. A difference between PUCCH format 4 and PUCCH format 3 is that PUCCH format 4 of a plurality of UEs can be multiplexed in one RB in the case of PUCCH format 4. PUCCH format 4 of a plurality of UEs can be multiplexed through the application of Pre-DFT orthogonal cover code (OCC) to control information at the IFFT front end. However, the number of control information symbols which can be transmitted by one UE may be reduced according to the number of multiplexed UEs. The number of UEs which can be multiplexed, that is, the number of different available OCCs may be 2 or 4, and the number of OCCs and OCC indexes to be applied may be configured through a higher layer.

According to an embodiment, the short PUCCH may be transmitted through both a downlink-centric slot and an uplink-centric slot and may be generally transmitted through the last symbol of the slot or an OFDM symbol in the back (for example, the last OFDM symbol, the second-to-last OFDM symbol, or the last two OFDM symbols). Of course, the short PUCCH can be transmitted at a random location within the slot. The short PUCCH may be transmitted using one OFDM symbol or two OFDM symbols. The short PUCCH may be used to reduce a delay time compared to the long PUCCH in the state in which the uplink cell coverage is good, and may be transmitted in a CP-OFDM scheme.

The short PUCCH may support transmission formats such as PUCCH format 0 and PUCCH format 2 according to the number of supportable control information bits. First, PUCCH format 0 is a short PUCCH format which can support control information up to 2 bits and may use frequency resources of 1 RB. The control information may include a combination of HARQ-ACK and SR or each thereof. PUCCH format 0 may include the structure in which no DMRS is transmitted and only a sequence mapped to 12 subcarriers in the frequency axis within one OFDM symbol is transmitted. The UE may generate the sequence, based on the group hopping or sequence hopping configuration made by the BS through a higher-layer signal and a configured ID, perform cyclic shift on the generated sequence by a final CS value obtained by adding another CS value to an indicated initial cyclic shift (CS) value according to ACK or NACK, map the sequence to 12 subcarriers, and perform transmission.

For example, when HARQ-ACK is 1 bit, the UE may generate the final CS by adding 6 to the initial CS value in the case of ACK and generate the final CS by adding 0 to the initial CS in the case of NACK as shown in [Table 28] below. 0 which is the CS value for NACK and 6 which is the CS value for ACK are defined in the standard, and the UE may generate PUCCH format 0 according to the value defined in the standard and transmit 1-bit HARQ-ACK.

TABLE 28

| HARQ-ACK: 1-bit | NACK | ACK |
|---|---|---|
| final CS | (initial CS + 0) mod | (initial CS + 6) |
| | 12 = initial CS | mod 12 |

For example, when HARQ-ACK is 2 bits, 0 may be added to the initial CS value in the case of (NACK, NACK), 3 may be added to the initial CS value in the case of (NACK, ACK), and 6 may be added to the initial CS value in the case of (ACK, ACK), and 9 may be added to the initial CS value in the case of (ACK, NACK) as shown in [Table 29] below. 0 which is the CS value for (NACK, NACK), 3 which is the CS value for (NACK, ACK), 6 which is the CS value for (ACK, ACK), and 9 which is the CS value for (ACK, NACK) may be defined in the standard, and the UE may generate PUCCH format 0 according to the value defined in the standard and transmit 2-bit HARQ-ACK. When the final CS value is larger than 12 by the CS value added to the initial CS value according to ACK or NACK, the length of the sequence may be 12 and thus modulo 12 may be applied to the final CS value.

TABLE 29

| HARQ- | | | | |
|---|---|---|---|---|
| ACK: | NACK, | NACK, | ACK, | ACK, |
| 2-bit | NACK | ACK | ACK | NACK |
| final CS | (initial | (initial | (initial | (initial |
| | CS + 0) | CS + 3) | CS + 6) | CS + 9) |
| | mod 12 = | mod 12 | mod 12 | mod 12 |
| | initial CS | | | |

PUCCH format 2 is a short PUCCH format supporting control information larger than 2 bits, and the number of used RBs may be configured through a higher layer. The control information may include a combination of HARQ-ACK, SR, and CSI, or each thereof. When an index of a first subcarrier is #0, PUCCH format 2 may be fixed to subcarriers having locations of indexes of #1, #4, #7, and #10 at which the DMSR is transmitted within one OFDM symbol. The control information may be mapped to the remaining subcarriers except for the subcarriers at which the DMRS is located through a channel modulation process after channel coding.

Values which can be configured for the respective PUCCH formats and ranges thereof may be as shown in [Table 30] below. When there is no need to configure a value, N.A. is expressed in [Table 30] below.

TABLE 30

| | | PUCCH | PUCCH | PUCCH | PUCCH | PUCCH |
|---|---|---|---|---|---|---|
| | | Format 0 | Format 1 | Format 2 | Format 3 | Format 4 |
| Starting symbol | Configurabiliry | ✓ | ✓ | ✓ | ✓ | ✓ |
| | Value range | 0-13 | 0-10 | 0-13 | 0 -10 | 0-10 |
| Number of | Configurability | ✓ | ✓ | ✓ | ✓ | ✓ |
| symbols in a slot | Value range | 1, 2 | 4-14 | 1,2 | 4 -14 | 4-14 |
| Index for | Configurability | ✓ | ✓ | ✓ | ✓ | ✓ |
| identifying | | | | | | |
| starting PRB | Value range | 0-274 | 0-274 | 0-274 | 0-274 | 0-274 |
| Number of PRBs | Configurability | N.A. | N.A. | V | | N.A. |
| | Value range | N.A.(Default | N.A.(Default | 1-16 | 1-6, 8-10, 12. 15, 16 | N.A. |
| | | is 1) | is 1) | | | (Default is 1) |
| Enabling | Configurability | ✓ | ✓ | ✓ | ✓ | ✓ |
| frequency | | | | | | |
| hopping | Value range | On/Off (only for 2 | On/off | On/Off (only for 2 | On/off | On/off |
| (intra-slot) | | symbol) | | symbol) | | |
| Freqncy resource | Configurability | ✓ | ✓ | ✓ | ✓ | ✓ |
| of 2^{nd} hop if | | | | | | |
| intra-slot | | | | | | |
| frequency | Value range | 0-274 | 0-274 | 0-274 | 0-274 | 0-274 |
| hopping is | | | | | | |
| enabled | | | | | | |
| Index of initial | Configurability | ✓ | ✓ | N.A. | N.A. | N.A. |
| cyclic shift | Value range | 0-11 | 0-11 | N.A. | N.A. | N.A. |
| Index of | Configurability | N.A. | ✓ | N.A. | N.A. | N.A. |
| time-domain | | | | | | |
| OCC | Value range | N.A. | 0-6 | N.A. | N.A. | N.A. |
| Length of | Configurability | N.A. | N.A. | N.A. | N.A. | ✓ |
| Pre-DFT OCC | Value range | N.A. | N.A. | N.A | N.A. | 2, 4 |
| Index of Pre-DFT | Configurability | N.A. | N.A. | N.A. | N.A. | ✓ |
| OCC | Value range | N.A. | N.A. | N.A. | N.A. | 0, 1, 2, 3 |

Meanwhile, in order to improve the uplink coverage, multi-slot repetitive may be supported for PUCCH formats 1, 3, and 4, and the PUCCH repetition may be configured for each PUCCH format. The UE may perform repetitive transmission for the PUCCH including pieces of UCI corresponding to the number of slots configured through higher-layer signaling nrofSlots. For PUCCH repetitive transmission, PUCCH transmission of each slot may be performed using the same number of successive symbols, and the number of corresponding successive symbols may be configured through nrofSymbols in PUCCH-format 1, PUCCH-format 3, or PUCCH-format 4 which is higher-layer signaling. For PUCCH repetitive transmission, PUCCH transmission of each slot may be performed using the same start symbol, and the corresponding start symbol may be configured through startingSymbolIndex in PUCCH-format 1, PUCCH-format 3, or PUCCH-format 4 which is higher-layer signaling. For the PUCCH repetitive transmission, single PUCCH-spatialRelationInfo may be configured to a single PUCCH resource.

For thePUCCH repetitive transmission, for example, when the UE receives a configuration of frequency hopping in PUCCH transmission in different slots, the UE may perform frequency hopping in units of slots.

Further, when the UE receives a configuration of frequency hopping in PUCCH transmission in different slots, the UE may start PUCCH transmission from a first PRB index configured through higher-layer signaling startingPRB in even-numbered slots and starts PUCCH transmission from a second PRB index configured through higher-layer signaling secondHopPRB in odd-numbered slots.

For example, when the UE receives a configuration of frequency hopping in PUCCH transmission in different slots, an index of a slot indicated to the UE for first PUCCH transmission may be 0, and a value of the number of PUCCH repetitive transmissions may increase regardless of PUCCH transmission in each slot during the number of all the configured PUCCH repetitive transmissions.

For example, when the UE receives a configuration of frequency hopping in PUCCH transmission in different slots, the UE does not expect a configuration of frequency hopping within the slot in PUCCH transmission.

For example, when the UE does not receive the configuration of frequency hopping in different slots in PUCCH transmission but receives the configuration of frequency hopping within the slot, first and second PRB indexes may be equally applied even in the slot.

For example, when the number of uplink symbols for PUCCH transmission is smaller than nrofSymbols configured through higher-layer signaling, the UE may not transmit the PUCCH.

For example, although the UE did not transmit the PUCCH in the slot for any reason during PUCCH repetitive transmission, the UE may increase the number of PUCCH repetitive transmissions.

In NR Release 17, the BS may configure the number of slots repeatedly transmitted for each PUCCH resource within PUCCH-ResourceExt that is the extension of higher-layer signlaing PUCCH-Resource for PUCCH resources through higher-layer signlaing pucch-RepetitionNrofSlots-r17. If the corresponding higher-layer signaling pucch-RepetitionNrofSlots-r17 is configured, the corresponding PUCCH resources are scheduled, and higher-layer signlaing nrofSlots is also configured, the UE may determine the number of slots for repeatedly transmitting the corresponding PUCCH resources through pucch-RepetitionNrofSlots-r17 and ignore the higher-layer signlaing nrofSlots.

### [PUCCH: PUCCH Resource Configuration]

Subsequently, a PUCCH resource configuration of the BS or the UE is described. The BS can configure PUCCH resources for each BWP through a higher layer for a specific UE. The PUCCH resource configuration may be as shown in [Table 31] below.

```
TABLE 31
PUCCH-Config ::= SEQUENCE {
  resourceSetToAddModList SEQUENCE (SIZE (1..maxNrofPUCCH-
ResourceSets)) OF PUCCH-ResourceSet OPTIONAL, -- Need N
  resourceSetToReleaseList SEQUENCE (SIZE (1..maxNrofPUCCH-
ResourceSets)) OF PUCCH-ResourceSetId OPTIONAL, -- Need N
  resourceToAddModList SEQUENCE (SIZE (1..maxNrofPUCCH-Resources))
OF PUCCH-Resource OPTIONAL, -- Need N
  resourceToReleaseList SEQUENCE (SIZE (1..maxNrofPUCCH-Resources)) OF
PUCCH-ResourceId OPTIONAL, -- Need N
  format1 SetupRelease { PUCCH-FormatConfig } OPTIONAL, -- Need M
  format2 SetupRelease { PUCCH-FormatConfig } OPTIONAL, -- Need M
  format3 SetupRelease { PUCCH-FormatConfig } OPTIONAL, -- Need M
  format4 SetupRelease { PUCCH-FormatConfig } OPTIONAL, -- Need M
  schedulingRequestResourceToAddModList SEQUENCE (SIZE (1..maxNrofSR-
Resources)) OF SchedulingRequestResourceConfig OPTIONAL, -- Need N
schedulingRequestResourceToReleaseList SEQUENCE (SIZE (1..maxNrofSR-
Resources)) OF SchedulingRequestResourceId OPTIONAL, -- Need N
  multi-CSI-PUCCH-ResourceList SEQUENCE (SIZE (1..2)) OF PUCCH-
ResourceId OPTIONAL, -- Need M
  dl-Data ToUL-ACK SEQUENCE (SIZE (1..8)) OF INTEGER (0..15)
OPTIONAL, -- Need M
  spatialRelationInfoToAddModList SEQUENCE (SIZE
(1..maxNrofSpatialRelationInfos)) OF PUCCH-SpatialRelationInfo OPTIONAL,
-- Need N
  spatialRelationInfoToReleaseList SEQUENCE (SIZE
(1..maxNrofSpatialRelationInfos)) OF PUCCH-SpatialRelationInfoId
OPTIONAL, -- Need N
  pucch-PowerControl PUCCH-PowerControl OPTIONAL, -- Need M
  ...,
  [[
  resourceToAddModListExt-r16 SEQUENCE (SIZE (1..maxNrofPUCCH-
Resources)) OF PUCCH-ResourceExt-r16 OPTIONAL, -- Need N
  dl-DataToUL-ACK-r16 SetupRelease { DL-DataToUL-ACK-r16 } OPTIONAL,
-- Need M
  ul-AccessConfigListDCI-1-1-r16 SetupRelease { UL-AccessConfigListDCI-1-1-r16
} OPTIONAL, -- Need M
  subslotLengthForPUCCH-r16 CHOICE {
    normalCP-r16 ENUMERATED {n2,n7},
    extendedCP-r16 ENUMERATED {n2,n6}
  } OPTIONAL, -- Need R
  dl-DataToUL-ACK-DCI-1-2-r16 SetupRelease { DL-DataToUL-ACK-DCI-1-2-r16}
OPTIONAL, -- Need M
  numberOfBitsForPUCCH-ResourceIndicatorDCI-1-2-r16 INTEGER (0..3)
OPTIONAL, -- Need R
  dmrs-Uplink TransformPrecodingPUCCH-r16 ENUMERATED {enabled}
OPTIONAL, -- Cond PI2-BPSK
  spatialRelationInfoToAddModListSizeExt-v1610 SEQUENCE (SIZE
(1..maxNrofSpatialRelationInfosDiff-r16)) OF PUCCH-SpatialRelationInfo
OPTIONAL, -- Need N
  spatialRelationInfoToReleaseListSizeExt-v1610 SEQUENCE (SIZE
(1..maxNrofSpatialRelationInfosDiff-r16)) OF PUCCH-SpatialRelationInfoId
OPTIONAL, -- Need N
  spatialRelationInfoToAddModListExt-v1610 SEQUENCE (SIZE
(1..maxNrofSpatialRelationInfos-r16)) OF PUCCH-SpatialRelationInfoExt-r16
OPTIONAL, -- Need N
  spatialRelationInfoToReleaseListExt-v1610 SEQUENCE (SIZE
(1..maxNrofSpatialRelationInfos-r16)) OF PUCCH-SpatialRelationInfoId-r16 OPTIONAL, -
  - Need N
    resourceGroupToAddModList-r16 SEQUENCE (SIZE (1..maxNrofPUCCH-
ResourceGroups-r16)) OF PUCCH-ResourceGroup-r16 OPTIONAL, -- Need
N
  resourceGroupToReleaseList-r16 SEQUENCE (SIZE (1..maxNrofPUCCH-
ResourceGroups-r16)) OF PUCCH-ResourceGroupId-r16 OPTIONAL, -- Need
N
  sps-PUCCH-AN-List-r16 SetupRelease { SPS-PUCCH-AN-List-r16 }
OPTIONAL, -- Need M
  schedulingRequestResourceToAddModListExt-v1610 SEQUENCE (SIZE
(1..maxNrofSR-Resources) OF SchedulingRequestResourceConfigExt-v1610
OPTIONAL -- Need N
  ]]
  }
```

According to [Table 31] above, one or a plurality of PUCCH resource sets may be configured within a PUCCH resource configuration for a specific BWP, and a maximum payload value for UCI transmission may be configured in some of the PUCCH resource sets. One or a plurality of PUCCH resources may belong to each PUCCH resource set, and each PUCCH resource may belong to one of the PUCCH formats.

In the PUCCH resource sets, a maximum payload value of a first PUCCH resource set may be fixed to 2 bits. Accordingly, the corresponding value may not be separately configured through a higher layer. When the remaining PUCCH resource sets are configured, indexes of the corresponding PUCCH resource sets may be configured in an ascending order according to the maximum payload value, and no maximum payload value may be configured in the last PUCCH resource set. A higher-layer configuration for the PUCCH resource set may be as shown in [Table 32] below.

TABLE 32

| | |
|---|---|
| PUCCH-ResourceSet ::= | SEQUENCE { |
| pucch-ResourceSetId | PUCCH-ResourceSetId, |
| resourceList | SEQUENCE (SIZE (1..maxNrofPUCCH-ResourcesPerSet)) OF |

PUCCH-ResourceId,

| | |
|---|---|
| maxPayloadSize | INTEGER (4..256) OPTIONAL -- Need R |

}

IDs of the PUCCH resources belonging to the PUCCH resource set may be included in a parameter resourceList in [Table 32].

In initial access or when no PUCCH resource set is configured, a PUCCH resource set shown in [Table 33] below including a plurality of cell-specific PUCCH resources may be used in the initial BWP. In the PUCCH resource set, a PUCCH resource to be used for initial access may be indicated through SIB1.

TABLE 33

| | PUCCH | First | Number | PRB offset | Set of initial |
|---|---|---|---|---|---|
| Index | format | symbol | of symbols | RB_{BWP}^{offset} | CS indexes |
| 0 | 0 | 12 | 2 | 0 | {0, 3} |
| 1 | 0 | 12 | 2 | 0 | {0, 4, 8} |
| 2 | 0 | 12 | 2 | 3 | {0, 4, 8} |
| 3 | 1 | 10 | 4 | 0 | {0, 6} |
| 4 | 1 | 10 | 4 | 0 | {0, 3, 6, 9} |
| 5 | 1 | 10 | 4 | 2 | {0, 3, 6, 9} |
| 6 | 1 | 10 | 4 | 4 | {0, 3, 6, 9} |
| 7 | 1 | 4 | 10 | 0 | {0, 6} |
| 8 | 1 | 4 | 10 | 0 | {0, 3, 6, 9} |
| 9 | 1 | 4 | 10 | 2 | {0, 3, 6, 9} |
| 10 | 1 | 4 | 10 | 4 | {0, 3, 6, 9} |
| 11 | 1 | 0 | 14 | 0 | {0, 6} |
| 12 | 1 | 0 | 14 | 0 | {0, 3, 6, 9} |
| 13 | 1 | 0 | 14 | 2 | {0, 3, 6, 9} |
| 14 | 1 | 0 | 14 | 4 | {0, 3, 6, 9} |
| 15 | 1 | 0 | 14 | [N_{BWP}^{size}/4] | {0, 3, 6, 9} |

According to an embodiment, a maximum payload of each PUCCH resource included in the PUCCH resource set may be 2 bits in the case of PUCCH format 0 or 1, and may be determined by the symbol length, the number of PRBs, and a maximum code rate in the case of remaining formats. The symbol length and the number of PRBs may be configured for each PUCCH resource, and the maximum code rate may be configured for each PUCCH format.

Subsequently, selection of PUCCH resources for UCI transmission is described. According to an embodiment, in the case of SR transmission, a PUCCH resource for an SR corresponding to schedulingRequestID may be configured through a higher layer as show in [Table 34] below. The PUCCH resource may be a resource belonging to PUCCH format 0 or PUCCH format 1.

TABLE 34

| SchedulingRequestResourceConfig ::= SEQUENCE { | | |
|---|---|---|
| schedulingRequestResourceId | | SchedulingRequestResourceId, |
| schedulingRequestID | | SchedulingRequestId, |
| periodicity AndOffset | | CHOICE { |
| sym2 | | |
| sym6or7 | NULL, | |
| sl1 | NULL, | -- Recurs in every slot |
| sl2 | INTEGER (0..1), | |
| sl4 | INTEGER (0..3), | |
| sl5 | INTEGER (0..4), | |
| sl8 | INTEGER (0..7), | |
| sl10 | INTEGER (0..9), | |
| sl16 | INTEGER (0..15), | |
| sl20 | INTEGER (0..19), | |
| sl40 | INTEGER (0..39), | |
| sl80 | INTEGER (0..79), | |
| sl160 | INTEGER (0..159), | |
| sl320 | INTEGER (0..319), | |
| sl640 | INTEGER (0..639) | |
| } | OPTIONAL, -- Need M | |
| resource | PUCCH-ResourceId | OPTIONAL -- Need M |

}

A transmission period and an offset of the configured PUCCH resource may be configured through a parameter periodicity AndOffset in [Table 34]. When there is uplink data to be transmitted by the UE at a time point corresponding to the configured period and offset, the corresponding PUCCH resource may be transmitted, and otherwise, the corresponding PUCCH resource may not be transmitted.

In the case of CSI transmission, PUCCH resources to transmit a periodic CSI report or a semi-persistent CSI report through the PUCCH may be configured in a parameter pucch-CSI-ResourceList as shown in [Table 35] below. The parameter pucch-CSI-ResourceList may include a list of the PUCCH resources for each BWP for a cell or a component carrier (CC) to which the corresponding CSI report is transmitted. The PUCCH resource may be a resource belonging to PUCCH format 2, PUCCH format 3, or PUCCH format 4. The transmission period and the offset of the PUCCH resource may be configured through reportSlotConfig in [Table 35].

TABLE 35

| CSI-ReportConfig ::= | SEQUENCE { | |
|---|---|---|
| reportConfigId | CSI-ReportConfigId, | |
| carrier | ServCellIndex | OPTIONAL, -- Need S |

...

| | |
|---|---|
| reportConfigType | CHOICE { |
| periodic | SEQUENCE { |
| reportSlotConfig | CSI-ReportPeriodicityAndOffset, |
| pucch-CSI-ResourceList OF PUCCH- | SEQUENCE (SIZE (1..maxNrofBWPs)) |

CSI-Resource
},

| | |
|---|---|
| semiPersistentOnPUCCH | SEQUENCE { |
| reportSlotConfig | CSI-ReportPeriodicityAndOffset, |
| pucch-CSI-ResourceList OF PUCCH- | SEQUENCE (SIZE (1..maxNrofBWPs)) |

CSI-Resource
},

| | |
|---|---|
| semiPersistentOnPUSCH | SEQUENCE { |
| reportSlotConfig | ENUMERATED {sl5, sl10, sl20, sl40, sl80, sl160, sl320}, |
| reportSlotOffsetList | SEQUENCE (SIZE (1..maxNrofUL-Allocations)) OF |

INTEGER(0..32),

| | |
|---|---|
| p0alpha | P0-PUSCH-AlphaSetId |

},

| | |
|---|---|
| aperiodic | SEQUENCE { |
| reportSlotOffsetList | SEQUENCE (SIZE (1.. maxNrofUL-Allocations)) OF |

```
INTEGER(0..32)
    }
  },
  ...
  }
```

In the case of HARQ-ACK transmission, a resource set of the PUCCH resource to be transmitted may be first selected according to a payload of UCI including the corresponding HARQ-ACK. For example, a PUCCH resource set having a minimum payload which is not smaller than the UCI payload may be selected. Subsequently, a PUCCH resource within a PUCCH resource set may be selected through a PUCCH resource indicator (PRI) within DCI that schedules a TB corresponding to the corresponding HARQ-ACK. The PRI may be a PUCCH resource indicator specified in [Table 17] or [Table 18]. The relation between the PRI and the PUCCH resource selected from the PUCCH resource set may be as shown in [Table 36] below.

TABLE 36

| PUCCH | |
|---|---|
| resource | |
| indicator | PUCCH resource |
| ′000′ | 1^{st} PUCCH resource provided by pucch-ResourceId |
| | obtained from the 1^{st} value of resourceList |
| ′001′ | 2^{nd} PUCCH resource provided by pucch-ResourceId |
| | obtained from the 2^{nd} value of resourceList |
| ′010′ | 3^{rd} PUCCH resource provided by pucch-ResourceId |
| | obtained from the 3^{rd} value of resourceList |
| ′011′ | 4^{th} PUCCH resource provided by pucch-ResourceId |
| | obtained from the 4^{th} value of resourceList |
| ′100′ | 5^{th} PUCCH resource provided by pucch-ResourceId |
| | obtained from the 5^{th} value of resourceList |
| ′101′ | 6^{th} PUCCH resource provided by pucch-ResourceId |
| | obtained from the 6^{th} value of resourceList |
| ′110′ | 7^{th} PUCCH resource provided by pucch-ResourceId |
| | obtained from the 7^{th} value of resourceList |
| ′111′ | 8^{th} PUCCH resource provided by pucch-ResourceId |
| | obtained from the 8^{th} value of resourceList |

When the number of PUCCH resources selected from the selected PUCCH resource set is larger than 8, PUCCH resources may be selected by the [Equation 2] below.

$${r}_{PUCCH} = \{ \begin{matrix}⌊ \frac{{n}_{CCE , p} \cdot ⌈ {R}_{PUCCH} / 8 ⌉}{{N}_{CCE , p}} ⌋ + {Δ}_{PRI} \cdot ⌈ \frac{{R}_{PUCCH}}{8} ⌉ if {Δ}_{PRI} < {R}_{PUCCH} mod 8 \\ ⌊ \frac{{n}_{CCE , p} \cdot ⌈ {R}_{PUCCH} / 8 ⌉}{{N}_{CCE , p}} ⌋ + {Δ}_{PRI} \cdot ⌈ \frac{{R}_{PUCCH}}{8} ⌉ + {R}_{PUCCH} mod 8 if {Δ}_{PRI} \geq {R}_{PUCCH} mod 8\end{matrix} \} . \qquad [ Equation 2 ]$$

In [Equation 2], T_{PUCCH} denotes an index of a PUCCH resource selected within a PUCCH resource set, R_{PUCCH} denotes the number of PUCCH resources belonging to a PUCCH resource set, Δ_{PRI} denotes a PRI value, N_{CCE,p} denotes the total number of CCEs of a CORESET p to which received DCI belongs, and n_{CCE,p} denotes a first CCE index for received DCI.

A time point at which the corresponding PUCCH resource is transmitted is after: K₁ slots from TB transmission corresponding to the corresponding HARQ-ACK. Candidates of K₁ are configured through a higher layer and, more specifically, may be configured in a parameter dl-Data ToUL-ACK within PUCCH-Config shown in [Table 31]. Among the candidates, one value of: K₁ may be selected by a PDSCH-to-HARQ feedback timing indicator within DCI scheduling the TB, and the value may be a value shown in [Table 16] or [Table 17]. Meanwhile, the unit of x may be a slot or a subslot. The subslot is a unit of the length smaller than the slot, and one or a plurality of symbols may correspond to one subslot.

Subsequently, the case in which two or more PUCCH resources are located within one slot is described. The UE may transmit UCI through one or two PUCCH resources within one slot or subslot, and when UCI is transmitted through two PUCCH resources within one slot/subslot, i) each PUCH resource may not overlap in units of symbols and ii) at least one PUCCH resource may be short PUCCHs. Meanwhile, the UE may not expect transmission of a plurality of PUCCH resources for HARQ-ACK transmission within one slot.

### [PUSCH: Related to Transmission Beam]

Hereinafter, an uplink beam configuration to be used for PUCCH transmission will be described in detail.

For example, when the UE does not have a UE-specific configuration for a PUCCH resource configuration (dedicated PUCCH resource configuration), the PUCCH resource set may be provided through higher-layer signaling pucch-ResourceCommon in which case a beam configuration for PUCCH transmission may be based on a beam configuration used in PUSCH transmission scheduled through a random access response (RAR) UL grant. For example, when the UE has a UE-specific configuration for a PUCCH resource configuration (dedicated PUCCH resource configuration), a beam configuration for PUCCH transmission may be provided through higher-layer signaling pucch-spatialRelationInfoId included in [Table 31]. For example, when the UE receives a configuration of one pucch-spatialRelationInfold, the beam configuration for PUCCH transmission of the UE may be provided through one pucch-spatialRelationInfold. For example, when the UE receives a configuration of a plurality of pucch-spatialRelationInfoID, the UE may receive an indication of activation for one of the plurality of pucch-spatialRelationInfoID through a MAC control element (CE). The UE may receive a configuration of a maximum of 8 pucch-spatialRelationInfoID through higher-layer signaling and receive an indication of activation for only one pucch-spatialRelationInfoID. When the UE receives an indication of activation for pucch-spatialRelationInfoID through the MAC CE, the UE may apply activation of pucch-spatialRelationInfoID through the MAC CE, starting at a first slot after 3Nₛₗₒₜ^{subframe,μ} slots from a slot for HARQ-ACK transmission for a PDSCH transmitting the MAC CE including activation information of pucch-spatialRelationInfoID. u is numerology applied to PUCCH transmission, and Nₛₗₒₜ^{subframe,μ} is the number of slots per subframe in the given numerology. A higher-layer configuration for pucch-spatialRelationInfo may be as shown in [Table 37] below.

```
TABLE 37
PUCCH-SpatialRelationInfo ::= SEQUENCE {
  pucch-SpatialRelationInfoId PUCCH-SpatialRelationInfoId,
  servingCellId ServCellIndex OPTIONAL, -- Need S
  referenceSignal CHOICE {
  ssb-Index SSB-Index,
  csi-RS-Index NZP-CSI-RS-ResourceId,
  srs PUCCH-SRS
  },
  pucch-PathlossReferenceRS-Id PUCCH-PathlossReferenceRS-Id,
  p0-PUCCH-Id P0-PUCCH-Id,
  closedLoopIndex ENUMERATED { i0, i1 }
  }
  PUCCH-SpatialRelationInfoId ::= INTEGER (1..maxNrofSpatialRelationInfos)
```

According to [Table 37], a specific pucch-spatialRelationInfo configuration may include one referenceSignal configuration, and the corresponding referenceSignal may be ssb-Index indicating a specific SS/PBCH, csi-RS-Index indicating a specific CSI-RS, or srs indicating a specific SRS. If the referenceSignal is configured as ssb-Index, the UE may configure a beam used to receive an SS/PBCH corresponding to the ssb-Index among SS/PBCH within the serving cell which is the same as that of the UE as a beam for PUCCH transmission. If servingCellId is provided, the UE may configure a beam used to receive an SS/PBCH correpsonding to ssb-Index among SS/PBCH included in the cell indicated by servingCellId as a beam for pucch transmission. If referenceSignal is configured as csi-RS-Index, the UE may configure a beam used for reception of a CSI-RS corresponding to csi-RS-Index among the CSI-RSs within the same serving cell as the beam for PUCCH transmission or, when servingCellId is provided, configure a beam used for reception of a CSI-RS corresponding to csi-RS-Index among the CSI-RSs within a cell indicated by servingCellId as the beam for pucch transmission. If referenceSignal is configured as srs, the UE may configure a transmission beam used for transmission of an SRS corresponding to a resource index provided through a higher-layer signaling resource within the same serving cell and/or an activated uplink BWP as the beam for PUCCH transmission or, when servingCellID and/or uplinBWP is provided, configure a transmission beam used for transmission of an SRS corresponding to a resource index provided through a higher-layer signaling resource within a cell indicated by servingCellID and/or uplinkBWP and/or an uplink BWP as the beam for PUCCH transmission. The specific pucch-spatialRelationInfo configuration may include one pucch-PathlossReferenceRS-Id configuration. PUCCH-PathlossReferenceRS in [Table 38] can be mapped to pucch-PathlossReferenceRS-Id in [Table 37], and a maximum of four PUCCH-PathlossReferenceRS can be configured through pathlossReferenceRSs within higher-layer signaling PUCCH-PowerControl in [Table 38]. The ssb-Index may be configured when PUCCH-PathlossReferenceRS is connected to the SS/PBCH through higher-layer signaling referenceSignal, and csi-RS-Index may be configured when PUCCH-PathlossReferenceRS is connected to the CSI-RS.

TABLE 38
PUCCH-PowerControl ::= SEQUENCE {

| | | |
|---|---|---|
| deltaF-PUCCH-f0 | INTEGER (−16..15) | OPTIONAL, -- Need R |
| deltaF-PUCCH-f1 | INTEGER (−16..15) | OPTIONAL, -- Need R |
| deltaF-PUCCH-f2 | INTEGER (−16..15) | OPTIONAL, -- Need R |
| deltaF-PUCCH-f3 | INTEGER (−16..15) | OPTIONAL, -- Need R |
| deltaF-PUCCH-f4 | INTEGER (−16..15) | OPTIONAL, -- Need R |

```
    p0-Set  SEQUENCE (SIZE (1..maxNrofPUCCH-P0-PerSet)) OF P0-PUCCH
OPTIONAL, -- Need M
    pathlossReferenceRSs  SEQUENCE  (SIZE  (1..maxNrofPUCCH-
```

| | |
|---|---|
| PathlossReferenceRSs)) OF PUCCH-PathlossReferenceRS | OPTIONAL, -- Need |

```
M
    twoPUCCH-PC-AdjustmentStates  ENUMERATED {twoStates}  OPTIONAL, --
Need S
    ...,
    [[
```

| | |
|---|---|
| pathlossReferenceRSs-v1610 SetupRelease | { PathlossReferenceRSs-v1610 } |

```
OPTIONAL -- Need M
    ]]
  }
```

| | |
|---|---|
| P0-PUCCH ::= | SEQUENCE { |
| p0-PUCCH-Id | P0-PUCCH-Id, |
| p0-PUCCH-Value | INTEGER (−16..15) |
| } | |
| P0-PUCCH-Id ::= | INTEGER (1..8) |

```
  PathlossReferenceRSs-v1610 ::=  SEQUENCE  (SIZE  (1..maxNrofPUCCH-
PathlossReferenceRSsDiff-r16)) OF PUCCH-PathlossReferenceRS-r16
  PUCCH-PathlossReferenceRS ::=  SEQUENCE {
    pucch-PathlossReferenceRS-Id  PUCCH-PathlossReferenceRS-Id,
```

| | |
|---|---|
| referenceSignal | CHOICE { |

ssb-Index SSB-Index,

| | |
|---|---|
| csi-RS-Index | NZP-CSI-RS-ResourceId |

```
    }
  }
  PUCCH-PathlossReferenceRS-r16 ::=  SEQUENCE {
    pucch-PathlossReferenceRS-Id-r16  PUCCH-PathlossReferenceRS-Id-v1610,
    referenceSignal-r16  CHOICE {
      ssb-Index-r16  SSB-Index,
      csi-RS-Index-r16  NZP-CSI-RS-ResourceId
    }
  }
```

### [PUCCH: Group-Based Spatial Relation Activation]

In Rel-15, when the UE receives a configuration of a plurality of pucch-spatialRelationInfoID, the UE may determine the spatial relation of corresponding PUCCH resources by receiving a MAC CE for activating the spatial relation for each PUCCH resource. However, this method has a disadvantage of much signaling overhead to activate the spatial relation of a plurality of PUCCH resources. Accordingly, in Rel-16, a new MAC CE for adding a PUCCH resource group and activating the spatial relation in units of PUCCH resource groups has been introduced. For the PUCCH resource groups, a maximum of 4 PUCCH resource groups may be configured through resourceGroup ToAddModList in [Table 31], and for each PUCCH resource group, a plurality of PUCCH resource IDs within one PUCCH resource group may be configured as a list as shown in [Table 39].

TABLE 39

| | |
|---|---|
| PUCCH-ResourceGroup-r16 ::= | SEQUENCE { |
| pucch-ResourceGroupId-r16 | PUCCH-ResourceGroupId-r16, |
| resourcePerGroupList-r16 | SEQUENCE (SIZE (1..maxNrofPUCCH- |

ResourcesPerGroup-r16)) OF PUCCH-ResourceId
}

| | |
|---|---|
| PUCCH-ResourceGroupId-r16 ::= | INTEGER (0..maxNrofPUCCH- |

ResourceGroups-1-r16)

In Rel-16, the BS may configure each PUCCH resource group in the UE through resourceGroupToAddModList in [Table 31] and the higher-layer configuration in [Table 39] and configure a MAC CE for simultaneously activating spatial relations of all PUCCH resources within one PUCCH resource group.

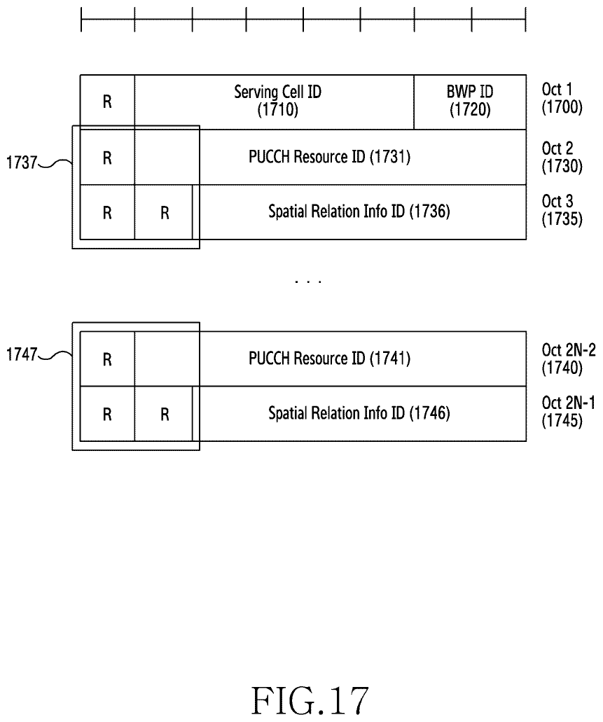

FIG. 17 illustrates an example of a medium access control (MAC) control element (CE) for activating the spatial relation based on a physical uplink control channel (PUCCH) resource group in a wireless communication system according to an embodiment of the disclosure.

Referring to FIG. 17, a serving cell ID 1710 in which a PUCCH resource to apply a MAC CE is configured and a BWP ID 1720 may be indicated by Oct. 1 1700. A PUCCH resource ID 1731 or 1741 indicated by Oct. 2 1730 (or Oct 2N-2 1740) may indicate IDs of the PUCCH resource. When the indicated PUCCH resource is included in a PUCCH resource group according to resourceGroupToAddModList, a different PUCCH resource ID within the same PUCCH resource group may not be indicated through the same MAC CE, and all PUCCH resources within the same PUCCH resource group may be activated by the same spatial relation info ID 1736 or 1746 indicated by Oct. 3 1735 (or Oct 2N-1 1745). At this time, the spatial relation info ID 1736 or 1746 may include a value corresponding to PUCCH-SpatialRelationInfold-1 to be applied to the PUCCH resource group in [Table 37].

### [Uplink: PUSCH]

### [PUSCH: Regarding Transmission Scheme]

Next, a PUSCH transmission scheduling scheme will be described. PUSCH transmission may be dynamically scheduled by a UL grant inside DCI, or operated by means of configured grant Type 1 or Type 2. Dynamic scheduling indication regarding PUSCH transmission may be made by DCI format 0_0 or 0_1.

Configured grant Type 1 PUSCH transmission may be configured semi-statically by receiving configuredGrantConfig including rrc-ConfiguredUplinkGrant in Table 40 through upper signaling, without receiving a UL grant inside DCI. Configured grant Type 2

PUSCH transmission may be scheduled semi-persistently by a UL grant inside DCI after receiving configuredGrantConfig not including rrc-ConfiguredUplinkGrant in Table 40 through upper signaling. If PUSCH transmission is operated by a configured grant, parameters applied to the PUSCH transmission may be applied through configuredGrantConfig (upper signaling) in Table 40 except for dataScramblingIdentityPUSCH, txConfig, codebookSubset, maxRank, and scaling of UCI-OnPUSCH, which are provided by pusch-Config in Table 41, which is upper signaling. If provided with transformPrecoder inside configuredGrantConfig (upper signaling) in Table 40, the UE may apply tp-pi2BPSK inside pusch-Config in [Table 26] to PUSCH transmission operated by a configured grant.

TABLE 40
ConfiguredGrantConfig ::= SEQUENCE {

| | |
|---|---|
| frequencyHopping | ENUMERATED {intraSlot, interSlot} |

OPTIONAL, -- Need S,
cg-DMRS-Configuration DMRS-UplinkConfig,

| | |
|---|---|
| mcs-Table | ENUMERATED {qam256, qam64LowSE} |

OPTIONAL, -- Need S
mcs-TableTransformPrecoder ENUMERATED {qam256, qam64LowSE}
OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, |

resourceAllocationType1, dynamicSwitch },

| | | |
|---|---|---|
| rbg-Size | ENUMERATED { config2} | OPTIONAL, -- |

```
Need S
    powerControlLoopToUse ENUMERATED {n0, n1},
    p0-PUSCH-Alpha P0-PUSCH-AlphaSetId,
```

| | |
|---|---|
| transformPrecoder | ENUMERATED {enabled, disabled} |

OPTIONAL, -- Need S
nrofHARQ-Processes INTEGER(1..16),

| | |
|---|---|
| repK | ENUMERATED {n1, n2, n4, n8}, |
| repK-RV | ENUMERATED {s1-0231, s2-0303, s3-0000} |

OPTIONAL, -- Need R
periodicity ENUMERATED {

sym2, sym7, sym1x14, sym2x14, sym4x14, sym5x14, sym8x14,

sym10x14, sym16x14, sym20x14,

sym32x14, sym40x14, sym64x14, sym80x14, sym128x14,

sym160x14, sym256x14, sym320x14, sym512x14,

sym640x14, sym1024x14, sym1280x14, sym2560x14,

sym5120x14,

sym6, sym1x12, sym2x12, sym4x12, sym5x12, sym8x12,

sym10x12, sym16x12, sym20x12, sym32x12,

sym40x12, sym64x12, sym80x12, sym128x12, sym160x12,

sym256x12, sym320x12, sym512x12, sym640x12,

sym1280x12, sym2560x12

},

| | |
|---|---|
| configuredGrantTimer INTEGER (1..64) | OPTIONAL, - |

```
- Need R
    rrc-ConfiguredUplinkGrant  SEQUENCE {
      timeDomainOffset  INTEGER (0..5119),
      timeDomainAllocation  INTEGER (0..15),
      frequencyDomainAllocation  BIT STRING (SIZE(18)),
      antennaPort  INTEGER (0..31),
```

| | |
|---|---|
| dmrs-SeqInitialization INTEGER (0..1) | OPTIONAL, -- |

Need R
precodingAndNumberOfLayers INTEGER (0..63),

| | |
|---|---|
| srs-ResourceIndicator INTEGER (0..15) | OPTIONAL, - |

- Need R
mcsAndTBS INTEGER (0..31),

| | |
|---|---|
| frequencyHoppingOffset | INTEGER (1.. |

maxNrofPhysicalResourceBlocks-1) OPTIONAL, -- Need R

| | |
|---|---|
| pathlossReferenceIndex | INTEGER (0..maxNrofPUSCH- |

PathlossReferenceRSs-1),
...

| | |
|---|---|
| } | OPTIONAL, -- Need R |

```
    ...
  }
```

Next, a PUSCH transmission method will be described in detail. The DMRS antenna port for PUSCH transmission is identical to an antenna port for SRS transmission. PUSCH transmission may follow a codebook-based transmission method and a non-codebook-based transmission method according to whether the value of txConfig inside pusch-Config in Table 41, which is upper signaling, is “codebook” or “nonCodebook.”

As described above, PUSCH transmission may be dynamically scheduled through DCI format 0_0 or 0_1, and may be semi-statically configured by a configured grant. Upon receiving indication of scheduling regarding PUSCH transmission through DCI format 0_0, the UE may perform beam configuration for PUSCH transmission by using pucch-spatialRelationInfoID corresponding to a UE-specific PUCCH resource corresponding to the minimum ID inside an activated uplink BWP inside a serving cell. In this case, the PUSCH transmission is based on a single antenna port. The UE may not expect scheduling regarding PUSCH transmission through DCI format 0_0 inside a BWP having no configured PUCCH resource including pucch-spatialRelationInfo. If the UE has no configured txConfig inside pusch-Config in Table 32, the UE may not expect scheduling through DCI format 0_1.

TABLE 41

| | |
|---|---|
| PUSCH-Config ::= | SEQUENCE { |

| | |
|---|---|
| dataScramblingIdentityPUSCH INTEGER (0..1023) | OPTIONAL, |

-- Need S

| | |
|---|---|
| txConfig ENUMERATED {codebook, nonCodebook} | OPTIONAL, |

```
-- Need S
  dmrs-UplinkForPUSCH-MappingTypeA  SetupRelease  { DMRS-UplinkConfig }
OPTIONAL, -- Need M
  dmrs-UplinkForPUSCH-MappingTypeB  SetupRelease  { DMRS-UplinkConfig }
OPTIONAL, -- Need M
```

| | | |
|---|---|---|
| pusch-PowerControl | PUSCH-PowerControl | OPTIONAL, -- |

Need M

| | | |
|---|---|---|
| frequencyHopping | ENUMERATED {intraSlot, interSlot} | OPTIONAL, |

-- Need S

| | |
|---|---|
| frequencyHoppingOffsetLists | SEQUENCE (SIZE (1..4)) OF INTEGER |

(1..maxNrofPhysicalResourceBlocks-1)
OPTIONAL, -- Need M

| | |
|---|---|
| resourceAllocation | ENUMERATED { resourceAllocationType0, |

resourceAllocationType1, dynamicSwitch},

| | |
|---|---|
| pusch-TimeDomainAllocationList | SetupRelease { PUSCH- |

TimeDomainResourceAllocationList } OPTIONAL, -- Need M

| | | |
|---|---|---|
| pusch-AggregationFactor | ENUMERATED { n2, n4, n8 } | OPTIONAL, |

-- Need S

| | |
|---|---|
| mcs-Table ENUMERATED {qam256, qam64LowSE} | OPTIONAL, |

-- Need S

| | |
|---|---|
| mcs-TableTransformPrecoder | ENUMERATED {qam256, qam64LowSE} |

OPTIONAL, -- Need S

| | | |
|---|---|---|
| transformPrecoder | ENUMERATED {enabled, disabled} | OPTIONAL, |

-- Need S

| | |
|---|---|
| codebookSubset | ENUMERATED {fullyAndPartialAndNonCoherent, |

partialAndNonCoherent,nonCoherent}

| | OPTIONAL, -- Cond codebookBased | |
|---|---|---|
| maxRank | INTEGER (1..4) | OPTIONAL, -- Cond |

codebookBased

| | | |
|---|---|---|
| rbg-Size | ENUMERATED { config2} | OPTIONAL, -- |

Need S

| | | |
|---|---|---|
| uci-OnPUSCH | SetupRelease { UCI-OnPUSCH} | OPTIONAL, -- |

Need M

| | | |
|---|---|---|
| tp-pi2BPSK | ENUMERATED {enabled} | OPTIONAL, -- Need |

S
...
}

The codebook-based PUSCH transmission may be dynamically scheduled through DCI format 0_0 or 0_1, and may be operated semi-statically by a configured grant. If a codebook-based PUSCH is dynamically scheduled through DCI format 0_1 or configured semi-statically by a configured grant, the UE may determine a precoder for PUSCH transmission, based on an SRS resource indicator (SRI), a transmission precoding matrix indicator (TPMI), and a transmission rank (the number of PUSCH transmission layers).

The SRI may be given through the SRS resource indicator (a field inside DCI) or configured through srs-ResourceIndicator (upper signaling). During codebook-based PUSCH transmission, the UE may have at least one SRS resource configured therefor, and may have a maximum of two SRS resources configured therefor. If the UE is provided with an SRI through DCI, the SRS resource indicated by the SRI refers to the SRS resource corresponding to the SRI among SRS resources transmitted prior to the PDCCH including the SRI. In addition, the TPMI and the transmission rank may be given through “precoding information and number of layers” (a field inside DCI) or configured through precodingAndNumberOfLayers (upper signaling). The TPMI may be used to indicate a precoder applied to PUSCH transmission. If one SRS resource is configured for the UE, the TPMI may be used to indicate a precoder to be applied in the configured SRS resource. If multiple SRS resources are configured for the UE, the TPMI may be used to indicate a precoder to be applied in an SRS resource indicated through the SRI.

The precoder to be used for PUSCH transmission may be selected from an uplink codebook having the same number of antenna ports as the value of nrofSRS-Ports inside SRS-Config (upper signaling). In connection with codebook-based PUSCH transmission, the UE may determine a codebook subset, based on codebookSubset inside pusch-Config (upper signaling) and TPMI. The codebookSubset inside pusch-Config (upper signaling) may be configured to be one of “fullyAndPartial AndNonCoherent,” “partialAndNonCoherent,” or “noncoherent,” based on UE capability reported by the UE to the base station. For example, if the UE reported “partialAndNonCoherent” as UE capability, the UE may not expect that the value of codebookSubset (upper signaling) may be configured as “fully AndPartialAndNonCoherent.” In addition, if the UE reported “nonCoherent” as UE capability, UE may not expect that the value of codebookSubset (upper signaling) may be configured as “fully AndPartialAndNonCoherent” or “partialAndNonCoherent.” If nrofSRS-Ports inside SRS-ResourceSet (upper signaling) indicates two SRS antenna ports, UE may not expect that the value of codebookSubset (upper signaling) may be configured as “partialAndNonCoherent.”

The UE may have one SRS resource set configured therefor, wherein the value of usage inside SRS-ResourceSet (upper signaling) is “codebook,” and one SRS resource may be indicated through an SRI inside the SRS resource set. If multiple SRS resources are configured inside the SRS resource set wherein the value of usage inside SRS-ResourceSet (upper signaling) is “codebook,” the UE may expect that the value of nrofSRS-Ports inside SRS-Resource (upper signaling) is identical with respect to all SRS resources.

The UE may transmit, to the base station, one or multiple SRS resources included in the SRS resource set wherein the value of usage is configured as “codebook” according to upper signaling, and the base station may select one from the SRS resources transmitted by the UE and indicate the UE to be able to transmit a PUSCH by using transmission beam information of the corresponding SRS resource. In connection with the codebook-based PUSCH transmission, the SRI may be used as information for selecting the index of one SRS resource, and may be included in DCI. Additionally, the base station may add information indicating the rank and TPMI to be used by the UE for PUSCH transmission to the DCI. By using the SRS resource indicated by the SRI, the UE may apply the precoder indicated by the rank and TPMI indicated based on the transmission beam of the corresponding SRS resource, thereby performing PUSCH transmission.

Next, non-codebook-based PUSCH transmission will be described in detail. The non-codebook-based PUSCH transmission may be dynamically scheduled through DCI format 0_0 or 0_1, and may be operated semi-statically by a configured grant. If at least one SRS resource is configured inside an SRS resource set wherein the value of usage inside SRS-ResourceSet (upper signaling) is “nonCodebook,” non-codebook-based PUSCH transmission may be scheduled for the UE through DCI format 0_1.

With regard to the SRS resource set wherein the value of usage inside SRS-ResourceSet (upper signaling) is “nonCodebook,” one connected NZP CSI-RS resource (non-zero power CSI-RS) may be configured for the UE. The UE may calculate a precoder for SRS transmission by measuring the NZP CSI-RS resource connected to the SRS resource set. For example, if the difference between the last received symbol of an aperiodic NZP CSI-RS resource associated with the SRS resource set and the first symbol of aperiodic SRS transmission in the UE is less than 42 symbols, the UE may not expect that information regarding the precoder for SRS transmission will be updated.

If the configured value of resourceType inside SRS-ResourceSet (upper signaling) is “aperiodic,” the associated NZP CSI-RS may be indicated by an SRS request which is a field inside DCI format 0_1 or 1_1. If the associated NZP CSI-RS resource is an aperiodic NZP CSI-RS resource, the existence of the connected NZP CSI-RS may be indicated with regard to the case in which the value of SRS request (a field inside DCI format 0_1 or 1_1) is not “00.” The corresponding DCI may not indicate cross carrier or cross BWP scheduling. In addition, if the value of SRS request indicates the existence of a NZP CSI-RS, the NZP CSI-RS may be positioned in the slot used to transmit the PDCCH including the SRS request field. In this case, TCI states configured for the scheduled subcarrier are not configured as QCL-TypeD.

If there is a periodic or semi-persistent SRS resource set configured, the associated NZP CSI-RS may be indicated through associatedCSI-RS inside SRS-ResourceSet (upper signaling). With regard to non-codebook-based transmission, the UE does not expect that spatialRelationInfo which is upper signaling regarding the SRS resource and associatedCSI-RS inside SRS-ResourceSet (upper signaling) will be configured together.

If multiple SRS resources are configured for the UE, the UE may determine a precoder to be applied to PUSCH transmission and the transmission rank, based on an SRI indicated by the base station. The SRI may be indicated through the SRS resource indicator (a field inside DCI) or configured through srs-ResourceIndicator (upper signaling). Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the base station by the UE. SRS resources simultaneously transmitted by the UE occupy the same RB. The UE configures one SRS port for each SRS resource. There may be only one configured SRS resource set wherein the value of usage inside SRS-ResourceSet (upper signaling) is configured as “nonCodebook,” and there may be a maximum of four configured SRS resources for non-codebook-based PUSCH transmission.

The base station may transmit one NZP-CSI-RS connected to the SRS resource set to the UE, and the UE may calculate the precoder to be used when transmitting one or multiple SRS resources inside the corresponding SRS resource set, based on the result of measurement when the corresponding NZP-CSI-RS is received. The UE applies the calculated precoder when transmitting, to the base station, one or multiple SRS resources inside the SRS resource set wherein the configured usage is “nonCodebook,” and the base station selects one or multiple SRS resources from the received one or multiple SRS resources. In connection with the non-codebook-based PUSCH transmission, the SRI indicates an index that may express one SRS resource or a combination of multiple SRS resources, and the SRI is included in DCI. The number of SRS resources indicated by the SRI transmitted by the base station may be the number of transmission layers of the PUSCH, and the UE transmits the PUSCH by applying the precoder applied to SRS resource transmission to each layer.

[PUSCH: preparation procedure time]

Next, a PUSCH preparation procedure time will be described. If a base station schedules a UE so as to transmit a PUSCH by using DCI format 0_0, 0_1, or 0_2, the UE may require a PUSCH preparation procedure time such that a PUSCH is transmitted by applying a transmission method (SRS resource transmission precoding method, the number of transmission layers, spatial domain transmission filter) indicated through DCI. The PUSCH preparation procedure time of the UE may follow Equation 3 given below.

$${T}_{proc , 2} = max ( ( {N}_{2} {d}_{2 , 1} + {d}_{2} ) ( 2048 + 144 ) {κ2}^{- μ} {T}_{c} + {T}_{ext} + {T}_{switch} , {d}_{2 , 2} ) . \qquad [ Equation 3 ]$$

Each parameter in Tproc,2 described above in Equation 4 may have the following meaning:
N₂: may denote the number of symbols determined according to UE processing capability 1 or 2, based on the UE's capability, and numerology u. N₂ may have a value in [Table 42] if UE processing capability 1 is reported according to the UE's capability report, and may have a value in [Table 43] if UE processing capability 2 is reported, and if availability of UE processing capability 2 is configured through upper layer signaling;

TABLE 42

| | PUSCH preparation |
|---|---|
| μ | time N₂ [symbols] |
| 0 | 10 |
| 1 | 12 |
| 2 | 23 |
| 3 | 36 |

TABLE 43

| μ | PUSCH preparation time N₂ [symbols] |
|---|---|
| 0 | 5 |
| 1 | 5.5 |
| 2 | 11 for frequency range 1 |

d2,1: the number of symbols determined to be 0 if all resource elements of the first OFDM symbol of PUSCH transmission include DM-RSs, and to be 1 otherwise;
κ: 64;
μ: follows a value, among μ_{DL} and μ_{UL}, which makes T_{proc.2} larger. μ_{DL} may refer to the numerology of a downlink used to transmit a PDCCH including DCI that schedules a PUSCH, and μ_{DL} refers to the numerology of an uplink used to transmit a PUSCH;
T_{c}: may have 1/(Δfₘₐₓ·N_{f}), Δfₘₐₓ=480·10³ Hz, N_{f}=4096;
d_{2.2}: may follow a BWP switching time if DCI that schedules a PUSCH indicates BWP switching, and have 0 otherwise;
d₂: if OFDM symbols overlap temporally between a PUSCH having a high priority index and a PUCCH having a low priority index, the d2 value of the PUSCH having a high priority index may be used. Otherwise, d₂ is 0;
Tₑₓₜ: if the UE uses a shared spectrum channel access scheme, the UE may calculate Tₑₓₜ and apply the same to a PUSCH preparation procedure time. Otherwise, Tₑₓₜ is assumed to be 0; and
T_{switch}: if an uplink switching spacing has been triggered, T_{switch} is assumed to be the switching spacing time. Otherwise, T_{switch} is assumed to be 0.

The base station and the UE determine that the PUSCH preparation procedure time is insufficient if the first symbol of a PUSCH starts earlier than the first uplink symbol in which a CP starts after Tproc, 2 from the last symbol of a PDCCH including DCI that schedules the PUSCH, in view of the influence of timing advance between the uplink and the downlink and time domain resource mapping information of the PUSCH scheduled through the DCI. Otherwise, the base station and the UE determine that the PUSCH preparation procedure time is sufficient. The UE may transmit the PUSCH only if the PUSCH preparation procedure time is sufficient, and may ignore the DCI that schedules the PUSCH if the PUSCH preparation procedure time is insufficient.

### [PUSCH: Regarding Repeated Transmission]

Hereinafter, repeated transmission of an uplink data channel in a 5G system will be described in detail. A 5G system may support two types of methods for repeatedly transmitting an uplink data channel, PUSCH repeated transmission type A and PUSCH repeated transmission type B. One of PUSCH repeated transmission type A and type B may be configured for a UE through upper layer signaling.

### 1. PUSCH Repeated Transmission Type A

As described above, the symbol length of an uplink data channel and the location of the start symbol may be determined by a time domain resource allocation method in one slot, and a base station may notify a UE of the number of repeated transmissions through upper layer signaling (for example, RRC signaling) or L1 signaling (for example, DCI).
Based on the number of repeated transmissions received from the base station, the UE may repeatedly transmit an uplink data channel having the same length and start symbol as the configured uplink data channel, in a continuous slot. If the base station configured a slot as a downlink for the UE, or if at least one of symbols of the uplink data channel configured for the UE is configured as a downlink, the UE omits uplink data channel transmission, but counts the number of repeated transmissions of the uplink data channel.

### 2. PUSCH Repeated Transmission Type B

As described above, the start symbol and length of an uplink data channel may be determined by a time domain resource allocation method in one slot, and the base station may notify the UE of the number of repeated transmissions (numberofrepetitions) through upper layer signaling (for example, RRC signaling) or L1 signaling (for example, DCI).
The nominal repetition of the uplink data channel is determined as follows, based on the previously configured start symbol and length of the uplink data channel. The slot in which the nth nominal repetition starts is given by

$${K}_{s} + ⌊ \frac{S + n \cdot L}{{N}_{symb}^{slot}} ⌋ ,$$

and the symbol starting in that slot is given by mod (S+n·L, Nₛₗₒₜ^{symb}). The slot in which the nth nominal repetition ends is given by

$${K}_{s} + ⌊ \frac{S + ( n + 1 ) \cdot L - 1}{{N}_{symb}^{slot}} ⌋ ,$$

and the symbol ending in that slot is given by mod (S+(n+1)·L−1, N_{symb}^{slot}, this regard, n=0, . . . , numberofrepetitions-1, S refers to the start symbol of the configured uplink data channel, and L refers to the symbol length of the configured uplink data channel. Kₛ refers to the slot in which PUSCH transmission starts, and N_{symb}^{slot} refers to the number of symbols per slot.
The UE determines an invalid symbol for PUSCH repeated transmission type B. A symbol configured as a downlink by tdd-UL-DL-ConfigurationCommon or tdd-UL-DL-ConfigurationDedicated may be determined as the invalid symbol for PUSCH repeated transmission type B. Additionally, the invalid symbol may be configured in an upper layer parameter (for example, InvalidSymbolPattern). The upper layer parameter (for example, InvalidSymbolPattern) may provide a symbol level bitmap across one or two slots, thereby configuring the invalid symbol. In the bitmap, 1 represents the invalid symbol. Additionally, the cycle and pattern of the bitmap may be configured through the upper layer parameter (for example, InvalidSymbolPattern). For example, if an upper layer parameter (for example, InvalidSymbolPattern) is configured, and if parameter InvalidSymbolPatternIndicator-ForDCIFormat0_1 or InvalidSymbolPatternIndicator-ForDCIFormat0_2 indicates 1, the UE may apply an invalid symbol pattern, and if the above parameter indicates 0, the UE may not apply the invalid symbol pattern. For example, if an upper layer parameter (for example, InvalidSymbolPattern) is configured, and if parameter InvalidSymbolPatternIndicator-ForDCIFormat0_1 or InvalidSymbolPatternIndicator-ForDCIFormat0_2 is not configured, the UE may apply the invalid symbol pattern.

After an invalid symbol is determined, the UE may consider, with regard to each nominal repetition, that symbols other than the invalid symbol are valid symbols. If one or more valid symbols are included in each nominal repetition, the nominal repetition may include one or more actual repetitions. Each actual repetition includes a set of consecutive valid symbols available for PUSCH repeated transmission type B in one slot.

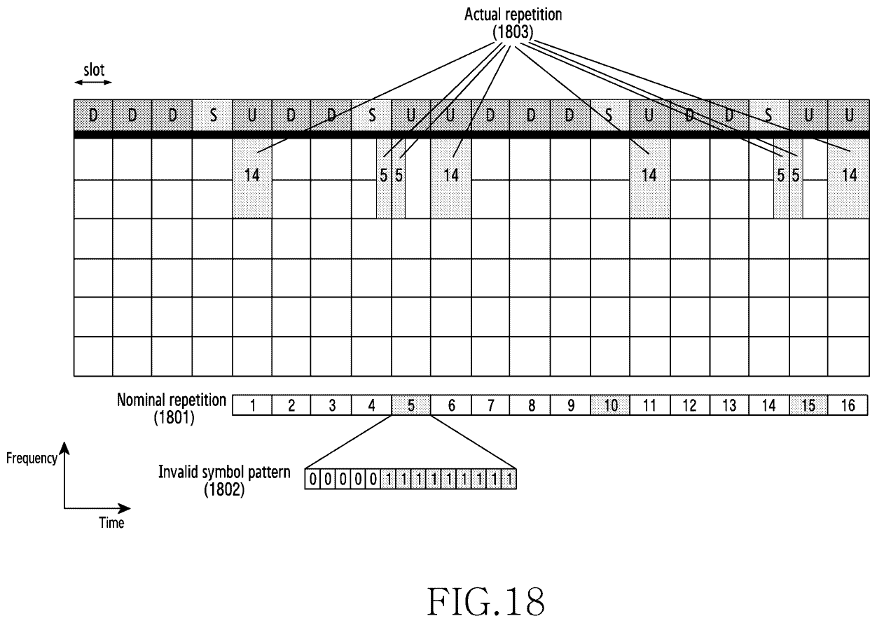

FIG. 18 illustrates an example of PUSCH repeated transmission type B in a wireless communication system according to an embodiment of the disclosure. The UE may receive the following configurations: the start symbol S of an uplink data channel is 0, the length L of the uplink data channel is 14, and the number of repeated transmissions is 16. In this case, nominal repetitions appear in 16 consecutive slots (1801). Thereafter, the UE may determine that the symbol configured as a downlink symbol in each nominal repetition 1801 is an invalid symbol. In addition, the UE determines that symbols configured as 1 in the invalid symbol pattern 1802 are invalid symbols. If valid symbols other than invalid symbols in respective nominal repetitions constitute one or more consecutive symbols in one slot, the UE may transmit them as actual repetitions (1803).

In addition, with regard to PUSCH repeated transmission, additional methods may be defined in NR Release 16 with regard to UL grant-based PUSCH transmission and configured grant-based PUSCH transmission, across slot boundaries, as follows.
Method 1 (mini-slot level repetition): through one UL grant, two or more PUSCH repeated transmissions are scheduled inside one slot or across the boundary of consecutive slots. In addition, in connection with method 1, time domain resource allocation information inside DCI indicates resources of the first repeated transmission. In addition, time domain resource information of remaining repeated transmissions may be determined according to time domain resource information of the first repeated transmission, and the uplink or downlink direction determined with regard to each symbol of each slot. Each repeated transmission occupies consecutive symbols.
Method 2 (multi-segment transmission): through one UL grant, two or more PUSCH repeated transmissions are scheduled in consecutive slots. Transmission no. 1 is designated with regard to each slot, and the start point or repetition length may differ between respective transmission. In addition, in method 2, time domain resource allocation information inside DCI may indicate the start point and repetition length of all repeated transmissions. In addition, when performing repeated transmissions inside a single slot through method 2, if there are multiple bundles of consecutive uplink symbols in the corresponding slot, respective repeated transmissions may be performed with regard to respective uplink symbol bundles. For example, if there is a single bundle of consecutive uplink symbols in the corresponding slot, PUSCH repeated transmission may be performed once according to the method of NR Release 15.
Method 3: two or more PUSCH repeated transmissions are scheduled in consecutive slots through two or more UL grants. Transmission no. 1 may be designated with regard to each slot, and the nth UL grant may be received before PUSCH transmission scheduled by the (n-1) th UL grant is over.
Method 4: through one UL grant or one configured grant, one or multiple PUSCH repeated transmissions inside a single slot, or two or more PUSCH repeated transmissions across the boundary of consecutive slots may be supported. The number of repetitions indicated to the UE by the base station is only a nominal value, and the UE may actually perform a larger number of PUSCH repeated transmissions than the nominal number of repetitions. Time domain resource allocation information inside DCI or configured grant refers to resources of the first repeated transmission indicated by the base station. Time domain resource information of remaining repeated transmissions may be determined with reference to resource information of the first repeated transmission and the uplink or downlink direction of symbols. For example, if time domain resource information of a repeated transmission indicated by the base station spans a slot boundary or includes an uplink/downlink switching point, the corresponding repeated transmission may be divided into multiple repeated transmissions. One repeated transmission may be included in one slot with regard to each uplink period.

### [PUSCH: Frequency Hopping Process]

Hereinafter, frequency hopping of a physical uplink shared channel (PUSCH) in a 5G system will be described in detail.

A 5G system supports two kinds of PUSCH frequency hopping methods with regard to each PUSCH repeated transmission type. First of all, in PUSCH repeated transmission type A, intra-slot frequency hopping and inter-slot frequency hopping are supported, and in PUSCH repeated transmission type B, inter-repetition frequency hopping and inter-slot frequency hopping are supported. The inter-slot frequency hopping method supported in PUSCH repeated transmission type A may include a method in which a UE transmits allocated resources in the frequency domain, after changing the same by a configured frequency offset, by two hops in one slot The start RB of each hop in connection with intra-slot frequency hopping may be expressed by Equation 4 below.

$${RB}_{start} = \{ \begin{matrix}{RB}_{start} & i = 0 \\ ( {RB}_{start} + {RB}_{offset} ) mod {N}_{BWP}^{size} & i = 1\end{matrix} . \qquad [ Equation 4 ]$$

In Equation 4, i-0 and i=1 denote the first and second hops, respectively, and RBstart denotes the start RB in a UL BWP and may be calculated from a frequency resource allocation method. RBoffset denotes a frequency offset between two hops through an upper layer parameter. The number of symbols of the first hop may be represented by [N_{symb}^{PUSCH,s/}2], and number of symbols of the second hop may be represented by N_{symb}^{PUSCH,2}−[N_{symb}^{PUSCH,s/}2]. N_{symb}^{PUSCH,s} is the length of PUSCH transmission in one slot and is expressed by the number of OFDM symbols.

Next, the inter-slot frequency hopping method supported in PUSCH repeated transmission types A and B may include a method in which the UE transmits allocated resources in the frequency domain, after changing the same by a configured frequency offset, in each slot. The start RB during nₛ^{μ} slots in connection with inter-slot frequency hopping may be expressed by Equation 5 below.

$${RB}_{start} ( {n}_{s}^{μ} ) = \{ \begin{matrix}{RB}_{start} & {n}_{s}^{μ} mod 2 = 0 \\ ( {RB}_{start} + {RB}_{offset} ) mod {N}_{BWP}^{size} & {n}_{s}^{μ} mod 2 = 1\end{matrix} . \qquad [ Equation 5 ]$$

In Equation 5, nₛ^{μ} denotes the current slot number during multi-slot PUSCH transmission, and RBstart denotes the start RB inside a UL BWP and may be calculated from a frequency resource allocation method. RB_{offset} denotes a frequency offset between two hops through an upper layer parameter. Next, the inter-repetition frequency hopping method supported in PUSCH repeated transmission type B may include a method in which resources allocated in the frequency domain regarding one or multiple actual repetitions in each nominal repetition are moved by a configured frequency offset and then transmitted. The index RBstart (n) of the start RB in the frequency domain regarding one or multiple actual repetitions in the nth nominal repetition may follow Equation 6 below

$${RB}_{start} ( n ) = \{ \begin{matrix}{RB}_{start} & n mod 2 = 0 \\ ( {RB}_{start} + {RB}_{offset} ) mod {N}_{BWP}^{size} & n mod 2 = 1\end{matrix} .$$

In Equation 6, n denotes the index of nominal repetition, and RB_{offset} denotes an RB offset between two hops through an upper layer parameter.

### [PUSCH: Related to Transmission Power]

Hereinafter, a method of determining transmission power of an uplink data channel in a 5G system is described in detail.

The 5G system may determine transmission power of an uplink data channel through [Equation 7] below.

$${P}_{PUSCH , b , f , c} ( i , j , {q}_{d} , l ) = min \{ \begin{matrix}{P}_{CMAX , f , c} ( i ) , \\ {P}_{O \_ PUSCH b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF b , f , c} ( i ) + {f}_{b , f , c} ( i , l )\end{matrix} \} . \qquad [ Equation 7 ]$$

In [Equation 7], j is a grant type of a PUSCH, and specifically, j=0 is a PUSCH grant for a random access response, j=1 is a configured grant, and j ∈ {2,3, . . . , J−1} is a dynamic grant. P_{CMAX,jr}⁽ⁱ⁾ is maximum output power configured in the UE for a carrier f of a serving cell c in a PUSCH transmission occasion i. P_{0_PUSCH,f,c}^{(j)} may be a parameter including a sum of P_{O_NOMINAL_PUSCH,f,c}^{(j)} configured by a higher-layer parameter and P_{O_UEPUSCH,f,c}^{(j)} that can be determined through a higher-layer configuration and an SRI (for example, in the case of a dynamic grant PUSCH). M_{RBb,f,c}^{PUSCH}(i) is a bandwidth for resource allocation expressed by the number of resource blocks in the PUSCH transmission occasion i, and Δ_{TF,b,f,c}⁽ⁱ⁾ is a value determined according to a modulation coding scheme (MCS) and a type of information transmitted through a PUCCH (for example, whether a UL-SCH is included or whether CSI is included). α_{b,f,c}^{(j)} is a value for compensating pathloss and corresponds to a value that can be determined through a higher-layer configuration and an SRS resource indicator (SRI) (in the case of a dynamic grant PUSCH). PL_{b,f,c}^{(qd)} may be a downlink pathloss estimation value that the UE estimates through a reference signal having a reference signal index q_{d}. The UE may determine the reference signal index q_{d} through the higher-layer configuration and the SRI (for example, in the case of a dynamic grant PUSCH or a configured grant PUSCH based on ConfiguredGrantConfig that does not include a higher-layer configuration rrc-ConfiguredUplinkGrant (type 2 configured grant PUSCH)) or through the higher-layer configuration. f_{b,f,c}^{(i,l)} is a closed loop power control value and may be supported in an accumulation type and an absolute type. For example, when a higher-layer parameter tpc-Accumulation is not configured in the UE, the UE may determine a closed loop power control value in the accumulation type. At this time, f_{b,f,c}^{(i,l)} is determined

$${f}_{b , f , c} ( i - {i}_{0} , l ) + {\sum }_{\text{?} = \text{?}}^{\text{?}} {δ}_{PUSCH , b , f , c} ( m , l )$$

$$\text{?} \text{indicates text missing or illegible when filed}$$

that is a sum of a closed loop power control value for a PUSCH transmission occasion i-i₀ and TPC command values for closed loop index 1 through DCI between a symbol K_{PUSCH}(i-i₀)−1 for transmitting the PUSCH transmission occasion i-i₀ and a symbol K_{PUSCH} (i) for transmitting the PUSCH transmission occasion i. For example, when the higher-layer parameter tpc-Accumulation is configured in the UE, f_{b,f,c}^{(i,l)} is determined as a TPC command value δ_{PUSCHb,f,c}^{(i,l)} for closed loop index 1 received through DCI. When the higher-layer parameter twoPUSCH-PC-AdjustementStates is configured in the UE, closed loop index 1 may be configured as 0 or 1, and the value may be determined through the higher-layer configuration and the SRI (for example, in the case of dynamic grant PUSCH). The mapping relation between a TPC command field within DCI and the TPC value δ_{PUSCHb,f,c} according to the accumulation type and the absolute type may be defined as shown in [Table 44] below.

TABLE 44

| TPC | Accumulated | Absolute |
|---|---|---|
| command field | δ_{PUSCH,b,f,c}[dB] | δ_{PUSCH,b,f,c}[dB] |
| 0 | −1 | −4 |
| 1 | 0 | −1 |
| 2 | 1 | 1 |
| 3 | 3 | 4 |

### [Related to PHR]

The power headroom report may include a process in which the UE measures a difference (for example, available transmission power of the UE) between nominal UE maximum transmission power and estimated power for uplink transmission and transmits the same to the BS. The power headroom report may be used to support power aware packet scheduling. The estimated power for uplink transmission may include estimated power for UL-SCH (PUSCH) per activated serving cell, estimated power for UL-SCH and PUCCH transmission in SpCell of a different MAC entity (for example, E-UTRA MAC entity in EN-DC, NE-DC, and NGEN-DC cases in the 3GPP standard), and estimated power for SRS transmission per activated serving cell. When at least one of the following trigger events is satisfied, the UE may trigger the power headroom report.
[Trigger event 1] when the higher-layer parameter phr-ProhibitTimer has expired and the MAC entity has an uplink resource for new transmission, pathloss for at least one activated serving cell may be changed more than the higher-layer parameter phr-Tx-PowerFactorChange dB after the latest PHR transmission. An activated downlink BWP for at least one activated serving cell may not be a dormant BWP. At this time, a change in pathloss for one cell may be determined as a difference between pathloss currently measured for current pathloss reference and pathloss measured at a corresponding time point for pathloss reference at the latest PHR transmission time point.
[Trigger event 2] the case where the higher-layer parameter phr-PeriodicTimer has expired.
[Trigger event 3] the case where a power headroom report function by a higher layer is configured or reconfigured rather than a configuration or reconfiguration corresponding to non-supporting of the power headroom report.
[Trigger event 4] when SCell for any MAC entity having an uplink in which firstActiveDownlinkBWP-Id is not configured as a dormant BWP is activated, firstActiveDownlinkBWP-Id may be an identifier of a DL BWP to be activated when an RRC (re) configuration is made (for exmaple, the configuration for the SpCell) or identifier of a DL BWP to be used when the SCell is activated (for example, the configuration for the SCell).
[Trigger event 5] the case where the PSCell is added (for example, the PSCell is newly added or is changed).
[Trigger event 6] the case where all of a) and b) are satisfied for specific activated serving cells of any MAC entity having the configured uplink when the higher-layer parameter phr-PrhoibitTimer has expired and the MAC entity has an uplink resource for new transmission:
   a) there is an uplink resource allocated for transmission or a PUCCH is transmitted to the corresponding cell; and
   b) the MAC entity has an uplink resource for transmission or when a PUCCH is transmitted to the corresponding cell, power backoff required due to power management for the corresponding cell is larger than the higher-layer parameter phr-Tx-PowerFactorChange dB after the latest PHR transmission.
[Trigger event 7] the case where an activated BWP of the SCell for any MAC entity having the configured uplink is changed to a non-dormant downlink BWP from the dormant BWP.
[Trigger event 8] the case where, for example, a higher-layer parameter mpe-Reporting-FR2 indicating whether there is a report on maximum allowed UE output power reduction (MPE P-MPR) to satisfy maximum permissible exposure (MPE) in FR2 is configured in the UE and mpe-ProhibitTimer does not run, the measured P-MPR applied to sastify FR2 MPE requirements is larger than or equal to a higher-layer parameter mpe-Threshold for one or more activated FR2 serving cells after the latest power headroom report when the power headeroom report is indicated as an “MPE P-MPR report.”

The power headroom report may be triggered according to the above-described trigger events, and the UE may determine the power headroom report according to the following additional conditions.
[Additional conditions according to temporary required power backoff] when required power backoff is temporarily reduced (for example, up to scores of ms) due to power management, the MAC entity may not trigger the power headroom report. For example, when the required power backoff is temporarily reduced and the power headroom report is triggered by different trigger events, a value of P_{CMAX.f.c}/PH indicating a ratio between maximum power and the remaining (available) power may be prevented from being temporarily reduced due thereto. For example, a PHR may be prevented from being triggered due to temporary backoff. For example, when the PHR is triggered by another PHR trigger event (for example, expiration of a periodic timer), conditions may be added to not report a PH that reflects temporary power reduction due to required power backoff and to report a PH except for influence of required power backoff.
[Power headroom report conditions according to UE implementation] for example, when one HARQ process is configured as cg-RetransmissionTimer, and a power headroom report is already included in a MAC PDU for transmission by the corresponding HARQ process but transmission through a lower layer has not been yet performed, a method of processing the content of the corresponding power headroom report may be determined according to UE implementation.

One or more of the trigger events may be generated and the power headroom report may be triggered, and when an uplink transmission resource allocated through downlink control information can accommodate the MAC entity for the power headroom report and a subheader therefor, the UE may transmit the power headroom report through the corresponding uplink resource. At this time, the corresponding uplink resource may be a resource for uplink transmission scheduled by the first downlink control format (first DCI format) scheduling initial transmission of a transport block (TB) after the power headroom trigger or the first uplink grant. For example, after the power headroom trigger is generated, the UE may transmit the power headroom report through uplink transmission scheduled by the first downlink control information format or the first uplink grant among uplink resources that may accommodate the MAC entity for the power headroom and the subheader therefor. Alternatively, after the power headroom trigger is generated, the UE may transmit the power headroom report through configured grant PUSCH transmission that may accommodate the MAC entity for the power headeroom and the subheader therefor.

When reporting the power headroom for a specific cell, the UE may select, calculate, and report one of two types of power headroom information. The first type is an actual PHR and may include power headroom information calculated based on actually transmitted uplink signal (for example, PUSCH) transmission power. The second type is a virtual PHR (or reference format) and may include power headroom information calculated based on a transmission power parameter configured by a higher layer without an actually transmitted uplink signal (for example, PUSCH). After the power headroom report is triggered, the UE may calculate the actual PHR, based on downlink control information received up to a time point including a PDCCH monitoring occasion in which a first DCI format for scheduling a PUSCH to transmit a MAC CE including the power headroom report is scheduled and higher-layer information for periodic/semi-persistent SRS transmission and configured grant transmission. For example, when the UE receives downlink control information after the PDCCH monitoring occasion in which the first DCI format is received or determines periodic/semi-persistent SRS transmission or configured grant transmission, the UE may calculate the virtual PHR for the corresponding cell. Alternatively, after the power headroom report is triggered, the UE may calculate the actual PHR, based on downlink control information received up to a time point before T′_{proc.2}=T_{proc.2} corresponding to the PUSCH preparation process time from the first uplink symbol of the configured grant PUSCH that may transmit the corresponding power headroom information and higher-layer information for periodic/semi-persistent SRS transmission and configured grant transmission. For example, when the UE receives downlink control information after the time point before T′_{proc.2} from the first uplink symbol of the configured grant PUSCH or determines periodic/semi-persistent SRS transmission or configured grant transmission, the UE may calculate the virtual PHR for the corresponding cell.

When the UE calculates the actual PHR, based on actual PUSCH transmission, power headroom report information for a serving cell c, a carrier f, a BWP b, and a PUSCH transmission time point i may be expressed as shown in [Table 8] below.

$${PH}_{type b , f , c} ( i , j , {q}_{d} , l ) = {P}_{CMAX , f , c} ( i ) - \{ {P}_{O \_ PUSCH b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l ) \} [ dB ] . \qquad [ Equation 8 ]$$

In another example, when the UE calculates the virtual PHR, based on a transmission power parameter configured by a higher layer, power headroom report information for the serving cell c, the carrier f, the BWP b, and the PUSCH transmission time point i may be expressed as shown in [Equation 9] below.

$${PH}_{type 1 b , f , c} ( i , j , {q}_{d} , l ) = {\tilde{P}}_{CMAX , f , c} ( i ) - \{ {P}_{O \_ PUSCH , b , f , c} ( j ) + {α}_{b , f , c} ( j ) \cdot {PL}_{b , f , c} ( {q}_{d} ) + {f}_{b , f , c} ( i , l ) \} [ dB ] . \qquad [ Equation 9 ]$$

According to [Equation 8] above, the UE may calculate power headroom information by using a difference between maximum output power and transmission power of the PUSCH transmission occasion i. According to [Equation 9], the power headroom information may be calculated using a difference from reference PUSCH transmission power using a parameter related to maximum power reduction (MPR) (for example, MPR, additional-MPR (A-MPR), and power management MPR (P-MPR)), \tilde{P}_{CMAXf,c}⁽ⁱ⁾ that is maximum output power in the case where Δ_{T}_{_{c}} is assumed as 0, and a default transmission power parameter (for example, P_{O_NOMINAL_PUSCH,fc}(0), p0 and alpha of P0-PUSCH-AlpahSet where p0-PUSCH-AlphaSetId=0, P_{Lb,f,c}(q_{d}) corresponding to pusch-PathlossReferenceRS-Id=0, and a closed loop power control value where closed loop index 1=0). For the description of each parameter in [Equation 8] and [Equation 9], refer to description of parameters in [Equation 7] above. The A-MPR may be MPR that satisfies additional emission requirements indicated by the BS through higher-layer signaling (for example, a network signaling label may be identified through a combination of additionalSpectrumEmission indicated by RRC and an NR freq. band (Table 6.2.3.1-1A within TS 38.101-1) and an A-MPR value according thereto may be defined as Table 6.2.3.1-1 within TS 38.101-1). The P-MPR is maximum allowed UE output power reduction for serving cell c and the purpose thereof may be to satisfy applicable electromagnetic energy absorption requirements. For the A-MPR and the P-MPR, refer to 3GPP standard TS 38.101-1 section 6.2. In the communication system to which the disclosure can be applied, the first type power headroom information may indicate power headroom information for PUSCH transmission power, the second type power headroom information may indicate power headroom information for PUCCH transmission power, and the third type headroom information may indicate power headroom information for SRS transmission power. Meanwhile, the disclosure is not limited thereto.

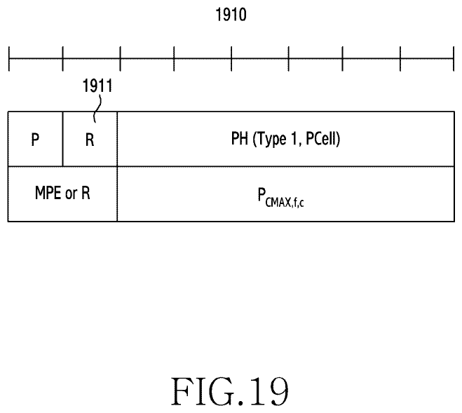

FIG. 19 illustrates a MAC CE format including single PHR information according to an embodiment of the disclosure.

For example, when MR-DC or UL-CA is not supported, the BS may configure a higher-layer parameter “multiplePHR” for the corresponding UE as “false.” This means that the UE supports the power headroom report on the PCell through a MAC CE having a single entry as indicated by a MAC CE 1910 in FIG. 19. Each field in FIG. 19 may be defined as shown in [Table 45] below. Meanwhile, the dentition is only an example, and the disclosure is not limited thereto.

TABLE 45
P: when mpe-Reporting-FR2 is configured and the serving cell operates in FR2, P of
1 bit is set as 0 if P-MPR applied according to TS38.133 is smaller than P-MPR_00, or
otherwise, set as 1. When mpe-Reporting-FR2 is not configured or the serving cell
operates in FR1, P indicates whether power backoff is applied to control transmission
power. When power backoff is not applied due to power management and thus
corresponding Pcmax,c field has a different value, the corresponding P area is set as 1.
PC_{MAX,f,c}: this field indicates a maximum transmission power value used for
calculating a power headroom when the power headroom is reported. One of 64
nominal UE transmit power levels may be selected with 6-bit information.
MPE: when mpe-Reporting-FR2 is configured, the serving cell operates in FR2, and
the P field is set as 1, the MPE area indicates a power backoff value applied to satisfy
maximum permissible exposure (MPE) requirements. A 2-bit field indicates one of a
total of 4 measured P-MPR values. When mpe-Reporting-FR2 is not configured, the
serving operates in FR1, or the P field is set as 0, a reserved bit like R may exist;
R: is a reserved bit and is set as 0.
PH: this field indicates a power headroom level and includes 6 bits, and may select
one of a total of 64 power headroom levels.

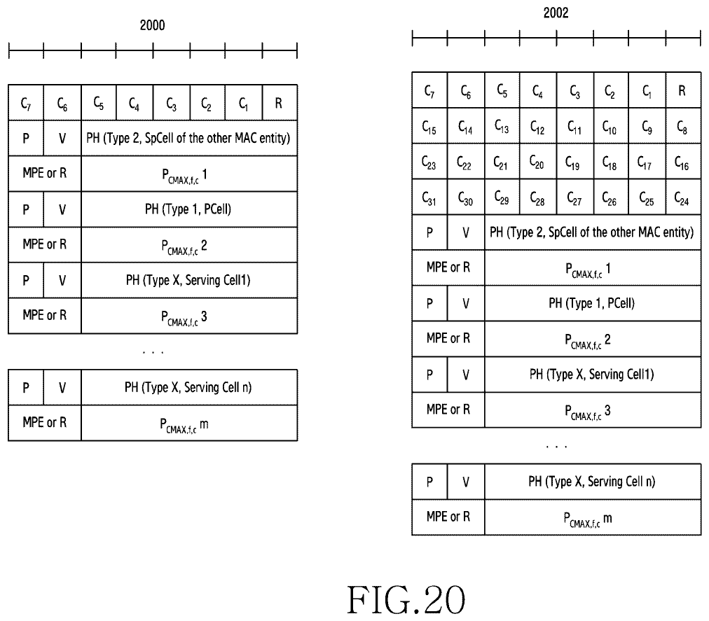

FIG. 20 illustrates a MAC CE format including a plurality of pieces of PHR information according to an embodiment of the disclosure.

For example, when the UE supports multi-RAT dual connectivity (MR-DC) or uplink carrier aggregation (UL-CA), the BS may configure a higher-layer parameter “multiplePHR” for the corresponding UE as “true” in order to transmit a power headroom report for each serving cell. This means supporting of the power headroom report for a plurality of serving cells through a MAC C having a plurality of entries like a first format 2000 or a second format 2002 illustrated in FIG. 20. The first format 2000 of FIG. 20 may receive a configuration of a plurality of serving cells and include a PHR MAC CE format that can be used when the largest index of the corresponding serving cells is smaller than 8. The second format 2002 of FIG. 20 may receive a configuration of a plurality of serving cells and include a PHR MAC CE format that can be used when the largest index of the corresponding serving cells is larger than or equal to 8.

According to an embodiment, the first format 2000 or the second format 2002 illustrated in FIG. 20 may have the variable size according to a set or the number of configured serving cells unlike the PHR MAC CE format illustrated in FIG. 19. The corresponding information may include the second type PH Information for a special cell (SpCell) of another MAC entity (for example, LTE) and the first type PH Information for the PCell. When the largest index of the corresponding serving cells is smaller than 8, a field informing of serving cell information may include one octet. When the largest index of the corresponding serving cells is larger than or equal to 8, a field informing of serving cell information may include four octets. The PHR MAC CE may include power headroom information fmf according to the order of serving cell indexes. When the power headroom report is triggered, the MAC entity may transmit the PHR MAC CE including power headroom information through a transmittable PUSCH. At this time, whether the power headroom information is calculated based on actual transmission (for example, actual PHR) or calculated based on the transmission power parameter configured by the higher layer (for example, virtual PHR) may be determined based on the higher-layer signal and downlink control information received up to the specific time (the time point including a PDCCH monitoring occasion in which the first DCI format is detected or the time point before T′proc.2 from the first symbol of the initial PUSCH). Meanwhile, the fields of the PHR MAC CE format illustrated in FIG. 20 may have the same meaning (definition) as most fields in the PHR MAC CE format illustrated in FIG. 19, and Cᵢ and V may have the meaning described in [Table 46] below.

TABLE 46
Cᵢ: this case indicates whether there is a power headroom area for a serving cell having
ServCellIndex i. when a power headroom for a serving cell i is reported, the
corresponding area Cᵢ is set as 1. When the power headroom for the serving cell i not
reported, the corresponding area Cᵢ is set as 0.
V: this area indicates whether a power headroom value is calculated based on actual
transmission or a reference format. For first type power headroom information, Vis set
as 0 when a PUSCH is actually transmitted, and set as 1 when the reference format for
the PUSCH is used. For second type PH information, Vis set as 0 when the PUCCH is
actually transmitted, and set as 1 when the reference format for the PUCCH is used.
For third type PH information, Vis set as 0 when an SRS is actually, and set as 1 when
the reference format for the SRS is used. Further, P_{cmax,f,c} and the MPE field therefor
may exist when the V value is 0 for the first type, second type, and third type power
headroom information, and P_{cmax,f,c} and the MPE field therefor may be omitted when
the V value is 1.

### [Uplink: RS]

### [Related to SRS]

Subsequently, a method of estimating an uplink channel using sounding reference signal (SRS) transmission by the UE is described. The BS may configure at least one SRS configuration in every uplink BWP and configure at least one SRS resource set in every SRS configuration in order to transmit configuration information for SRS transmission. For example, the BS and the UE may exchange higher-layer signaling information below in order to transmit information related to an SRS resource set:
srs-ResourceSetId: SRS resource set index;
srs-ResourceIdList: set of SRS resource indexes referred to by SRS resource set;
resourceType: indicates a time-axis transmission configuration of SRS resources referred to by an SRS resource set and is configured as one of “periodic,” “semi-persistent,” and “aperiodic.” For example, when “periodic” or “semi-persistent” is configured, associated CSI-RS information may be provided according to a used place of the SRS resource set. For example, when “aperiodic” is configured, an aperiodic SRS resource trigger list and slot offset information may be provided, and associated CSI-RS information may be provided according to a used place of the SRS resource set;
usage: indicates a configuration for a used place of SRS resources referred to by the SRS resource set and is configured as one of “beamManagement,” “codebook,” “nonCodebook,” and “antennaSwitching”; and
alpha, p0, pathlossReferenceRS, srs-PowerControlAdjustmentStates: may provide a parameter configuration for controlling transmission power of SRS resources referred to by the SRS resource set.

The UE may assume that SRS resources included in the set of SRS resource indexes referred to by the SRS resource set follow information configured in the SRS resource set.

Further, the BS and the UE may transmit and receive high-layer signaling information in order to transmit individual configuration information for SRS resources. For example, the individual configuration information for SRS resources may include time-frequency axis mapping information within the slot of SRS resources, which may include information on intra-slot or inter-slot frequency hopping of SRS resources. Further, the individual configuration information for SRS resources may include a time-axis transmission configuration of SRS resources and may be configured as one of “periodic,” “semi-persistent,” and “aperiodic.” This may be limited to have the time-axis transmission configuration such as the SRS resources set including SRS resources. When the time-axis transmission configuration of SRS resources is configured as “periodic” or “semi-persistent,” an SRS resource transmission period and a slot offset (for example, periodicityAndOffset) may be additionally configured in the time-axis transmission configuration.

The BS may activate, deactivate, or trigger SRS transmission to the UE through higher-layer signaling including RRC signaling or MAC CE signaling or L1 signaling (for example, DCI). For example, the BS may activate or deactivate periodic SRS transmission to the UE through higher-layer signaling. The BS may indicate activation of an SRS resource set having a resource Type configured as periodic through higher-layer signaling, and the UE may transmit SRS resources referred to by the activated SRS resource set. Time-frequency axis resource mapping within the slot of the SRS resources follows resource mapping information configured in the SRS resources, and slot mapping including the transmission period and the slot offset follows a periodicity AndOffset configured in the SRS resources. Further, a spatial domain transmission filter applied to the SRS resources may refer to spatial relation info configured in the SRS resources or refer to associated CSI-RS information configured in the SRS resource set including the SRS resources. The UE may transmit SRS resources within an uplink BWP activated for activated semi-persistent SRS resources through higher-layer signaling.

For example, the BS may activate or deactivate semi-persistent SRS transmission to the UE through high-layer signaling. The BS may indicate activation of the SRS resource set through MAC CE signaling, and the UE may transmit SRS resources referred to by the activated SRS resource set. The SRS resource set activated through MAC CE signaling may be limited to an SRS resource set having the resourceType configured as semi-persistent. Time-frequency axis resource mapping within the slot of the SRS resources follows resource mapping information configured in the SRS resources, and slot mapping including the transmission period and the slot offset follows a periodicity AndOffset configured in the SRS resources. Further, a spatial domain transmission filter applied to the SRS resources may refer to spatial relation info configured in the SRS resources or refer to associated CSI-RS information configured in the SRS resource set including the SRS resources. When spatial relation info is configured in the SRS resources, a spatial domain transmission filter may be determined with reference to configuration information for spatial relation info transmitted through MAC CE signaling activating semi-persistent SRS transmission without following the spatial relation info. The UE may transmit SRS resources within an uplink BWP activated for activated semi-persistent SRS resources through higher-layer signaling.

For example, the BS may trigger aperiodic SRS transmission to the UE through DCI. The BS may indicate one of the aperiodic SRS resource triggers (aperiodicSRS-ResourceTrigger) through an SRS request field of DCI. The UE may understand that an SRS resource set including the aperiodic SRS resource trigger indicated through DCI in an aperiodic SRS resource trigger list among SRS resource set configuration information is triggered. The UE may transmit the SRS resources referred to by the triggered SRS resource set. Time-frequency axis resource mapping within the slot of the SRS resources follows resource mapping information configured in the SRS resources. Further, slot mapping of the SRS resources may be determined through a slot offset between a PDCCH including DCI and the SRS resources, which may refer to a value(s) included in a slot offset set configured in the SRS resource set. Specifically, the slot offset between the PDCCH including DCI and the SRS resources may apply a value indicated by a time domain resource assignment field of DCI among an offset value(s) included in the slot offset set configured in the SRS resource set. Further, a spatial domain transmission filter applied to the SRS resources may refer to spatial relation info configured in the SRS resources or refer to associated CSI-RS information configured in the SRS resource set including the SRS resources. The UE may transmit SRS resources within an uplink BWP activated for triggered aperiodic SRS resources through DCI.

When the BS triggers aperiodic SRS transmission to the UE through DCI, the UE may need a minimum time interval between the PDCCH including DCI for triggering aperiodic SRS transmission and the transmitted SRS in order to transmit the SRS through the application of configuration information for SRS resource. The time interval for SRS transmission by the UE may be defined as the number of symbols between the last symbol of the PDCCH including DCI for triggering aperiodic SRS transmission and the first symbol to which the SRS resource that is first transmitted among the transmitted SRS resource(s) is mapped. The minimum time interval may be defined with reference to a PUSCH preparation procedure time required for preparing PUSCH transmission by the UE. Further, the minimum time interval may have different values according to a used place of the SRS resource set including the transmitted SRS resource. For example, the minimum time interval may be defined as N2 symbols defined in consideration of the UE processing capability according to the UE capability with reference to the PUSCH preparation procedure of the UE. Further, the minimum time interval may be determined as N2 symbols when the used place of the SRS resource set is configured as “codebook” or “antennaSwitching” in consideration of the used place of the SRS resource set including the transmitted SRS resource, and may be determined as N2+14 symbols when the used place of the SRS resource set is configured as “nonCodebook” or “beamManagement.” The UE may perform aperiodic SRS transmission when the time interval for aperiodic SRS transmission is longer than or equal to the minimum time interval, and may ignore DCI for triggering the aperiodic SRS when the time interval for aperiodic SRS transmission is shorter than the minimum time interval.

TABLE 47

| SRS-Resource ::= | SEQUENCE { | |
|---|---|---|
| srs-ResourceId | SRS-ResourceId, | |
| nrofSRS-Ports | ENUMERATED {port1, ports2, ports4}, | |
| ptrs-PortIndex | ENUMERATED {n0, n1 } | OPTIONAL, -- |

Need R

| | |
|---|---|
| transmissionComb | CHOICE { |
| n2 | SEQUENCE { |
| combOffset-n2 | INTEGER (0..1), |
| cyclicShift-n2 | INTEGER (0..7) |

},

| | |
|---|---|
| n4 | SEQUENCE { |
| combOffset-n4 | INTEGER (0..3), |
| cyclicShift-n4 | INTEGER (0..11) |

```
      }
    },
```

| | |
|---|---|
| resourceMapping | SEQUENCE { |
| startPosition | INTEGER (0..5), |
| nrofSymbols | ENUMERATED {n1, n2, n4}, |
| repetitionFactor | ENUMERATED {n1, n2, n4} |

},

| | |
|---|---|
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |

},

| | |
|---|---|
| groupOrSequenceHopping | ENUMERATED { neither, groupHopping, |

sequenceHopping },

| | |
|---|---|
| resourceType | CHOICE { |
| aperiodic | SEQUENCE { |

```
        ...
      },
```

| | |
|---|---|
| semi-persistent | SEQUENCE { |

| | |
|---|---|
| periodicityAndOffset-sp | SRS-PeriodicityAndOffset, |

```
        ...
      },
```

| | |
|---|---|
| periodic | SEQUENCE { |

| | |
|---|---|
| periodicityAndOffset-p | SRS-PeriodicityAndOffset, |

```
        ...
      }
    },
```

| sequenceId | INTEGER (0..1023), | |
|---|---|---|
| spatialRelationInfo | SRS-SpatialRelationInfo | OPTIONAL, -- |

```
Need R
    ...
  }
```

In [Table 47] above, spatialRelationInfo configuration information may be applied to a beam used for corresponding SRS transmission of beam information of the corresponding reference signal with reference to one reference signal. For example, the configuration of spatialRelationInfo may include information shown in [Table 48] below.

TABLE 48
SRS-SpatialRelationInfo ::= SEQUENCE {

| | | |
|---|---|---|
| servingCellId | ServCellIndex | OPTIONAL, -- Need S |

| | |
|---|---|
| referenceSignal | CHOICE { |
| ssb-Index | SSB-Index, |
| csi-RS-Index | NZP-CSI-RS-ResourceId, |
| srs | SEQUENCE { |
| resourceId | SRS-ResourceId, |
| uplinkBWP | BWP-Id |

```
      }
    }
  }
```

Referring to the spatialRelationInfo configuration, at least one of an SS/PBCH block index, a CSI-RS index, or an SRS index may be configured as an index of a reference signal to be referred to for using beam information of a specific reference signal. Higher-layer signaling referenceSignal is configuration information indicating a reference signal of which beam information is referred to for corresponding SRS transmission, ssb-Index is an index of an SS/PBCH block, csi-RS-Index is an index of a CSI-RS, and srs is an index of an SRS. For example, when a value of higher-layer signaling referenceSignal is configured as “ssb-Index,” the UE may apply a reception beam used for receiving the SS PBCH block corresponding to ssb-Index as a transmission beam of the corresponding SRS transmission. For example, when a value of higher-layer signaling referenceSignal is configured as “csi-RS-Index,” the UE may apply a reception beam used for receiving the CSI-RS corresponding to csi-RS-Index as a transmission beam of the corresponding SRS transmission. For example, when a value of higher-layer signaling referenceSignal is configured as “srs,” the UE may apply a transmission beam used for transmitting the SRS corresponding to srs as a transmission beam of the corresponding SRS transmission.

### [Related to Uplink PTRS]

The UE may receive a configuration of a higher-layer parameter phaseTrackingRS for a PTRS in a higher-layer parmaeter DMRS-UplinkConfig. When transmitting a PUSCH to the BS, the UE may transmit a phase tracking reference signal (PTRS) for tracking a phase for an uplink channel. A procedure in which the UE transmits a UL PTRS may be determined according to whether transform precoding is performed in PUSCH transmission. When the transform precoding is performed and a transformPrecoderEnabled area is configured within a higher-layer parameter PTRS-UplinkConfig, sampleDensity within the transformPrecoderEnabled area may indicate a sample density threshold expressed as N_{RB0} to N_{RB4} in [Table 49] below. When the transform precoding is performed and the transformPrecoderEnabled area is configured within a higher-layer parameter PTRS-UplinkConfig, the UE may determine a PT-RS group pattern for scheduled resources N_{RB} according to [Table 49]. In addition, when a transform precoder is applied to PUSCH transmission, the number of bits of a PTRS-DMRS association area for indicating the correlation between the PTRS and the DMRS within DCI format 0_1 or 0_2 may be 0.

TABLE 49

| | Number of | Number of samples |
|---|---|---|
| Scheduled bandwidth | PT-RS groups | per PT-RS group |
| N_{RB0} ≤ N_{RB} < N_{RB1} | 2 | 2 |
| N_{RB1} ≤ N_{RB} < N_{RB2} | 2 | 4 |
| N_{RB2} ≤ N_{RB} < N_{RB3} | 4 | 2 |
| N_{RB3} ≤ N_{RB} < N_{RB4} | 4 | 4 |
| N_{RB4} ≤ N_{RB} | 8 | 4 |

When the transform precoding is not applied to PUSCH transmission and a higher-layer parameter phaseTrackingRS is configured, frequecyDensity within a transformPrecoderDisabled area in the higher-layer parameter PTRS-UplinkConfig may indicate N_{RB0} to NRBI, and timeDensity may indicate ptrs-MCS₁ to ptrs-MCS₃. The UE may determine PT-RS density in the time domain (L_{PT-RS}) and PT-RS density (K_{PT-RS}) in the frequency domain according to MCS (IMCs) and RB (N_{RB}) of the scheduled PUSCH as shown in [Table 50] and [Table 51]. In [Table 50], ptrs-MCS₄ is not indicated as a higher-layer parameter but the BS and the UE may know that the ptrs-MCS₄ is 29 or 28 according to the configured MCS table.

TABLE 50

| Scheduled MCS | Time Density (LPT-RS) |
|---|---|
| IMcs < ptrs-MCS₁ | PT-RS is not present |
| ptrs-MCS₁ ≤ I_{MCS} < ptrs-MCS₂ | 4 |
| ptrs-MCS₂ ≤ I_{MCS} < ptrs-MCS₃ | 2 |
| ptrs-MCS₃ ≤ I_{MCS} < ptrs-MCS₄ | 1 |

TABLE 51

| Scheduled bandwidth | Frequency density (K_{PT-RS}) |
|---|---|
| N_{RB} < N_{RB0} | PT-RS is not present |
| N_{RB0} ≤ N_{RB} < N_{RB1} | 2 |
| N_{RB1} ≤ N_{RB} | 4 |

When the transform precoder is not applied to PUSCH transmission and PTRS-UplinkConfig is configured, the BS may indicate a “PTRS-DMRS association” area of 2 bits to the UE in order to indciate the correlation between the PTRS and the DMRS within DCI format 0_1 or 0_2. The indicated PTRS-DMRS association area of 2 bits may be applied to [Table 52] or [Table 53] below according to the maximum number of ports of the PTRS configured as maxNrofPorts within the higher-layer parameter PTRS-UplinkConfig. For example, when the maximum number of PTRS ports is 1, the UE may determine the correlation between the PTRS and the DMRS by [Table 52] and 2 bits indicated as the PTRS-DMRS association area, and transmit the PTRS according to the determined correlation. When the maximum number of PTRS ports is 2, the UE may determine the correlation between the PTRS and the DMRS by [Table 53] and 2 bits indicated as the PTRS-DMRS association area, and transmit the PTRS according to the determined correlation.

TABLE 52

| Value | DMRS port |
|---|---|
| 0 | 1^{st} scheduled DMRS port |
| 1 | 2^{nd} scheduled DMRS port |
| 2 | 3^{rd} scheduled DMRS port |
| 3 | 4^{th} scheduled DMRS port |

TABLE 53

| Value of | | | |
|---|---|---|---|
| MSB | DMRS port | Value of LSB | DMRS port |
| 0 | 1^{st} DMRS port which | 0 | 1^{st} DMRS port which |
| | shares PTRS port 0 | | shares PTRS port 1 |
| 1 | 2^{nd} DMRS port which | 1 | 2^{nd} DMRS port which |
| | shares PTRS port 0 | | shares PTRS port 1 |

The DMRS ports in [Table 52] and [Table 53] may be determined through a table that is determined by the “Antenna ports” area indicated by DCI which is the same as the DCI indicating PTRS-DMRS association and the higher-layer parameter configuration. When the transform precoder is not configured as a higher configuration of the PUSCH, dmrs-Type is configured as 1 and maxLength is configured as 2 for the DMRS, and a rank of the PUSCH is 2, the UE may determine a DMRS port through a bit indicated by the table for “Antenna port(s) like

[Table 54] and the antenna port area. When a noncodebook-based PUSCH is supported, the UE may determine a value of the rank with reference to an SRI area indicated by DCI which is the same as the DCI including the “Antenna ports” area (for example, the rank may be considered as 1 when there is no SRI area). When a codebook-based PUSCH is supported, the UE may determine a value of the rank with reference to a TPMI area indicated by DCI which is the same as the DCI including the “Antenna ports” area. [Table 54] is an example of the Antenna port table that is referenced for the PUSCH configuration and, for example, when the PUSCH is configured as another parameter, the DMRS port may be determined according to the Antenna port table according to the configuration and the bit of the Antenna port area indicated by the DCI.

TABLE 54

| | Number of DMRS | | Number of |
|---|---|---|---|
| | CDM group(s) | | front-load |
| Value | without data | DMRS port(s) | symbols |
| 0 | 1 | 0.1 | 1 |
| 1 | 2 | 0.1 | 1 |
| 2 | 2 | 2.3 | 1 |
| 3 | 2 | 0.2 | 1 |
| 4 | 2 | 0.1 | 2 |
| 5 | 2 | 2.3 | 2 |
| 6 | 2 | 4.5 | 2 |
| 7 | 2 | 6.7 | 2 |
| 8 | 2 | 0.4 | 2 |
| 9 | 2 | 2.6 | 2 |
| 10-15 | Reserved | Reserved | Reserved |

A 1^{st} scheduled DMRS to a 4^{th} scheduled DMRS in [Table 52] may be defined as values to which DMRS ports indicated by bits of the Antenna port area of DCI and the antenna port table according to the higher-layer configuration are sequentially mapped. For example, when bits of the Antenna ports of DCI are 0001 and the DMRS ports are determined with reference to [Table 54] above, the scheduled DMRS ports may be 0 and 1, and DMRS port 0 may be defined as the 1^{st} scheduled DMRS and DMRS port 1 may be defined as the 2^{nd} scheduled DMRS. The DMRS port determined by bits of another Antenna port area and another higher-layer configuration may also be applied in the similar way. The UE may determine one DMRS port to which the PTRS port is correlated with reference to bits indicated by PTRS-DMRS association within DCI among DMRS ports defined as described above and transmit the PTRS according to the determined DMRS port.

In [Table 53], a DMRS port that shares PTRS port 0 and a DMRS port that shares PTRS port 1 may be defined according to codebook-based PUSCH transmission or non-codebook-based PUSCH transmission. For example, when the UE transmits a PUSCH based on partial-coherent or non-coherent codebook, an uplink layer transmitted by PUSCH antenna ports 1000 and 1002 may have the correlation with PTRS port 0, and an uplink layer transmitted by PUSCH antenna ports 1001 and 1003 may have the correlation with PTRS port 1. In a more detailed example, when layer 3: TPMI=2 is selected for codebook-based PUSCH transmission, a first layer is transmitted by PUSCH antenna ports 1000 and 1002 and thus has the correlation with PTRS port 0, and a second layer is transmitted by PUSCH antenna port 1001 and a third layer is transmitted by PUSCH antenna port 1002, and thus the second and third layers have the correlation with PTRS port 1. Each of the three layers means a DMRS port, and a DMRS port for the first layer corresponds to “1^{st} DMRS port which shares PTRS port 0,” a DMRS port for the second layer corresponds to “1^{st} DMRS port which shares PTRS port 1,” and a DMRS port for the third layer corresponds to “2^{nd} DMRS port which shares PTRS port 1” in [Table 53]. Similarly, the DMRS port correlated to PTRS port 0 and the DMRS port correlated to PTRS port 1 may be determined according to the number of different layers and the TPMI. For example, when the UE transmits a PUSCH based on non-codebook, a DMRS port correlated to PTRS port 0 and a DMRS port correlated to PTRS port 1 may be identified according to the SRI indicated by DCI and Antenna ports. More specifically, it is configured whether an SRS resource included in an SRS resource set of which the usage is “nonCodebook” is correlated to PTRS port 0 or PTRS port 1 through a higher-layer parameter ptrs-PortIndex. The BS indicates the SRS resource for transmitting the non-codebook-based PUSCH through an SRI. At this time, a port of each of the indicated SRS Resources is mapped to a PUSCH DMRS port in one-to-one correspondence. The correlation between the PUSCH DMRS port and the PTRS port is determined according to a higher-layer parameter ptrs-PortIndex of the SRS resource mapped to the DMRS port.

More specifically, it is assumed that ptrs-PortIndex is configured as n0, n0, n1, and n1 in SRS resources 1 to 4 included in the SRS resource set of which the usage is nonCodebook.

Further, it is assumed that PUSCH transmission is indicated through SRS resources 1, 2, and 4 using the SRI and DMRS ports 0, 1, and 2 are indicated by Antenna port areas. Ports of SRS resources 1, 2, and 4 are mapped to DMRS ports 0, 1, and 2. According to ptrs-PortIndex within the SRS resources, DMRS ports 0 and 1 have the correlation with PTSR port 0 and DMRS port 2 has the correlation with PTRS port 1. Accordingly, in [Table 53], DMRS port 0 corresponds to “1^{st} DMRS port which shares PTRS port 0,” DMRS port 1 corresponds to “2^{nd} DMRS port which shares PTRS port 0,” and DMRS port 2 corresponds to “1^{st} DMRS port which shares PTRS port 1.”

Similar to this, the DMRS port correlated to PTRS port 0 and the DMRS port correlated to PTRS port 1 may be determined according to a ptrs-PortIndex configuration method within SRS resources of different patterns, for example, different SRI values. The UE determines the correlation between the DMRS port and the PTRS port for two PTRS ports as described above. Thereafter, among a plurality of DMRS ports having the correlation for each PTRS port, the UE may determine a DMRS port to be correlated to PTRS port 0 with reference to the MSB of PTRS-DMRS association and determine a DMRS port to be correlated to PTRS port 1 with reference to the LSB, so as to transmit the PTRS.

### [PUSCH DMRS]

Subsequently, Antenna port field indications included in DCI format 0_1 and DCI format 0_2 are described. Antenna port fields within DCI formats 0_1 and 0_2 may be expressed by 3, 4, or 5 bits and may be indicated through [Table 55] to [Table 70] below.

TABLE 55
Antenna port(s), transform precoder is disabled,
dmrs-Type = 1, maxLength = 1, rank = 1

| | Number of DMRS CDM | |
|---|---|---|
| Value | group(s) without data | DMRS port(s) |
| 0 | 1 | 0 |
| 1 | 1 | 1 |
| 2 | 2 | 0 |
| 3 | 2 | 1 |
| 4 | 2 | 2 |
| 5 | 2 | 3 |
| 6-7 | Reserved | Reserved |

TABLE 56
Antenna port(s), transform precoder is disabled,
dmrs-Type = 1, maxLength = 1, rank = 2

| | Number of DMRS CDM | |
|---|---|---|
| Value | group(s) without data | DMRS port(s) |
| 0 | 1 | 0.1 |
| 1 | 2 | 0.1 |
| 2 | 2 | 2.3 |
| 3 | 2 | 0.2 |
| 4-7 | Reserved | Reserved |

TABLE 57
Antenna port(s), transform precoder is disabled,
dmrs-Type = 1, maxLength = 1, rank = 3

| | Number of DMRS CDM | |
|---|---|---|
| Value | group(s) without data | DMRS port(s) |
| 0 | 2 | 0-2 |
| 1-7 | Reserved | Reserved |

TABLE 58
Antenna port(s), transform precoder is disabled,
dmrs-Type = 1, maxLength=1, rank = 4

| | Number of DMRS CDM | |
|---|---|---|
| Value | group(s) without data | DMRS port(s) |
| 0 | 2 | 0-3 |
| 1-7 | Reserved | Reserved |

TABLE 59
Antenna port(s), transform precoder is disabled,
dmrs-Type = 1, maxLength = 2, rank = 1

| | Number of DMRS CDM | DMRS | Number of front- |
|---|---|---|---|
| Value | group(s) without data | port(s) | load symbols |
| 0 | 1 | 0 | 1 |
| 1 | 1 | 1 | 1 |
| 2 | 2 | 0 | 1 |
| 3 | 2 | 1 | 1 |
| 4 | 2 | 2 | 1 |
| 5 | 2 | 3 | 1 |
| 6 | 2 | 0 | 2 |
| 7 | 2 | 1 | 2 |
| 8 | 2 | 2 | 2 |
| 9 | 2 | 3 | 2 |
| 10 | 2 | 4 | 2 |
| 11 | 2 | 5 | 2 |
| 12 | 2 | 6 | 2 |
| 13 | 2 | 7 | 2 |
| 14-15 | Reserved | Reserved | Reserved |

TABLE 60
Antenna port(s), transform precoder is disabled,
dmrs-Type = 1, maxLength = 2, rank = 2

| | Number of DMRS | | Number of |
|---|---|---|---|
| | CDM group(s) | DMRS | front-load |
| Value | without data | port(s) | symbols |
| 0 | 1 | 0, 1 | 1 |
| 1 | 2 | 0, 1 | 1 |
| 2 | 2 | 2, 3 | 1 |
| 3 | 2 | 0, 2 | 1 |
| 4 | 2 | 0, 1 | 2 |
| 5 | 2 | 2, 3 | 2 |
| 6 | 2 | 4, 5 | 2 |
| 7 | 2 | 6, 7 | 2 |
| 8 | 2 | 0, 4 | 2 |
| 9 | 2 | 2, 6 | 2 |
| 10-15 | Reserved | Reserved | Reserved |

TABLE 61
Antenna port(s), transform precoder is disabled,
dmrs-Type = 1, maxLength = 2, rank = 3

| | Number of DMRS | | Number of |
|---|---|---|---|
| | CDM group(s) | DMRS | front-load |
| Value | without data | port(s) | symbols |
| 0 | 2 | 0-2 | 1 |
| 1 | 2 | 0, 1, 4 | 2 |
| 2 | 2 | 2, 3, 6 | 2 |
| 3-15 | Reserved | Reserved | Reserved |

TABLE 62
Antenna port(s), transform precoder is disabled,
dmrs-Type = 1, maxLength = 2, rank = 4

| | Number of DMRS | | Number of |
|---|---|---|---|
| | CDM group(s) | DMRS | front-load |
| Value | without data | port(s) | symbols |
| 0 | 2 | 0-3 | 1 |
| 1 | 2 | 0, 1, 4, 5 | 2 |
| 2 | 2 | 2, 3, 6, 7 | 2 |
| 3 | 2 | 0, 2, 4, 6 | 2 |
| 4-15 | Reserved | Reserved | Reserved |

TABLE 63
Antenna port(s), transform precoder is disabled,
dmrs-Type = 2, maxLength = 1, rank = 1

| | Number of DMRS | |
|---|---|---|
| | CDM group(s) | DMRS |
| Value | without data | port(s) |
| 0 | 1 | 0 |
| 1 | 1 | 1 |
| 2 | 2 | 0 |
| 3 | 2 | 1 |
| 4 | 2 | 2 |
| 5 | 2 | 3 |
| 6 | 3 | 0 |
| 7 | 3 | 1 |
| 8 | 3 | 2 |
| 9 | 3 | 3 |
| 10 | 3 | 4 |
| 11 | 3 | 5 |
| 12-15 | Reserved | Reserved |

TABLE 64
Antenna port(s), transform precoder is disabled,
dmrs-Type = 2, maxLength = 1, rank = 2

| | Number of DMRS | |
|---|---|---|
| | CDM group(s) | DMRS |
| Value | without data | port(s) |
| 0 | 1 | 0, 1 |
| 1 | 2 | 0, 1 |
| 2 | 2 | 2, 3 |
| 3 | 3 | 0, 1 |
| 4 | 3 | 2, 3 |
| 5 | 3 | 4, 5 |
| 6 | 2 | 0, 2 |
| 7-15 | Reserved | Reserved |

TABLE 65
Antenna port(s), transform precoder is disabled,
dmrs-Type = 2, maxLength = 1, rank = 3

| | Number of DMRS | |
|---|---|---|
| | CDM group(s) | DMRS |
| Value | without data | port(s) |
| 0 | 2 | 0-2 |
| 1 | 3 | 0-2 |
| 2 | 3 | 3-5 |
| 3-15 | Reserved | Reserved |

TABLE 66
Antenna port(s), transform precoder is disabled,
dmrs-Type = 2, maxLength = 1, rank = 4

| | Number of DMRS | |
|---|---|---|
| | CDM group(s) | DMRS |
| Value | without data | port(s) |
| 0 | 2 | 0-3 |
| 1 | 3 | 0-3 |
| 2-15 | Reserved | Reserved |

TABLE 67
Antenna port(s), transform precoder is disabled,
dmrs-Type = 2, maxLength = 2, rank = 1

| | Number of DMRS | | Number of |
|---|---|---|---|
| | CDM group(s) | DMRS | front-load |
| Value | without data | port(s) | symbols |
| 0 | 1 | 0 | 1 |
| 1 | 1 | 1 | 1 |
| 2 | 2 | 0 | 1 |
| 3 | 2 | 1 | 1 |
| 4 | 2 | 2 | 1 |
| 5 | 2 | 3 | 1 |
| 6 | 3 | 0 | 1 |
| 7 | 3 | 1 | 1 |
| 8 | 3 | 2 | 1 |
| 9 | 3 | 3 | 1 |
| 10 | 3 | 4 | 1 |
| 11 | 3 | 5 | 1 |
| 12 | 3 | 0 | 2 |
| 13 | 3 | 1 | 2 |
| 14 | 3 | 2 | 2 |
| 15 | 3 | 3 | 2 |
| 16 | 3 | 4 | 2 |
| 17 | 3 | 5 | 2 |
| 18 | 3 | 6 | 2 |
| 19 | 3 | 7 | 2 |
| 20 | 3 | 8 | 2 |
| 21 | 3 | 9 | 2 |
| 22 | 3 | 10 | 2 |
| 23 | 3 | 11 | 2 |
| 24 | 1 | 0 | 2 |
| 25 | 1 | 1 | 2 |
| 26 | 1 | 6 | 2 |
| 27 | 1 | 7 | 2 |
| 28-31 | Reserved | Reserved | Reserved |

TABLE 68
Antenna port(s), transform precoder is disabled,
dmrs-Type = 2, maxLength = 2, rank = 2

| | Number of DMRS | | Number of |
|---|---|---|---|
| | CDM group(s) | DMRS | front-load |
| Value | without data | port(s) | symbols |
| 0 | 1 | 0, 1 | 1 |
| 1 | 2 | 0, 1 | 1 |
| 2 | 2 | 2, 3 | 1 |
| 3 | 3 | 0, 1 | 1 |
| 4 | 3 | 2, 3 | 1 |
| 5 | 3 | 4, 5 | 1 |
| 6 | 2 | 0, 2 | 1 |
| 7 | 3 | 0, 1 | 2 |
| 8 | 3 | 2, 3 | 2 |
| 9 | 3 | 4, 5 | 2 |
| 10 | 3 | 6, 7 | 2 |
| 11 | 3 | 8, 9 | 2 |
| 12 | 3 | 10, 11 | 2 |
| 13 | 1 | 0, 1 | 2 |
| 14 | 1 | 6, 7 | 2 |
| 15 | 2 | 0, 1 | 2 |
| 16 | 2 | 2, 3 | 2 |
| 17 | 2 | 6, 7 | 2 |
| 18 | 2 | 8, 9 | 2 |
| 19-31 | Reserved | Reserved | Reserved |

TABLE 69
Antenna port(s), transform precoder is disabled,
dmrs-Type = 2, maxLength = 2, rank = 3

| | Number of DMRS | | Number of |
|---|---|---|---|
| | CDM group(s) | DMRS | front-load |
| Value | without data | port(s) | symbols |
| 0 | 2 | 0-2 | 1 |
| 1 | 3 | 0-2 | 1 |
| 2 | 3 | 3-5 | 1 |
| 3 | 3 | 0, 1, 6 | 2 |
| 4 | 3 | 2, 3, 8 | 2 |
| 5 | 3 | 4, 5, 10 | 2 |
| 6-31 | Reserved | Reserved | Reserved |

TABLE 70
Antenna port(s), transform precoder is disabled,
dmrs-Type = 2, maxLength = 2, rank = 4

| | Number of DMRS | | Number of |
|---|---|---|---|
| | CDM group(s) | DMRS | front-load |
| Value | without data | port(s) | symbols |
| 0 | 2 | 0-3 | 1 |
| 1 | 3 | 0-3 | 1 |
| 2 | 3 | 0, 1, 6, 7 | 2 |
| 3 | 3 | 2, 3, 8, 9 | 2 |
| 4 | 3 | 4, 5, 10, 11 | 2 |
| 5-31 | Reserved | Reserved | Reserved |

[Table 55] to [Table 70] may be used to indicate DMRS ports. [Table 55] to [Table 58] may be used when dmrs-type is indicated as 1 and maxLength is indicated as 1, [Table 59] to [Table 62] may be used when dmrs-Type=1 and maxLength=2, [Table 63] to [Table 66] may be used when dmrs-type=2 and maxLength=1, and [Table 67] to [Table 70] may be used when drms-type=2 and maxLength=2.

For example, when the UE receives configurations of all of higher-layer signaling dmrs-UplinkForPUSCH-MappingTypeA and dmrs-UplinkForPUSCH-MappingTypeB for DCI format 0_1, the length of bits in the Antenna port fields within DCI format 0_1 may be determined as max {X_{A}, X_{B}}, where each of X_{A} and X_{B} may be the length of bits in the Antenna port fields determined through dmrs-UplinkForPUSCH-MappingType A and dmrs-UplinkForPUSCH-MappingTypeB. For example, when a PUSCH mapping type corresponding to a smaller value between X_{A} and X_{B} is scheduled, 0 bits may be allocated to the MSB corresponding to the number of |X_{A}-X_{B}| and transmitted.

For example, when the UE does not receive a configuration of higher-layer signaling antennaPortsFieldPresenceD) (1-0-2 for DCI format 0_2, corresponding DCI format 0_2 may not have the Antenna port field. In other words, when the UE does not receive the configuration of higher-layer signaling antennaPortsFieldPresenceDCI-0-2, the length of the Antenna port field may be 0 bits, and the UE may determine a DMRS port, based on the assumption of a zeroth entry in [Table 55] to [Table 70]. For example, when the UE receives the configuration of higher-layer signaling antennaPortsFieldPresenceDCI-0-2, the length of bits of the Antenna port field within DCI format 0_2 may be determined similar to the case of DCI format 0_1. For example, when the UE receives configurations of all of higher-layer signaling dmrs-UplinkForPUSCH-MappingType A-DCI-0-2 and dmrs-UplinkForPUSCH-Mapping TypeB-DCI-O-2, the length of bits in the Antenna port field may be determined as max {X_{A}, X_{B}}, where each of X_{A} and X_{B} may be the length of bits in the Antenna port fields within DCI format 0_2 determined through dmrs-UplinkForPUSCH-Mapping Type A-DCI-0-2 and dmrs-Uplink ForPUSCH-MappingTypeB-DCI-0-2. For example, when a PUSCH mapping type corresponding to a smaller value between X_{A} and X_{B} is scheduled, 0 bits may be allocated to the MSB corresponding to the number of |X_{A}-X_{B}| and transmitted.

Numbers 1, 2, and 3 indicated by Number of DMRS CDM group(s) without data in [Table 55] to [Table 70] may mean CDM groups {0}, {0, 1}, and {0, 1, 2}, respectively. DMRS port(s) may sequentially include indexes of the used ports. The antenna port may be indicated by DMRS port+1000. A DMRS CDM group may be connected to a method of generating a DMRS sequence and an antenna port as shown in [Table 71] and [Table 72]. [Table 71] shows parameters when dmrs-type=1 is used, and [Table 72] shows parameters when dmrs-type=2 is used.

TABLE 71
Parameters for PUSCH DM-RS dmrs-type = 1

| | | |
|---|---|---|
| CDM | w_{f} (k′) | wₜ (l′) |

| \tilde{p} | group ^{λ} | Δ | k′ = 0 | k′ = 1 | l′ = 0 | l′ = 1 |
|---|---|---|---|---|---|---|
| 0 | 0 | 0 | +1 | +1 | +1 | +1 |
| 1 | 0 | 0 | +1 | −1 | +1 | +1 |
| 2 | 1 | 1 | +1 | +1 | +1 | +1 |
| 3 | 1 | 1 | +1 | −1 | +1 | +1 |
| 4 | 0 | 0 | +1 | +1 | +1 | −1 |
| 5 | 0 | 0 | +1 | −1 | +1 | −1 |
| 6 | 1 | 1 | +1 | +1 | +1 | −1 |
| 7 | 1 | 1 | +1 | −1 | +1 | −1 |

TABLE 72
Parameters for PUSCH DM-RS dmrs-type = 2.

| | | |
|---|---|---|
| CDM | w_{f} (k′) | wₜ (l′) |

| \tilde{p} | group ^{λ} | Δ | k′ = 0 | k′ = 1 | l′ = 0 | l′ = 1 |
|---|---|---|---|---|---|---|
| 0 | 0 | 0 | +1 | +1 | +1 | +1 |
| 1 | 0 | 0 | +1 | −1 | +1 | +1 |
| 2 | 1 | 2 | +1 | +1 | +1 | +1 |
| 3 | 1 | 2 | +1 | −1 | +1 | +1 |
| 4 | 2 | 4 | +1 | +1 | +1 | +1 |
| 5 | 2 | 4 | +1 | −1 | +1 | +1 |
| 6 | 0 | 0 | +1 | +1 | +1 | −1 |
| 7 | 0 | 0 | +1 | −1 | +1 | −1 |
| 8 | 1 | 2 | +1 | +1 | +1 | −1 |
| 9 | 1 | 2 | +1 | −1 | +1 | −1 |
| 10 | 2 | 4 | +1 | +1 | +1 | −1 |
| 11 | 2 | 4 | +1 | −1 | +1 | −1 |

A DMRS sequence according to each parameter is determined by [Equation 10] below. In [Equation 10], \tilde{P} denotes a DMRS port, k denotes a subcarrier index, 1 denotes an OFDM symbol index, u denotes subcarrier spacing, w_{f}(k′) and wₜ(l′) denote frequency domain orthogonal cover code (FD-OCC) and time domain orthogonal cover code (TD-OCC) coefficients according to a value of k′ and a value of l′, and Δ denotes an interval between CDM groups through the numbers of subcarriers. In [Equation 10], β_{PUSCH}^{DMRS} is a scaling factor that means a ratio between an energy per RE (EPRE) of a PUSCH and an EPRE of a DMRS and calculated as

$${β}_{PUSCH}^{DMRS} = {10}^{- \frac{{β}_{DRMS}}{20}} ,$$

and a value of β_{DMRS} may be 0 dB, −3 dB, or −4.77 dB as the number of CDM groups is 1, 2, or 3.

$${\tilde{a}}_{k , l}^{( {p}_{j} , μ )} = {w}_{f} ( {k}^{′} ) {w}_{t} ( {l}^{′} ) r ( 2 n + {k}^{′} ) \\ k = \{ \begin{matrix}4 n + 2 {k}^{′} + Δ & Configuration type 1 \\ 6 n + {k}^{′} + Δ & Configuration type 2\end{matrix} \\ {k}^{′} = 0 , 1 \\ l = \overline{l} + {l}^{′} \\ n = 0 , 1 , … \\ j = 0 , 1 , … , v - 1 \\ [ \begin{matrix}{a}_{k , l}^{( {p}_{0} , μ )} \\ ⋮ \\ {a}_{k , l}^{( {p}_{ρ - 1} , μ )}\end{matrix} ] = {β}_{PUSCH}^{DMRS} W [ \begin{matrix}{\tilde{a}}_{k , l}^{( {p}_{0} , μ )} \\ ⋮ \\ {\tilde{a}}_{k , l}^{( {p}_{v - 1} , μ )}\end{matrix} ] . \qquad [ Equation 10 ]$$

For example, when frequency hopping is not used, the UE may assume that higher-layer signaling dmrs-AdditionalPosition is configured as “pos2,” and a maximum of 2 additional DMRS symbols may be used for PUSCH transmission. For example, when frequency hopping is used, the UE may assume that higher-layer signaling dmrs-AdditionalPosition is configured as “pos1,” and a maximum of 1 additional DMRS symbol may be used for PUSCH transmission.

In the case of a PUSCH scheduled in DCI formats 0_1 and 0_2, the UE may assume that CDM groups indicated through a sequence of “Number of DMRS CDM group(s) without data” may include DMRS ports allocated to another UE that can be co-scheduled through a multi-user MIMO scheme in [Table 55] to [Table 70] and may not be used for data transmission of the corresponding UE. Further, the UE may understand that 1, 2, or 3 indicated through the sequence of “Number of DMRS CDM group(s) without data” means an index of a CDM group corresponding to the meaning corresponds to each of the CDM groups 0, {0,1}, and {0,1,2} in

### [Table 55] to [Table 70].

### [UE Capability]

### [Related to UE Capability Report]

In LTE and NR, the UE may perform a procedure of reporting a capability supported by the UE to the corresponding BS in the state in which the UE is connected to a serving BS. A procedure in which the UE reports a capability supported by the UE to the serving BS may be referred to as a UE capability report.

The BS may transmit a UE capability enquiry message that makes a request for a capability report to the UE in the connected state. The UE capability enquiry message may include a request for each radio access technology (RAT) type. The request for each RAT type may include supported frequency band combination information supported by the UE. Further, the UE capability enquiry message may be included in an RRC message container and transferred to the UE. The UE capability for a plurality of RAT types may be requested through one RRC message container transmitted by the BS. Alternatively, the BS may insert the UE capability enquiry message including the UE capability request for each RAT type into the RRC message container multiple times and transfer the RRC message container to the UE. In other words, the UE capability enquiry may be repeated multiple times within one UE capability enquiry message. The UE may configure a UE capability information message in response to a report request from the BS and report the same multiple times. In the wireless mobile communication system, a UE capability request may be made for RAT types such as NR, LTE, E-UTRA-NR dual connectivity (EN-DC), and multi-RAT dual connectivity (MR-DC). Further, the UE capability enquiry message is generally transmitted in the beginning after the UE is connected to the BS, but the request can be made even after the connection if the BS needs it.

The UE receiving the UE capability report request from the BS configures a UE capability according to the RAT type and band information requested by the BS. Hereinafter, a method by which the UE configures the UE capability in the NR system is described.
1. For example, the UE receives a list of LTE and/or NR bands from the BS through a UE capability request, the UE configures a band combination (BC) for EN-DC and NR standalone (SA). For example, the UE configures a list of BC candidates for EN-DC and NR SA, based on bands for which a request of FreqBandList is made to the BS. Further, the bands sequentially have priorities as stated in FreqBandList.
2. For example, when the BS sets a “eutra-nr-only” flag or a “eutra” flag and makes a request for the UE capability report, the UE completely removes NR SA BCs from the configured list of BC candidates. Such an operation may occur only when the LTE BS (eNB) makes a request for a “eutra” capability.
3. Thereafter, the UE removes fallback BCs from the candidate list of BCs configured in the above stage. The fallback BC is a BC which can be obtained by removing a band corresponding to at least one SCell from a predetermined BC, and a BC before the removal of the band corresponding at least one SCell can cover the fallback BC and thus the fallback BC may be omitted. This operation is applied to MR-DC, that is, LTE bands. The remaining BCs after the operation correspond to a final “candidate BC list.”
4. The UE selects BCs suitable for a requested RAT type in the final “candidate BC list” and selects BCs to be reported. In this operation, the UE configures supportedBandCombinationList according to a determined order. For example, the UE configures BCs and a UE capability to be reported according to an order of a preset rat-Type (nr->eutra-nr->eutra). Further, the UE configures featureSetCombination for the configured supportedBandCombinationList and configures a list of “candidate feature set combination” in a candidate BC list from which a list for fallback BCs (including capability at the same or lower stage) is removed. The “candidate feature set combination” may include all feature set combinations for NR and EUTRA-NR BCs, and may be acquired from a feature set combination of UE-NR-Capabilities and UE-MRDC-Capabilities containers.
5. For example, when the requested rat Type is eutra-nr and influences, featureSetCombinations are included in all of the two containers of UE-MRDC-Capabilities and UE-NR-Capabilities. However, the NR feature set is included only in UE-NR-Capabilities.

After the UE capability is configured, the UE transfers a UE capability information message including the UE capability. The BS performs scheduling and transmission/reception management suitable for the corresponding UE on the basis of the UE capability received from the UE.

[mTRP]

### [Related to NC-JT]

According to an embodiment of the disclosure, in order to receive a PDSCH from a plurality of TRPs, the UE may use non-coherent joint transmission (NC-JT).

Unlike the conventional system, the 5G wireless communication system supports not only a service requiring a high transmission rate but also both a service having a very short transmission delay and a service requiring a high connection density. In a wireless communication network including a plurality of cells, transmission and reception points (TRPs), or beams, cooperative communication (coordinated transmission) between respective cells, TRPs, and/or beams may satisfy various service requirements by increasing the strength of a signal received by the UE or efficiently controlling interference between the cells, TRPs, and/or beams.

Joint transmission (JT) is a representative transmission technology for the cooperative communication and may include a technology for increasing the strength of a signal received by the UE or throughput by transmitting signals to one UE through different cells, TRPs, and/or beams. At this time, channels between respective cells, TRPs, or and beams, and the UE may have significantly different characteristics. Particularly, in the case of non-coherent joint transmission (NC-JT) supporting non-coherent precoding between respective cells, TRPs, and/or beams, individual precoding, MCS, resource allocation, and TCI indication may be needed according to a channel characteristic for each link between each cell, TRP, and/or beam, and the UE.

The NC-JT may be applied to at least one of a downlink data channel (PDSCH), a downlink control channel (PDCCH), an uplink data channel (PUSCH), and an uplink control channel (PUCCH). In PDSCH transmission, transmission information such as precoding, MCS, resource allocation, and TCI may be indicated through DL DCI, and may be independently indicated for each cell, TRP, and/or beam for the NC-JT. This is a main factor that increases payload required for DL DCI transmission, which may have a bad influence on reception performance of a PDCCH for transmitting the DCI. Accordingly, in order to support JT of the PDSCH, it is required to carefully design a tradeoff between an amount of DCI information and reception performance of control information.

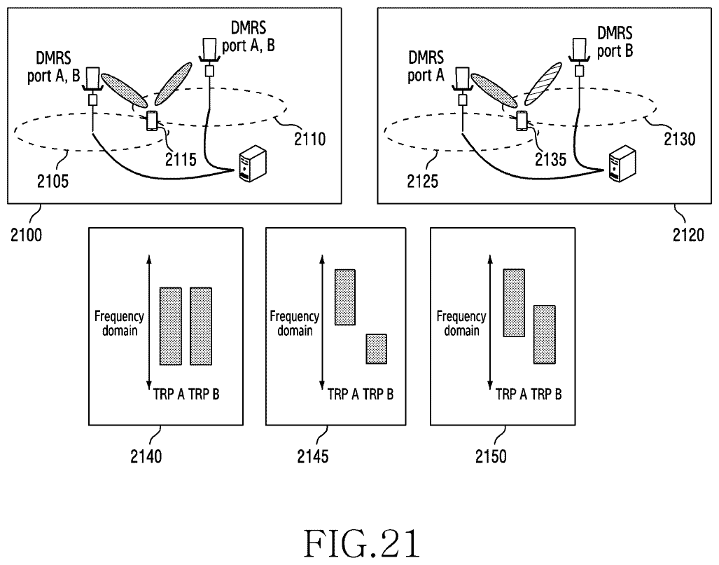

FIG. 21 illustrates a configuration of antenna ports and an example of resource allocation for cooperative communication in a wireless communication system according to an embodiment of the disclosure. Specifically, FIG. 21 illustrates a configuration of antenna ports and an example of resource allocation to transmit a PDSCH through cooperative communication in a wireless communication system according to an embodiment of the disclosure;

Referring to FIG. 21, the example for PDSCH transmission is described for each scheme of joint transmission (JT), and examples for allocating radio resources for each TRP are described.

Referring to FIG. 21, an example 2100 of coherent joint transmission (C-JT) supporting coherent precoding between respective cells, TRPs, and/or beams is illustrated.

In the case of C-JT, a TRP A 2105 and a TRP B 2110 may transmit single data (PDSCH) to a UE 2115, and a plurality of TRPs may perform joint precoding. This may mean that the TRP A 2105 and the TPR B 2110 transmit DMRSs through the same DMRS ports in order to transmit the same PDSCH. For example, the TRP A 2105 and the TPR B 2110 may transmit DMRSs to the UE through a DMRS port A and a DMRS port B, respectively. In this case, the UE may receive one piece of DCI information for receiving one PDSCH demodulated based on the DMRSs transmitted through the DMRS port A and the DMRS port B.

FIG. 21 illustrates an example 2120 of non-coherent joint transmission (NC-JT) supporting non-coherent precoding between respective cells, TRPs, and/or beams for PDSCH transmission.

In the case of NC-JT, the PDSCH is transmitted to a UE 2135 for each cell, TPR, and/or beam, and individual precoding may be applied to each PDSCH. Respective cells, TRPs, and/or beams may transmit different PDSCHs or different PDSCH layers to the UE, thereby improving throughput compared to single cell, TRP, and/or beam transmission. Further, respective cells, TRPs, and/or beams may repeatedly transmit the same PDSCH to the UE, thereby improving reliability compared to single cell, TRP, and/or beam transmission. For convenience of description, the cell, TRP, and/or beam are commonly called a TRP.

At this time, various wireless resource allocations such as the case 2140 in which frequency and time resources used by a plurality of TRPs for PDSCH transmission are all the same, the case 2145 in which frequency and time resources used by a plurality of TRPs do not overlap at all, and the case 2150 in which some of the frequency and time resources used by a plurality of TRPs overlap each other may be considered.

According to various embodiments of the disclosure, in order to support NC-JT, DCIs in various forms, structures, and relations may be considered to simultaneously allocate a plurality of PDSCHs to one UE.

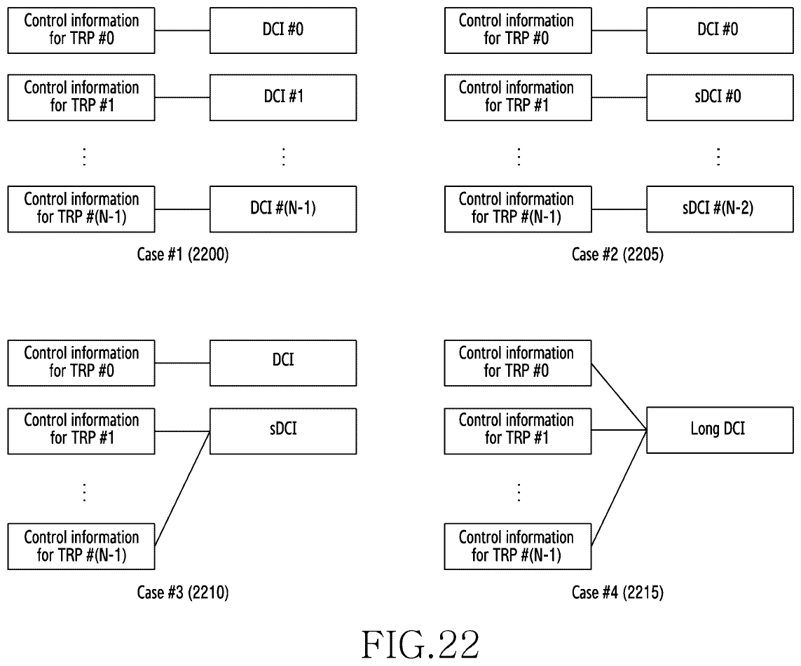

FIG. 22 illustrates an example for a configuration of downlink control information (DCI) for cooperative communication in a wireless communication system according to an embodiment of the disclosure. Specifically, FIG. 22 illustrates an example of a configuration of downlink control information (DCI) for NC-JT in which respective TRPs transmit different PDSCHs or different PDSCH layers to the UE in a wireless communication system according to an embodiment of the disclosure.

Referring to FIG. 22, case #1 2200 is an example in which control information for PDSCHs transmitted from (N−1) additional TRPs is transmitted independently from control information for a PDSCH transmitted by a serving TRP in a situation in which (N−1) different PDSCHs are transmitted from the (N−1) additional TRPs (TRP #1 to TRP #(N−1)) other than the serving TRP (TRP #0) used for single PDSCH transmission. For example, the UE may acquire control information for PDSCHs transmitted from different TRPs (TRP #0 to TRP #(N−1)) through independent DCI (DCI #0 to DCI #(N−1)). Formats between the independent DCI may be the same as or different from each other, and payload between the DCI may also be the same as or different from each other. In case #1, a degree of freedom of PDSCH control or allocation can be completely guaranteed, but when respective pieces of DCI are transmitted by different TRPs, a difference between DCI coverages may be generated and reception performance may deteriorate.

Case #2 2205 is an example in which pieces of control information for PDSCHs of (N−1) additional TRPs are transmitted and each piece of the DCI is dependent on control information for the PDSCH transmitted from the serving TRP in a situation in which (N−1) different PDSCHs are transmitted from (N−1) additional TRPs (TRP #1 to TRP #(N−1)) other than the serving TRP (TRP #0) used for single PDSCH transmission.

For example, DCI #0 that is control information for a PDSCH transmitted from the serving TRP (TRP #0) may include all information elements of DCI format 1_0, DCI format 1_1, and DCI format 1_2, but shortened DCI (hereinafter, referred to as sDCI) (sDCI #0 to sDCI #(N−2)) that are control information for PDSCHs transmitted from the cooperative TRPs (TRP #1 to TRP #(N−1)) may include only some of the information elements of DCI format 1_0, DCI format 1_1, and DCI format 1_2. Accordingly, the sDCI for transmitting control information of PDSCHs transmitted from cooperative TPRs has smaller payload compared to the normal DCI (nDCI) for transmitting control information related to the PDSCH transmitted from the serving TRP, and thus can include reserved bits compared to the nDCI.

In case #2, a degree of freedom of each PDSCH control or allocation may be limited according to content of information elements included in the sDCI, but reception capability of the sDCI is better than the nDCI, and thus a probability of the generation of difference between DCI coverages may become lower.

Case #3 2210 is an example in which one piece of control information for PDSCHs of (N−1) additional TRPs is transmitted and the DCI is dependent on control information for the PDSCH transmitted from the serving TRP in a situation in which (N−1) different PDSCHs are transmitted from (N−1) additional TRPs (TRP #1 to TRP #(N−1)) other than the serving TRP (TRP #0) used for single PDSCH transmission.

For example, in the case of DCI #0 that is control information for the PDSCH transmitted from the serving TRP (TRP #0), all information elements of DCI format 1_0, DCI format 1_1, and DCI format 1_2 may be included, and in the case of control information for PDSCHs transmitted from cooperative TRPs (TRP #1 to TRP #(N−1)), only some of the information elements of DCI format 1_0, DCI format 1_1, and DCI format 1_2 may be gathered in one “secondary” DCI (sDCI) and transmitted. For example, the sDCI may include at least one piece of HARQ-related information such as frequency domain resource assignment and time domain resource assignment of the cooperative TRPs and the MCS. In addition, information that is not included in the sDCI such as a BWP indicator and a carrier indicator may follow DCI (DCI #0, normal DCI, or nDCI) of the serving TRP.

In case #3 2210, a degree of freedom of PDSCH control or allocation may be limited according to content of the information elements included in the sDCI but reception performance of the sDCI can be controlled, and case #3 2210 may have smaller complexity of DCI blind decoding of the UE compared to case #1 N100 or case #2 2205.

Case #4 2215 is an example in which control information for PDSCHs transmitted from (N−1) additional TRPs is transmitted in DCI (long DCI) that is the same as that of control information for the PDSCH transmitted from the serving TRP in a situation in which different (N−1) PDSCHs are transmitted from the (N−1) additional TRPs (TRP #1 to TRP #(N−1)) other than the serving TRP (TRP #0) used for single PDSCH transmission. For example, the UE may acquire control information for PDSCHs transmitted from different TRPs (TRP #0 to TRP #(N−1)) through single DCI. In case #4 2215, complexity of DCI blind decoding of the UE may not be increased, but a degree of freedom of PDSCH control or allocation may be low since the number of cooperative TRPs is limited according to a long DCI payload restriction.

In the following description and embodiments, the sDCI may refer to various pieces of supplementary DCI such as shortened DCI, secondary DCI, or normal DCI (DCI formats 1_0 and 1_1) including PDSCH control information transmitted by the cooperative TRP, and unless specific restriction is mentioned, the corresponding description can be similarly applied to the various pieces of supplementary DCI.

In the following description and embodiments, case #1 2200, case #2 N2205, and case #3 2210 in which one or more pieces of DCI (or PDCCHs) are used to support NC-JT may be classified as multiple PDCCH-based NC-JT and case #4 2215 in which single DCI (or PDCCH) is used to support NC-JT may be classified as single PDCCH-based NC-JT. In multiple PDCCH-based PDSCH transmission, a CORESET for scheduling DCI of the serving TRP (TRP #0) is separated from CORESETs for scheduling DCI of cooperative TRPs (TRP #1 to TRP #(N-1)). Methods of distinguishing CORESETs may include a method of distinguishing the CORESETs through a higher layer indicator for each CORESET and a method of distinguishing the CORESETs through a beam configuration for each CORESET. Further, in single PDCCH-based NC-JT, single DCI schedules a single PDSCH having a plurality of layers instead of scheduling a plurality of PDSCHs, and the plurality of layers may be transmitted from a plurality of TRPs. At this time, association between a layer and a TRP transmitting the corresponding layer may be indicated through a transmission configuration indicator (TCI) indication for the layer.

In embodiments of the disclosure, the “cooperative TRP” may be replaced with various terms such as a “cooperative panel” or a “cooperative beam” when actually applied.

In embodiments of the disclosure, “the case in which NC-JT is applied” may be variously interpreted as “the case in which the UE simultaneously receives one or more PDSCHs in one BWP,” “the case in which the UE simultaneously receives PDSCHs on the basis of two or more transmission configuration indicator (TCI) indications in one BWP,” and “the case in which the PDSCHs received by the UE are associated with one or more DMRS port groups” according to circumstances, but is used by one expression for convenience of description.

In the disclosure, a wireless protocol structure for NC-JT may be variously used according to a TRP development scenario. For example, when there is no backhaul delay between cooperative TRPs or there is a small backhaul delay, a method (CA-like method) using a structure based on MAC layer multiplexing can be used similarly to reference numeral 410 of FIG. 4. On the other hand, when the backhaul delay between cooperative TRPs is too large to be ignored (for example, when a time of 2 ms or longer is needed to exchange information such as CSI, scheduling, and HARQ-ACK between cooperative TRPs), a method (DC-like method) of securing a characteristic strong at a delay can be used through an independent structure for each TRP from an RLC layer similarly to reference numeral 420 of FIG. 4.

The UE supporting C-JT and/or NC-JT may receive a C-JT and/or NC-JT-related parameter or a setting value from a higher-layer configuration and set an RRC parameter of the UE on the basis thereof. For the higher-layer configuration, the UE may use a UE capability parameter (for example, tci-StatePDSCH). The UE capability parameter (for example, tci-StatePDSCH) may define TCI states for PDSCH transmission, the number of TCI states may be configured as 4, 8, 16, 32, 64, and 128 in FRI and as 64 and 128 in FR2, and a maximum of 8 states which can be indicated by 3 bits of a TCI field of the DCI may be configured through a MAC CE message among the configured numbers. A maximum value 128 means a value indicated by maxNumberConfiguredTCIstatesPerCC within the parameter tci-StatePDSCH which is included in capability signaling of the UE. As described above, a series of configuration processes from the higher-layer configuration to the MAC CE configuration may be applied to a beamforming indication or a beamforming change command for at least one PDSCH in one TRP.

### [Multi-DCI-Based Multi-TRP]

As an embodiment of the disclosure, a multi-DCI-based multi-TRP transmission method is described. The multi-DCI-based multi-TRP transmission method may configure a downlink control channel for NC-JT transmission on the basis of a multi-PDCCH.

In NC-JT based on multiple PDCCHs, there may be a CORESTE or a search space separated for each TRP when DCI for scheduling the PDSCH of each TRP is transmitted. The CORESET or the search space for each TRP can be configured like in at least one of the following cases.
* A configuration of a higher-layer index for each CORESET: CORESET configuration information configured by a higher layer may include an index value, and a TRP for transmitting a PDCCH in the corresponding CORESET may be identified by the configured index value for each CORESET. For example, in a set of CORESETs having the same higher-layer index value, it may be considered that the same TRP transmits the PDCCH or the PDCCH for scheduling the PDSCH of the same TRP is transmitted. The index for each CORESET may be named CORESETPoolIndex, and it may be considered that the PDCCH is transmitted from the same TRP in CORESETs in which the same CORESETPoolIndex value is configured. In the CORESET in which the CORESETPoolIndex value is not configured, it may be considered that a default value of CORESETPoolIndex is configured, and the default value may be 0.
** In the disclosure, when the number of types of CORESETPoolIndex of each of a plurality of CORESETs included in higher-layer signaling PDCCH-Config is larger than 1, for example, when respective CORESETs have different CORESETPoolIndex, the UE may consider that the BS can use a multi-DCI-based multi-TRP transmission method.
** Unlike this, in the disclosure, when the number of types of CORESETPoolIndex of each of a plurality of CORESETs included in higher-layer signaling PDCCH-Config is 1, for example, when all CORESETs have the same CORESETPoolIndex of 0 or 1, the UE may consider that the BS performs transmission using a single-TRP without using the multi-DCI-based multi-TRP transmission method.
* A configuration of multiple PDCCH-Config: a plurality of PDCCH-Configs is configured in one BWP, and each PDCCH-Config may include a PDCCH configuration for each TRP. For example, a list of CORESETs for each TRP and/or a list of search spaces for each TRP may be included in one PDCCH-Config, and one or more CORESETs and one or more search spaces included in one PDCCH-Config may be considered to correspond to a specific TRP.
* CORESET beam/beam group configuration: a TRP corresponding to the corresponding CORESET may be identified through a beam or a beam group configured for each CORESET. For example, when the same TCI state is configured in a plurality of CORESETs, it may be considered that the corresponding CORESETs are transmitted through the same TRP or a PDCCH for scheduling a PDSCH of the same TRP is transmitted in the corresponding CORESET.
* A search space beam/beam group configuration: a beam or a beam group may be configured for each search space, and accordingly a TRP for each search space may be identified. For example, when the same beam/beam group or TCI state is configured in a plurality of search spaces, it may be considered that the same TRP transmits the PDCCH in the corresponding search space or a PDCCH for scheduling a PDSCH of the same TRP is transmitted in the corresponding search space.

As described above, by separating the CORESETs or search spaces for each TRP, it is possible to divide PDSCHs and HARQ-ACK for each TRP and accordingly to generate an independent HARQ-ACK codebook for each TRP and use an independent PUCCH resource.

The configuration may be independent for each cell or each BWP. For example, while two different CORESETPoolIndex values may be configured in the PCell, no CORESETPoolIndex value may be configured in a specific SCell. In this case, it may be considered that NC-JT is configured in the PCell, but NC-JT is not configured in the SCell in which no CORESETPoolIndex value is configured.

A PDSCH TCI state activation/deactivation MAC-CE which can be applied to the multi-DCI-based multi-TRP transmission method may follow FIG. 16. For example, when the UE does not receive a configuration of CORESETPoolIndex for each of all CORESETs within higher-layer signaling PDCCH-Config, the UE may ignore a CORESET Poll ID field 1655 within the corresponding MAC-CE 1650. For example, when the UE can support the multi-DCI-based multi-TRP transmission method (for example, when respective CORESETs within higher-layer signaling PDCCH-Config have different CORESETPoolIndex), the UE may activate a TCI state within DCI included in PDCCHs transmitted in CORESETs having CORESETPoolIndex which is the same as a value of the CORESET Poll ID field 1355 within the corresponding MAC-CE 1350. For example, when the value of the CORESET Poll ID field 1655 within the corresponding MAC-CE 1650 is 0, a TCI state within DCI included in PDCCHs transmitted by the CORESETs having CORESETPoolIndex of 0 may follow activation information of the corresponding MAC-CE.

When the UE receives a configuration indicating that the multi-DCI-based multi-TRP transmission method can be used from the BS (for example, the number of types of CORESETPoolIndex of a plurality of CORESETs included in higher-layer signaling PDCCH-Config is larger than 1 or respective CORESETs have different CORESETPoolIndex), the UE may know that there are the following restrictions on PDSCHs scheduled by PDCCHs within respective CORESETs having different two CORESETPollIndex.
1) When PDSCHs indicated by PDCCHs within respective CORESETs having different two CORESETPollIndex completely or partially overlap, the UE may apply TCI states indicated by the respective PDCCHs to different CDM groups. For example, two or more TCI states may not be applied to one CDM group.
2) When PDSCHs indicated by PDCCHs within respective CORESETs having different two CORESETPollIndex completely or partially overlap, the UE may expect that the numbers of actual front loaded DMRS symbols of respective PDSCHs, the numbers of actual additional DMRS symbols, locations of actual DMRS symbols, and DMRS types are not different.
3) The UE may expect that bandwidth parts indicated by PDCCHs within respective CORESETs having different two CORESETPoolIndex are the same and subcarrier spacings are also the same.
4) The UE may expect that information on PDSCH scheduled by PDCCHs within respective CORESETs having different two CORESETPoolIndex are completely included in respective PDCCHs.

### [Single-DCI-Based Multi-TRP]

As an embodiment of the disclosure, a single-DCI-based multi-TRP transmission method is described. The single-DCI-based multi-TRP transmission method may configure a downlink control channel for NC-JT on the basis of a single PDCCH.

In single DCI-based multi-TRP, PDSCHs transmitted by a plurality of TRPs may be scheduled by one piece of DCI. At this time, as a method of indicating the number of TRPs transmitting the corresponding PDSCHs, the number of TCI states may be used. For example, when the number of TCI states indicated by DCI that schedules the PDSCH is 2, single PDCCH-based NC-JT may be considered. For example, when the number of TCI states is 1, single-TRP transmission may be considered. The TCI states indicated by the DCI may correspond to one or two TCI states among TCI states activated by the MAC CE. When the TCI states of DCI correspond to two TCI states activated by the MAC CE, a TCI codepoint indicated by the DCI is associated with the TCI states activated by the MAC CE, in which case the number of TCI states activated by the MAC CE, corresponding to the TCI codepoint, may be 2.

In another example, when at least one of all codepoints of the TCI state field within DCI indicate two TCI states, the UE may consider that the BS can perform transmission, based on the single-DCI-based multi-TRP method. At this time, at least one codepoint indicating two TCI states within the TCI state field may be activated through an enhanced PDSCH TCI state activation/deactivation MAC-CE.

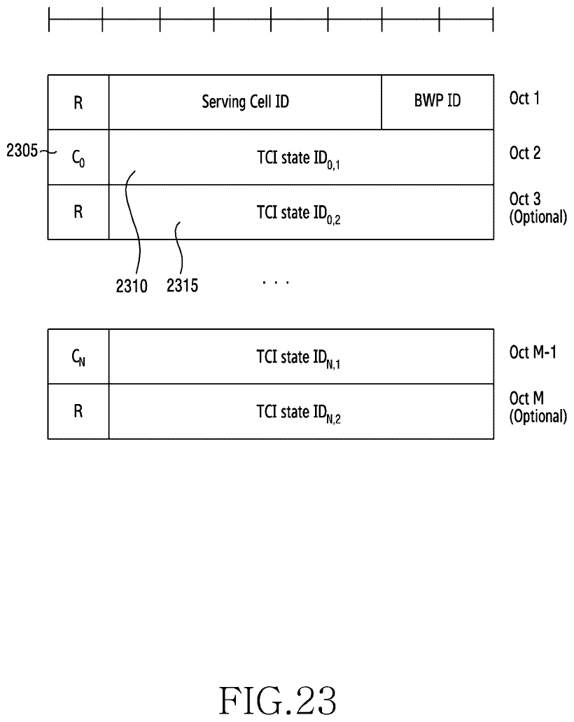

FIG. 23 illustrates an enhanced PDSCH TCI state activation/deactivation MAC-CE format. The meaning of each field within the MAC CE and a value configurable in each field are as shown in [Table 73] below.

TABLE 73
Serving Cell ID: This field indicates the identity of the Serving Cell for which the MAC
CE applies. The length of the field is 5 bits. If the indicated Serving Cell is configured as
part of a simultaneousTCI-UpdateList1 or simultaneousTCI-UpdateList2 as specified in TS
38.331 [5], this MAC CE applies to all the Serving Cells configured in the set
simultaneousTCI-UpdateList1 or simultaneousTCI-UpdateList2, respectively;
BWP ID: This field indicates a DL BWP for which the MAC CE applies as the codepoint
of the DCI bandwidth part indicator field as specified in TS 38.212 [9]. The length of the
BWP ID field is 2 bits;
Cᵢ: This field indicates whether the octet containing TCI state ID_{i,2} is present. If this field
is set to “1,” the octet containing TCI state ID_{i,2} is present. If this field is set to “0,” the octet
containing TCI state ID_{i,2} is not present;
TCI state ID_{i,j}: This field indicates the TCI state identified by TCI-StateId as specified in
TS 38.331 [5], where i is the index of the codepoint of the DCI Transmission configuration
indication field as specified in TS 38.212 [9] and TCI state ID_{i,j} denotes the j-th TCI state
indicated for the i-th codepoint in the DCI Transmission Configuration Indication field. The
TCI codepoint to which the TCI States are mapped is determined by its ordinal position
among all the TCI codepoints with sets of TCI state ID_{i,j} fields, i.e., the first TCI codepoint
with TCI state ID_{0,1} and TCI state ID_{0,2} may be mapped to the codepoint value 0, the second
TCI codepoint with TCI state ID_{1,1} and TCI state ID_{1,2} may be mapped to the codepoint value
1 and so on. The TCI state ID_{i,2} is optional based on the indication of the Ci field. The
maximum number of activated TCI codepoint is 8 and the maximum number of TCI states
mapped to a TCI codepoint is 2.
R: Reserved bit, set to “0.”

In FIG. 23, for example, when a value of a Co field 2305 is 1, the corresponding MAC-CE may include a TCI state ID_{0,2} field 2315 in addition to a TCI state ID_{0,1} field 2310. This may mean that the TCI state ID_{0,1} and TCI state ID_{0,2} are activated for a zeroth codepoint in the TCI state field included in DCI. When the BS indicates the corresponding codepoint to the UE, the UE may receive an indication of two TCI states. For example, when a value of the Co field 2305 is 0, the corresponding MAC-CE cannot include the TCI state ID_{0,2} field 2315, which may mean that one TCI state corresponding to the TCI state ID_{0,1} are activated for the zeroth codepoint of the TCI state field included in the DCI.

The configuration may be independent for each cell or each BWP. For example, while a maximum number of activated TCI states corresponding to one TCI codepoint is 2 in the PCell, a maximum number of activated TCI states corresponding to one TCI codepoint may be 1 in a specific SCell. In this case, it may be considered that NC-JT is configured in the PCell but NC-JT is not configured in the SCell.

### [Method of Distinguishing Single-DCI-Based Multi-TRP PDSCH Repetitive Transmission Schemes (TDM/FDM/SDM)]

Subsequently, a method of distinguishing single-DCI-based multi-TRP PDSCH repetitive transmission schemes is described. The UE may receive an indication of different single-DCI-based multi-TRP PDSCH repetitive transmission schemes (for example, TDM, FDM, and SDM) from the BS according to a value indicated by a DCI field and a higher-layer signaling configuration. [Table 74] below shows a method of distinguishing single or multi-TRP-based schemes indicated to the UE according to a specific DCI field value and a higher-layer signaling configuration.

TABLE 74

| | | Number | repetitionNumber | | |
|---|---|---|---|---|---|
| | Number | of | configuration and | Related to a | Transmission |
| | of TCI | CDM | indication | repetitionScheme | scheme |
| Combination | state | group | condition | configuration | indicated to UE |
| 1 | 1 | ≥1 | Condition 2 | Not configured | Single-TRP |
| 2 | 1 | ≥1 | Condition 2 | Configured | Single-TRP |
| 3 | 1 | ≥1 | Condition 3 | Configured | Single-TRP |
| 4 | 1 | 1 | Condition 1 | Configured or | Single-TRP |
| | | | | not configured | TDM scheme B |
| 5 | 2 | 2 | Condition 2 | Not configured | Multi-TRP SDM |
| 6 | 2 | 2 | Condition 3 | Not configured | Multi-TRP SDM |
| 7 | 2 | 2 | Condition 3 | Configured | Multi-TRP SDM |
| 8 | 2 | 1 | Condition 3 | Configured | Multi-TRP FDM |
| | | | | | scheme A/FDM |
| | | | | | scheme B/TDM |
| | | | | | scheme A |
| 9 | 2 | 1 | Condition 1 | Not configured | Multi-TRP |
| | | | | | TDM scheme B |

In [Table 74], each column may be described below.
The number of TCI states (second column): means the number of TCI states indicated by a TCI state field within DCI and may be, for example, 1 or 2.
The number of CDM groups (third column): means the number of different CDM groups of DMRS ports indicated by an Antenna port field within DCI and may be, for example, 1, 2, or 3.
repetitionNumber configuration and indication condition (fourth column): has three conditions according to whether repetitionNumber for all TDRA entries which can be indicated by a time domain resource allocation field within DCI is configured and whether an actually indicated TDRA entry has a repetitionNumber configuration.
Condition 1: case in which at least one of all TDRA entries which can be indicated by the time domain resource allocation field includes the configuration for repetitionNumber and includes the configuration of repetitionNumber having the TDRA entry larger than 1, indicated by the time domain resource allocation field within DCI.
Condition 2: case in which at least one of all TDRA entries which can be indicated by the time domain resource allocation field includes the configuration for repetitionNumber and the TDRA entry indicated by the time domain resource allocation field within DCI does not include the configuration for repetitionNumber.
Condition 3: case in which all TDRA entries which can be indicated by the time domain resource allocation field do not include the configuration for repetitionNumber.
Related to a repetitionScheme configuration (fifth column): means whether repetitionSchem which is higher-layer signaling is configured. Higher-layer signaling repetitionScheme may receive a configuration of one of “tdmSchemeA,” and “fdmSchemeA,” “fdmSchemeB”.
Transmission scheme indicated to UE (sixth column): means single or multi-TRP schemes indicated according to each combination (first column) shown in [Table 74] above.
Single-TRP: means single-TRP-based PDSCH transmission. For example, when the UE receives a configuration of pdsch-AggegationFactor within higher-layer signaling PDSCH-config, the UE may receive scheduling of single TRP-based PDSCH repetitive transmission the number of times received through the configuration. Otherwise, the UE may receive scheduling of single TRP-based PDSCH single transmission.
Single-TRP TDM scheme B: means time resource division-based PDSCH repetitive transmission between single TRP-based slots. The UE repeatedly transmits a PDSCH on a time dimension a number of times corresponding to the number of slots of repetitionNumber larger than 1 configured in the TDRA entry indicated by the time domain resource allocation field according to condition 1 related to repetitionNumber. At this time, a start symbol and a symbol length of the PDSCH indicated by the TDRA entry may be equally applied to every slot a number of times corresponding to repetitionNumber and the same TCI state may be applied to every PDSCH repetitive transmission. The corresponding scheme is similar to a slot aggregation scheme in that the PDSCH repetitive transmission between slots is performed in time resources but is different therefrom in that a repetitive transmission indication is dynamically determined on the basis of the time domain resource allocation field within DCI.
Multi-TRP SDM: means a multi-TRP-based space resource division PDSCH transmission scheme. This is a method of dividing a layer and performing reception from each TRP and may increase reliability of PDSCH transmission in that transmission can be performed at a lowered coding rate through an increase in the number of layers even though it is not the repetitive transmission scheme. The UE may receive a PDSCH by applying each of two TCI states indicated through the TCI state field within DCI to two CDM groups indicated by the BS.
Multi-TRP FDM scheme A: means a multi-TRP-based frequency resource division PDSCH transmission scheme and is a scheme having one PDSCH transmission occasion and capable of performing transmission with higher reliability by increasing frequency resources and lowering a coding rate even though is not the repetitive transmission such as multi-TRP SDM. Multi-TRP FDM scheme A may apply two TCI states indicated through the TCI state field within DCI to frequency resources which do not overlap each other. For example, when the PRB bundling size is determined as a wideband and the number of RBs indicated by the frequency domain resource allocation field is N, the UE may receive first ceil (N/2) RBs by applying a first T_{C} state and receive the remaining floor (N/2) RBs by applying a second TCI state. Here, ceil (.) and floor (.) operators indicating rounding up and rounding down at the first decimal place. For example, when the PRB bundling size is determined as 2 or 4, even-numbered PRGs are received by applying a first TCI state and odd-numbered PRGs are received by applying a second TCI state.
* Multi-TRP FDM scheme B: means a multi-TRP-based frequency resource division PDSCH repetitive transmission scheme and has two PDSCH transmission occasions to repeatedly transmit a PDSCH at each occasion. Same as multi-TRP FDM scheme A, multi-TRP FDM scheme B may also apply two TCI states indicated through the TCI state field within DCI to frequency resources which do not overlap each other. For example, when the PRB bundling size is determined as a wideband and the number of RBs indicated by the frequency domain resource allocation field is N, the UE may apply a first T_{C} state to first ceil (N/2) RBs to receive the first ceil (N/2) RBs and apply a second TCI state to the remaining floor (N/2) RBs to receive the remaining floor (N/2) RBs. Here, ceil (.) and floor (.) operators indicating rounding up and rounding down at the first decimal place. For example, when the PRB bundling size is determined as 2 or 4, even-numbered PRGs are received by applying a first TCI state and odd-numbered PRGs are received by applying a second TCI state.
Multi-TRP TDM scheme A: means a PDSCH repetitive transmission scheme within a multi-TRP-based time resource division slot. The UE may have two PDSCH transmission occasion within one slot, and a first reception occasion may be determined on the basis of a start symbol and a symbol length of the PDSCH indicated through the time domain resource allocation field within DCI. A start symbol of a second reception occasion of the PDSCH may be an occasion to which a symbol offset is applied by higher-layer signaling StartingSymbolOffsetK from the last symbol of the first transmission occasion, and the transmission occasion corresponding to the symbol length indicated therefrom may be determined. For example, when higher-layer signaling StartingSymbolOffsetK is not configured, the symbol offset may be considered as 0.
Multi-TRP TDM scheme B: means a PDSCH repetitive transmission scheme between multi-TRP-based time resource division slots. The UE may have one PDSCH transmission occasion within one slot and may receive repetitive transmission, based on a start symbol and a symbol length of the same PDSCH during slots corresponding to repetitionNumber indicated by the time domain resource allocation field within DCI. For example, when repetitionNumber is 2, the UE may receive PDSCH repetitive transmission of first and second slots by applying first and second TCI states, respectively. When repetitionNumber is larger than 2, the UE may use different TCI state application schemes according to which higher-layer signaling tciMapping is configured. For example, when tciMapping is configured as cyclicMapping, first and second TCI states may be applied to first and second PDSCH transmission occasions, respectively, and the same TCI state application method may be equally applied to the remaining PDSCH transmission occasions. For example, when tciMapping is configured as sequenticalMapping, a first TCI state may be applied to first and second PDSCH transmission occasions, a second TCI state may be applied to third and fourth PDSCH transmission occasions, and the same TCI state application method may be equally applied to the remaining PDSCH transmission occasions.

### [Others]

### [Additional Multi-TCI State Indication and Activation Method Based on Unified TCI Scheme]

As embodiment of the disclosure, an additional multi-TCI state indication and activation method based on a unified TCI scheme is described. The UE may receive scheduling of a PDSCH including MAC-CEs which can be configured by a combination of at least one of the following various MAC-CE structures from the BS and analyze each codepoint in a TCI state field within DCI format 1_1 or 1_2 after three slots for transmitting HARQ-ACK for the corresponding PDSCH to the BS, based on information within the MAC-CEs received from the BS. For example, the UE may activate each entry of the MAC-CE received from the BS in each codepoint in the TCI state field within DCI format 1_1 or 1_2.

For example, when the UE receives the configuration of two different CORESETPoolIndex through higher-layer signaling and receives the configuration of higher-layer signaling UL-TCIState or UL-TCIState, the BS and the UE may expect that an R field 1130 existing in the first octet is analyzed as a field indicating a CORESET Pool ID in FIG. 11 that is one of the MAC-CE formats indicating unified TCI state activation. For example, when the corresponding CORESET Pool ID is configured as 0, the UE may consider that the corresponding MAC-CE can be applied to each codepoint in the TCI state field within the PDCCH transmitted in the CORESET corresponding to CORESETPoolIndex 0. For example, when the corresponding CORESET Pool ID is configured as 1, the UE may consider that the corresponding MAC-CE can be applied to each codepoint in the TCI state field within the PDCCH transmitted in the CORESET corresponding to CORESETPoolIndex 1.

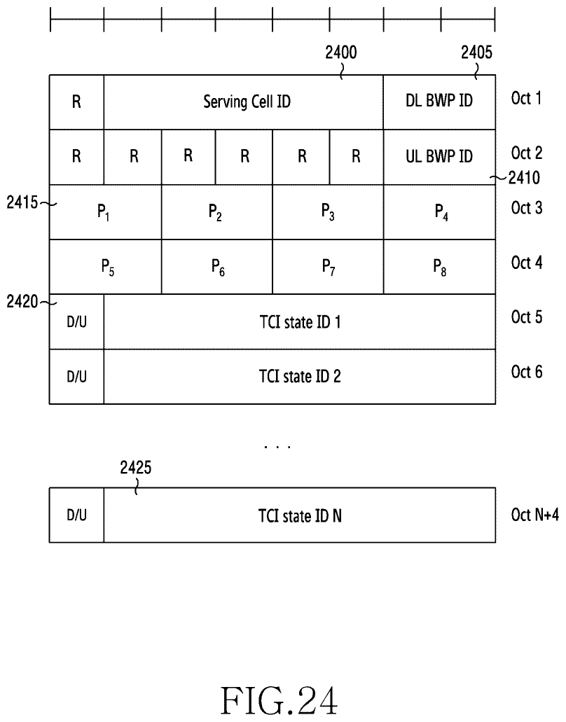

FIG. 24 illustrates another MAC-CE format for activating and indicating a plurality of joint TCI states or separate DL or UL TCI states in a wireless communication system according to an embodiment of the disclosure. The meaning of each field within the corresponding MAC-CE format is described below.

Serving cell ID 2400: this field may indicate a service cell to which the corresponding MAC-CE is applied. The length of this field may be 5 bits. For example, when the serving cell indicated by this field is included in one or more of simultaneousU-TCI-UpdateList1, simultaneousU-TCI-UpdateList2, simultaneousU-TCI-UpdateList3, or simultaneousU-TCI-UpdateList4 which is higher layer signaling, the corresponding MAC-CE may be applied to all serving cells included in a list of one or more of simultaneousU-TCI-UpdateList1, simultaneousU-TCI-UpdateList2, simultaneousU-TCI-UpdateList3, and simultaneousU-TCI-UpdateList4 including the serving cell indicated by this field.
DL BWP ID 2405: this field may indicate a DL BWP to which the corresponding MAC-CE is to be applied, and the meaning of each codepoint in this field may correspond to each codepoint of a bandwidth part indicator within DCI. The length of this field may be 2 bits.
UL BWP ID 2410: this field may indicate a UL BWP to which the corresponding MAC-CE is to be applied, and the meaning of each codepoint in this field may correspond to each codepoint of a bandwidth part indicator within DCI. The length of this field may be 2 bits.

Pᵢ 2415: this field may indicate whether each codepoint in the TCI state field within DCI format 1_1 or 1_2 has a plurality of TCI states or one TCI state.
for example, when unifiedTCI-StateType-r17 in MIMOparam-r17 within higher-layer signaling ServingCellConfig can be configured for one of joint and separate, the UE may analyze this field as follows regardless of which one is configured between two pieces of configuration information.
For example, when the value of Pᵢ is “00,” it means that the corresponding i^{th} codepoint has a single TCI state, which may imply that the corresponding codepoint includes the joint TCI state or one of the separate DCI TCI state or the separate UL TCI state.
** For example, when the value of Pᵢ is “01,” it means that the corresponding i^{th} codepoint has two TCI states, which may imply that the corresponding codepoint includes one of two joint TCI states, one separate DL TCI state and one separate UL TCI state, two separate DL TCI states, or two separate UL TCI states.
** For example, when the value of Pᵢ is “10,” it means that the corresponding i^{th} codepoint has three TCI states, which may imply that the corresponding codepoint includes one separate DL TCI state and two separate UL TCI state, or two separate DL TCI states and one separate UL TCI state.
** For example, when the value of Pᵢ is “11,” it means that the corresponding i^{th} codepoint has four TCI states, which may imply that the corresponding codepoint includes two separate DL TCI states and two separate UL TCI states.
* For example, when the UE can configure unifiedTCI-StateType-r17 in MIMOparam-r17 within ServingCellConfig corresponding to higher-layer signaling for one of joint, separate, and mixed mode, the UE may analyze this field as follows regardless of a configured value among available configuration values. The mixed mode may be expressed as one configuration value having the meaning that the general mixed mode of the joint TCI state and the separate DL or UL TCI state is possible and/or expressed as a plurality of configuration values such as “1joint+1DL” and “1joint+1UL,” and thus may be configured to indicate a specific combination of the specific number of joint TCI states and the specific number of separate DL or UL TCI states.
** For example, when the value of Pᵢ is “00,” it means that the corresponding i^{th} codepoint has a single TCI state, which may imply that the corresponding codepoint includes the joint TCI state, one of the separate DCI TCI state, or the separate UL TCI state.
** for example, when the value of Pᵢ is “01,” it means that the corresponding i^{th} codepoint has two TCI states, which may imply that the corresponding codepoint includes one of two joint TCI states, one joint TCI state and one separate DL TCI state, one joint TCI state and one separate UL TCI state, one separate DL TCI state and one separate UL TCI state, two separate DL TCI states, or two separate UL TCI states. For example, when the UE receives a configuration of a value indicating that the general mixed mode of the joint TCI state and the separate DL or UL TCI state is possible for unified TCI-StateType-r17 within MIMOparam-r17 in higher-layer signaling ServingCellConfig ike the mixed mode, one joint TCI state and one separate DL TCI state and one joint TCI state and one separate UL TCI state may be all possible. For example, when the UE receives a configuration of one of “1joint+1DL” and “1joint+1UL” through unifiedTCI-State Type-r17 in MIMOparam-r17 within ServingCellConfig corresponding to higher-layer signaling, only the case corresponding to a configuration value of unifiedTCI-StateType-r17 may be possible between one joint TCI state and one separate DL TCI state, and one joint TCI state and one separate UL TCI state.
** For example, when the value of Pᵢ is “10,” it means that the corresponding i^{th} codepoint has three TCI states, which may imply that the corresponding codepoint includes one separate DL TCI state and two separate UL TCI states, or two separate DL TCI states and one separate UL TCI state.
** For example, when the value of Pᵢ is “11,” it may mean that the corresponding i^{th} codepoint has four TCI states, which may imply that the corresponding codepoint includes two separate DL TCI states and two separate UL TCI states.
* The corresponding field may be 2 bits.

D/U 2420: this field may indicate whether a TCI state ID field within the same octet is a joint TCI state, a separate DL TCI state, or a separate UL TCI state. For example, when this field is 1, the TCI state ID field within the same octet may be the joint TCI state or the separate DL TCI state and, for example, when this field is 0, the TCI state ID within the same octet may be the separate UL TCI state.
TCI state ID 2425: this field may indicate a TCI state that can be detected by a TCI-StateId corresponding to higher-layer signaling. For example, when the D/U field is configured as 1, this field may be used to express the TCI-StateId that can be expressed by 7 bits. For example, when the D/U field is configured as 0, a most significant bit (MSB) of this field may be considered as being reserved, and the remaining 6 bits may be used to express the UL-TCIState-Id corresponding to higher layer signaling. The maximum of TCI states that can be activated may be 8 in the case of the joint TCI state and 16 in the case of the separate DL or UL TCI state.
R: means a reserved bit and may be configured as 0.

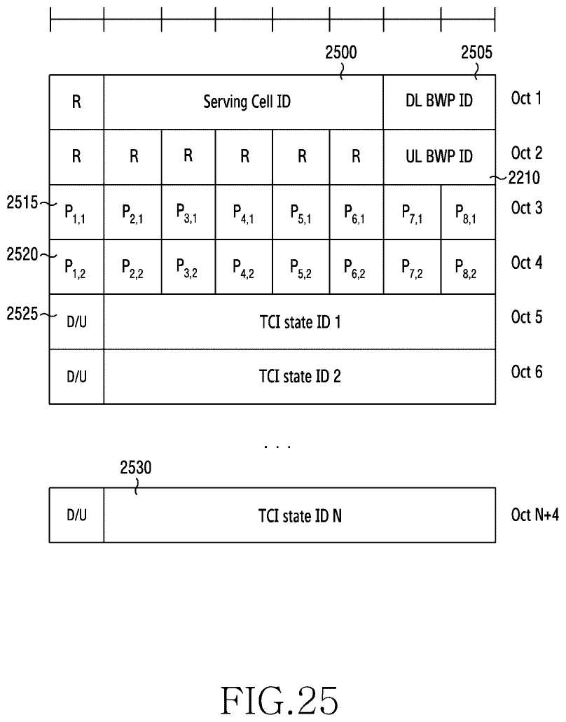

FIG. 25 illustrates another MAC-CE format for activating and indicating a plurality of joint TCI states or separate DL or UL TCI states in a wireless communication system according to an embodiment of the disclosure. The meaning of each field within the corresponding MAC-CE format is described below.

Serving cell ID 2500: this field may indicate a service cell to which the corresponding MAC-CE is applied. The length of this field may be 5 bits. For example, when the serving cell indicated by this field is included in one or more of simultaneousU-TCI-UpdateList1, simultaneousU-TCI-UpdateList2, simultaneousU-TCI-UpdateList3, or simultaneousU-TCI-UpdateList4 which is higher layer signaling, the corresponding MAC-CE may be applied to all serving cells included in a list of one or more of simultaneousU-TCI-UpdateList1, simultaneousU-TCI-UpdateList2, simultaneousU-TCI-UpdateList3, and simultaneousU-TCI-UpdateList4 including the serving cell indicated by this field.
DL BWP ID 2505: this field may indicate a DL BWP to which the corresponding MAC-CE is to be applied, and the meaning of each codepoint in this field may correspond to each codepoint of a bandwidth part indicator within DCI. The length of this field may be 2 bits.
UL BWP ID 2510: this field may indicate a UL BWP to which the corresponding MAC-CE is to be applied, and the meaning of each codepoint in this field may correspond to each codepoint of a bandwidth part indicator within DCI. The length of this field may be 2 bits.

P_{i.1} 2515, P_{i.2} 2520: these two fields may indicate whether each codepoint in the TCI state field within DCI format 1_1 or 1_2 has a plurality of TCI states or one TCI state.
* For example, in the case where unifiedTCI-StateType-r17 in MIMOparam-r17 within higher-layer signaling ServingCellConfig can be configured for one of joint and separate or configured for one of joint, separate, and mixed mode, when the UE receives a configuration of higher-layer signaling unifiedTCI-StateType-r17 as joint, the UE may omit the fourth octet including the P_{12,}, P_{22,}, . . . , P_{8,2} fields in FIG. 25 and make interpretation only for P_{i,1} as follows. The mixed mode may be expressed as one configuration value having the meaning that the general mixed mode of the joint TCI state and the separate DL or UL TCI state is possible and/or expressed as a plurality of configuration values such as “1joint+1DL” and “1joint+1UL,” and thus may be configured to indicate a specific combination of the specific number of joint TCI states and the specific number of separate DL or UL TCI states.
** For example, when a value of P_{i.1}—is “0,” it may mean that the corresponding i^{th} codepoint has one TCI state, which may imply that the corresponding codepoint includes one joint TCI state.
** For example, when a value of P_{i.1}—is “1,” it may mean that the corresponding i^{th} codepoint has two TCI states, which may imply that the corresponding codepoint includes two joint TCI states.
* For the case where unifiedTCI-StateType-r17 in MIMOparam-r17 within ServingCellConfig corresponding to higher-layer signaling can be configured for one of joint and separate or configured for one of joint, separate, and mixed mode, if the UE receives a configuration of unifiedTCI-StateType-r17 corresponding to higher-layer signaling as separate, the UE may consider P_{i.1} of the third octet and P_{i.2} of the fourth octet as one field of 2 bits and make interpretation as follows. The mixed mode may be expressed as one configuration value having the meaning that the general mixed mode of the joint TCI state and the separate DL or UL TCI state is possible and/or expressed as a plurality of configuration values such as “1joint+1DL” and “joint+1UL,” and thus may be configured to indicate a specific combination of the specific number of joint TCI states and the specific number of separate DL or UL TCI states.
** For example, when the value of P_{i.1} and the value of P_{i.2} are “0” and “0,” it may mean that the corresponding i^{th} codepoint has a single TCI state, which may imply that the corresponding codepoint includes the one of the separate DL TCI state or the separate UL TCI state.
** For example, when the value of P_{i.1} and the value of P_{i.2} are “0” and “1,” respectively, it may mean that the corresponding i^{th} codepoint has two TCI states, which may imply that the corresponding codepoint includes one of one separate DL TCI state and one separate UL TCI state, two separate DL TCI states, or two separate UL TCI states.
** For example, when the value of P_{i.1} and the value of P_{i.2} are “1” and “0,” respectively, it may mean that the corresponding i^{th} codepoint has three TCI states, which may imply that the corresponding codepoint includes one separate DL TCI state and two separate UL TCI states, or two separate DL TCI states and one separate UL TCI state.
** For example, when the value of P_{i.1} and the value of P_{i.2} are “1” and “1,” it may mean that the corresponding i^{th} codepoint has four TCI states, which may imply that the corresponding codepoint includes two separate DL TCI states and two separate UL TCI states.
* For example, when unifiedTCI-StateType-r17 in MIMOparam-r17 within higher-layer signaling ServingCellConfig can be configured for one of joint, separate, and mixed mode, the UE may interpret P_{i.1} of the third octet as follows and may not transmit the fourth octet when higher-layer signaling unifiedTCI-StateType-r17 is configured as the mixed mode. The mixed mode may be expressed as one configuration value having a meaning that the general mixed mode of the joint TCI state and the separate DL or UL TCI state is possible.
** For example, when a value of P_{i.1} is “0,” it may mean that the corresponding i^{th} codepoint includes one joint TCI state and one separate DL TCI state.
** For example, when a value of P_{i.1} is “1,” it may mean that the corresponding i^{th} codepoint includes one joint TCI state and one separate UL TCI state.
* For example, when unifiedTCI-StateType-r17 in MIMOparam-r17 within higher-layer signaling ServingCellConfig can be configured for one of joint, separate, and mixed mode, the UE may interpret P_{i.1} of the third octet and P_{i.2} of the fourth octet as follows when higher-layer signaling unifiedTCI-StateType-r17 is configured as the mixed mode. The mixed mode may be expressed as one configuration value having a meaning that the general mixed mode of the joint TCI state and the separate DL or UL TCI state is possible.
** For example, when the value of P_{i.1} is “0,” it may mean that the corresponding i^{th} codepoint includes only one joint TCI state. That is, since the mixed mode is not used, the value of P_{i.2} may be ignored.
** For example, when the value of P_{i.1} is “1,” it may mean that the corresponding i^{th} codepoint includes one of one separate UL TCI state and one separate DL TCI state in addition to one joint TCI state. That is, the mixed mode can be used for the corresponding codepoint, and one separate UL TCI state may be additionally used when the value of P_{i.2} is “0” and one separate UL TCI state may be additionally used when the value of P_{i.2} is “1.”

D/U 2525: this field may indicate whether a TCI state ID field within the same octet is a joint TCI state, a separate DL TCI state, or a separate UL TCI state. For example, when this field is 1, the TCI state ID field within the same octet may be the joint TCI state or the separate DL TCI state and, for example, when this field is 0, the TCI state ID within the same octet may be the separate UL TCI state.
TCI state ID 2530: this field may indicate a TCI state that can be detected by a TCI-StateId corresponding to higher-layer signaling. For example, when the D/U field is configured as 1, this field may be used to express the TCI-Stated that can be expressed by 7 bits. For example, when the D/U field is configured as 0, a most significant bit (MSB) of this field may be considered as being reserved, and the remaining 6 bits may be used to express the UL-TCIState-Id corresponding to higher layer signaling. The maximum of TCI states that can be activated may be 8 in the case of the joint TCI state and 16 in the case of the separate DL or UL TCI state.
R: means a reserved bit and may be configured as 0.

According to various embodiments of the disclosure, the above-described parameters are only examples and not limited thereto, and unifiedTCI-StateType-r17 in MIMOparam-r17 within higher-layer signaling ServingCellConfig in may be defined as a new parameter like unifiedTCI-StateType-r18 within higher-layer signaling MIMOparam-r18 in ServingCellConfig, or the existing parameter may be reused.

### [Group-Based Beam Reporting]

Subsequently, when the UE is able to simultaneously receive a plurality of reference signals (for example, CSI-RS or SSB resources) that can be simultaneously received, the UE may report channel state information (CSI) for the reference signals that can be simultaneously received to the BS through group-based beam reporting. The group-based beam reporting may be largely divided into two methods. In the group-based beam reporting of the first method, the UE may report indexes of two different reference signals (for example, CSI RS resource indicator (CRI) or SSB resource indicator (SSBRI)) that can be simultaneously received to the BS at a single reporting instance. In the group-based beam reporting of the second method, the UE may report one or more group(s) to the BS at a single CSI report instance. The following detailed description may include the content of the group-based beam reporting of the second method.

When the group-based beam reporting of the second method is performed, a group may include indexes of two reference signals (for example, CRI or SSBRI) that can be simultaneously received by the UE, and the BS may configure the number of groups that the UE can report in the UE with reference to a UE capability report made by the UE through higher-layer signaling such as “nrofReportedGroups.” The higher-layer parameter “nrofReportedGroups” may be configured as one of 1 to 4 in the UE by the BS. Two reference signals which can be detected through reference signal indexes included in one group and can be simultaneously received by the UE may be selected as CSI-RSs or SSBs from respective two resource sets for CSI report setting (for example, may be defined as two CSI resource sets according to the content specified in TS 38.214 or defined as channel measurement resource sets according to the content specified in TS 38.212).

For example, an index of a first reference signal in one group which the UE reports to the BS may be determined by selecting one reference signal (for example, a reference signal having the largest RSRP that has been measured among reference signals within the corresponding CSI resource set) from one resource set of the two CSI resource sets (for example, a CSI resource set including the reference signal having the largest RSRP that has been measured (the largest measured) may be selected among the two CSI resource sets, and the UE may report an Indicator of the corresponding resource set to the BS as a “resource set indicator” to report CSI). As described above, the index of the first reference signal in the first group may be the reference signal having the largest RSPR among all reference signals within two resource sets and, based on this, the UE may select a CSI resource set within the group from which the index of the first reference signal is selected among the two CSI resource sets and may report the resource set indicator therefor to the BS as CSI information. After selecting the index of the first reference signal within the first group, the UE may select an index of a second reference signal within the first group. The UE may select the index of the second reference signal within the first group as an index of one of reference signals within the other resource sets of the two resource sets (for example, a reference signal having the largest RSRP that has been measured among a plurality of reference signals that can be simultaneously received with the first reference signal within the first group) rather than the resource set from which the first reference signal within the first group is selected. The UE may report RSRP of a reference signal indicated by the index of the first reference signal within the first group.

For a reference signal indicated by an index of another reference signal (for example, the index of the second reference signal within the first group), the UE may report Differential RSRP indicating a difference value from the measured RSRP of the reference signal indicated by the index of the first reference signal within the first group. For example, when the measured RSRP of the reference signal indicated by the index of the first reference signal within the first group is defined as RSRP1 and the measured RSRP of the reference signal indicated by the index of the second reference signal within the first group is defined as RSRP2, the UE may determine the Differential RSRP reported together with the index of the index of the second reference signal within the first group as a value indicating RSRP1-RSRP2 through an interval of 2 dB. In order to make the group-based beam reporting of the second method, two CSI resource sets should be defined as described above. When resourceType within a higher-layer signaling parameter CSI-ResourceConfig is configured as “periodic” or “semiPersistent” and “groupBasedBeamReporting-v1710” is configured for two CSI resource sets, the BS may configure two NZP CSI-RS resource sets (for example, two NZP-CSI-RS-ResourceSetID may be configured in nzp-CSI-RS-ResourceSetList), two CSI SSB resource sets (for example, two CSI-SSB-ResourceSetId may be configured in csi-SSB-ResourceSetList), or one NZP CSI-RS resource set and one CSI SSB resource set (for example, one NZP-CSI-RS-ResourceSetId may be configured in nzp-CSI-RS-ResourceSetList and one CSI-SSB-ResourceSetId may be configured in csi-SSB-ResourceSetList).

For example, when one NZP CSI-RS resource set and one CSI SSB resource set are configured and the UE transmits the group-based beam reporting of the second method to the BS, the UE may configure the resource set indicator as “1” and report that the reference signal indicated by the index of the first reference signal within the first group is included in one CSI SSB resource set to the BS. For example, when one NZP CSI-RS resource set and one CSI SSB resource set are configured and the UE transmits the group-based beam reporting of the second method to the BS, the UE may configure the resource set indicator as “0” and report that the reference signal indicated by the index of the first reference signal within the first group is included in one NZP CSI resource set to the BS. For example, when two NZP CSI-RS resource sets are configured and the UE transmits the group-based beam reporting of the second method to the BS, the UE may configure the resource set indicator as “0” and report that the reference signal indicated by the index of the first reference signal within the first group is included in the first NZP CSI resource set to the BS or configure the resource set indicator as “1” and report that the reference signal indicated by the index of the first reference signal within the first group is included in the second NZP CSI resource set to the BS. For example, when two CSI SSB resource sets are configured and the UE transmits the group-based beam reporting of the second method to the BS, the UE may configure the resource set indicator as “0” and report that the reference signal indicated by the index of the first reference signal within the first group is included in the first CSI SSB resource set to the BS or configure the resource set indicator as “1” and report that the reference signal indicated by the index of the first reference signal within the first group is included in the second CSI SSB resource set to the BS.

For example, when the higher-layer parameter groupBasedBeamResporting-v1710 (or groupBasedBeamReporting-r17) is configured in the UE, the UE does not need to update measurement for CSI-RS and/or SSB resources that are larger than 64. Further, the UE may report group(s) corresponding to nrofReportedGroups (if configured) to the BS at a single reporting instance, and select one CSI-RS or SSB from each CSI resource set of the two CSI resource sets according to the reporting setting to select two CRIs or SSBRIs as one group as described above. CSI-RS and/or SSB resources in each group are selected from resources that can be simultaneously received by the UE.

[Table 75] below describes a method of configuring a CSI field (area) for an nth CSI report when the UE transmits the group-based beam reporting of the second method to the BS. As described above, the UE may configure a resource set indicator to be indicated through selection of one of the two CSI resource sets (or channel measurement resource sets), two reference indexes included in a maximum of 4 resource groups, and RSRP or differential RSRP therefor as CSI fields and report the CSI fields to the BS.

TABLE 75

| CSI report | |
|---|---|
| number | CSI fields |
| CSI | Resource set indicator |
| report #n | CRI or SSBRI #1 of 1st resource group |
| | CRI or SSBRI #2 of 1st resource group |
| | CRI or SSBRI #1 of 2nd resource group |
| | CRI or SSBRI #2 of 2nd resource group |
| | CRI or SSBRI #1 of 3rd resource group |
| | CRI or SSBRI #2 of 3rd resource group |
| | CRI or SSBRI #1 of 4th resource group |
| | CRI or SSBRI #2 of 4th resource group |
| | RSRP of CRI or SSBRI #1 of 1st resource group |
| | Differential RSRP of GRI or SSBRI #2 |
| | of 1st resource group |
| | Differential RSRP of CRI or SSBRI #1 of |
| | 2nd resource group |
| | Differential RSRP of CRI or SSBRI #2 of |
| | 2nd resource group |
| | Differential RSRP of CRI or SSBRI #1 of |
| | 3rd resource group |
| | Differential RSRP of CRI or SSBRI #2 of |
| | 3rd resource group |
| | Differential RSRP of CRI or SSBRI #1 of |
| | 4th resource group |
| | Differential RSRP of CRI or SSBRI #2 of |
| | 4th resource group |

Each elements included in the CSI field may be determined as shown in [Table 76]. K_{R}^{CSI-RS} is the number of CSI-RS resources configured in the corresponding CSI resource set, and K_{R}^{SSB} is the number of SS/PBCH blocks configured in the corresponding CSI resource set.

TABLE 76

| Field | Bitwidth |
|---|---|
| CRI | [log₂(Kₛ^{CSI-RS})] |
| SSBRI | [log₂(Kₛ^{SSB})] |
| RSRP | 7 |
| Differential RSRP | 4 |
| Capability Index | 2 |

### Detailed Embodiments

Hereinafter, various embodiments of the disclosure will be described in detail in conjunction with the accompanying drawings. Of course, the embodiments of the disclosure may be employed in FDD and TDD systems. As used herein, upper signaling (or upper layer signaling) is a method for transferring signals from a base station to a UE by using a downlink data channel of a physical layer, or from the UE to the base station by using an uplink data channel of the physical layer, and may also be referred to as RRC signaling, PDCP signaling, or a medium access control (MAC) control element (MAC CE).

In the following description of the disclosure, the UE may use various methods to determine whether or not to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific range indicated by an upper layer. Hereinafter, it will be assumed, for the sake of descriptive convenience, that NC-JT case refers to a case in which the UE receives a PDSCH to which cooperative communication is applied, based on conditions similar to those described above.

Hereinafter, determining priority between A and B may be variously described as, for example, selecting an entity having a higher priority according to a predetermined priority rule and performing an operation corresponding thereto, or omitting or dropping operations regarding an entity having a lower priority.

Hereinafter, the above examples may be described through several embodiments, but they are not independent of each other, and one or more embodiments may be applied simultaneously or in combination.

Hereinafter, for the sake of descriptive convenience, a cell, a transmission point, a panel, a beam, and/or a transmission direction which can be distinguished through an upper layer/L1 parameter such as a TCI state or spatial relation information, a cell ID, a TRP ID, or a panel ID may be described as a transmission reception point (TRP) (for example, transmission point), a beam, or a TCI state as a whole. Therefore, when actually applied, a TRP, a beam, or a TCI state may be appropriately replaced with one of the above terms.

Hereinafter, embodiments of the disclosure will be described in detail in conjunction with the accompanying drawings. In the following description, a base station is an entity that allocates resources to terminals, and may be at least one of a gNode B, a gNB, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the following description of embodiments of the disclosure, the 5G system will be described by way of example, but the embodiments of the disclosure may be applied to other communication systems having similar technical backgrounds or channel types. Examples of such communication systems may include LTE or LTE-A mobile communication systems and mobile communication technologies developed beyond 5G. Therefore, based on determinations by those skilled in the art, the embodiments of the disclosure may also be applied to other communication systems through some modifications without significantly departing from the scope of the disclosure.

Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description of the disclosure, upper layer signaling may refer to signaling corresponding to at least one signaling among the following signaling, or a combination of one or more thereof:
Master information block (MIB);
System information block (SIB) or SIB X (X=1, 2, . . . );
Radio resource control (RRC); and/or
Medium access control (MAC) control element (CE).

In addition, L1 signaling may refer to signaling corresponding to at least one signaling method among signaling methods using the following physical layer channels or signaling, or a combination of one or more thereof:
Physical downlink control channel (PDCCH);
Downlink control information (DCI);
UE-specific DCI;
Group common DCI;
Common DCI;
Scheduling DCI (for example, DCI used for the purpose of scheduling downlink or uplink data);
Non-scheduling DCI (for example, DCI not used for the purpose of scheduling downlink or uplink data)-physical uplink control channel (PUCCH); and/oe
Uplink control information (UCI).

As used herein, the term “slot” may generally refer to a specific time unit corresponding to a transmit time interval (TTI), may specifically refer to a slot used in a 5G NR system, or may refer to a slot or a subframe used in a 4G LTE system. Furthermore, it will be apparent that a panel (or beam) according to various embodiments is used to transmit a signal and this term may be replaced with the term “resource for RS, CSI-RS, or SSB,” and the expression “at least one” may include one or more of items enumerated and the expression “multiple” may include two or more of items enumerated.

### First Embodiment: Method of Supporting Multiple TRPs Based on Plurality of TAs

The first embodiment describes a method by which the BS supports timing advance (TA) associated with each TRP in order to operate multiple TRPs based on multiple DCI for the UE.

The UE may support timing advance for matching a downlink frame and an uplink frame from the BS side. When the UE supports multiples TRPs based on multiple DCI, the UE may associate the plurality of TRPs with single TA to support the TRPs or may associate the plurality of TRPs with the plurality of TA to support the TRPs according to the UE capability. For example, the UE may associate two TRPs with single TA to support multiple TRPs or may associate two TRPs with two TAs to support multiple TRPs. The UE may support multiple TRPs by using single TA or multiple TAs even when multiple TRPs based on single DCI are supported. When respective TRPs are supported while being associated with TAs during supporting of a multi-DCI-based multi-TRP, the BS may indicate a timing advance command in order to allow the UE to match different uplink transmission timing of respective TRPs due to difference in the propagation path between the respective TRPs and the UE by using the TAs.

In order to associate and support two TRPs and two TAs, the UE may need to report an additional UE capability (optional UE capability) to the BS. The BS may configure a higher-layer parameter for supporting a multi-DCI-based multi-TRP and a higher-layer parameter for supporting multiple TAs in the UE, based on an additional UE capability report made by the UE.

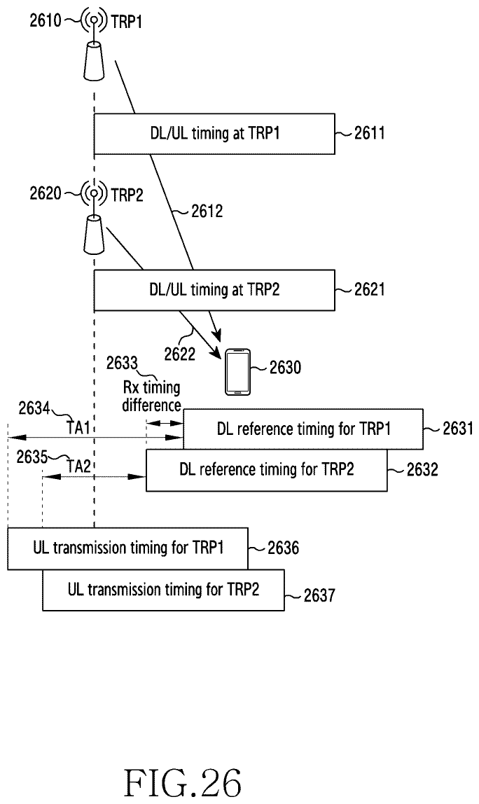

FIG. 26 illustrates an example of supporting multiple TRPs based on multiple DCI by using a plurality of Tas according to an embodiment of the disclosure.

A UE 2630 may support a multi-DCI-based multi-TRP transmission/reception scheme for transmitting and receiving uplink signals to two TRPs 2610 and 2620. FIG. 26 illustrates, as an example, the case where the two TRPs 2610 and 2620 are synchronized and thus uplink timing 2611 for TRP 1 (or a TRP associated with CORESETPoolIndex=0) and uplink timing 2621 for TRP 2 (or a TRP associated with CORESETPoolIndex=1) are the same. For example, when the two TRPs 2610 and 2620 are not completely synchronized, uplink timing 2611 and 2621 for two TRPs may not be the same. For example, when the UE 2630 receives a downlink signal from TRP 1 2610 through a path 2612 between TRP 1 and the UE, the UE may receive the downlink signal according to DL reference timing 2631 for TRP 1 due to propagation delay according to the path 2612 between TRP 1 and the UE. For example, when the UE 2630 receives a downlink signal from TRP 2 2620 through a path 2622 between TRP 2 and the UE, the UE may receive the downlink signal according to DL reference timing 2632 for TRP 2 due to propagation delay according to the path 2622 between TRP 2 and the UE. At this time, since the path 2612 between TRP 1 and the UE and the path 2622 between TRP 2 and the UE are different, there may be difference in start timing between the DL reference timing 2631 and the DL reference timing 2632. This may be defined as Rx timing difference 2633, and the maximum Rx timing difference that can be supported by the UE may be determined by an additional UE capability. When the multi-DCI-based multi-TRP transmission and reception scheme is supported, each TA 2634 or 2635 associated with each TRP may be supported and may be indicated according to an associated timing advance group (TAG). At this time, a timing advance offset and a timing advance command may be indicated according to a TAG associated with each TRP, and TA for controlling uplink timing of each TRP may be determined, based thereon.

When the Rx timing difference between two TRPs is smaller than a “predetermined value” and the UE supports a UE capability for supporting TA for each TRP, the BS may support the corresponding UE through an uplink transmission timing control method using T_{A} for each TRP even though a separate additional UE capability according to the Rx timing difference is not supported by the UE. On the other hand, when the Rx timing difference between two TRPs is larger than the “predetermined value,” in order to allow the BS to support the corresponding UE through the uplink transmission timing control method using the TA for each TRP, the UE may additionally support the separate additional UE capability according to the Rx timing difference unlike the above case. The “predetermined value” for determining a need of the support of the additional UE capability may be defined as a common value shared in advance between the BS and the UE. For example, the BS and the UE may predefine a predetermined value through an implicit method (for example, a ratio of the length of a CP calculated in consideration of SCS for an active BWP of the corresponding serving cell, a multiple of the length of the CP, or a portion of the length of the CP (for example, half the length of the CP)), and the UE may identify whether the Rx timing difference is larger or smaller than the predefined value to determine whether an additional UE capability report is needed. Alternatively, the BS and the UE may configure the “predetermined value” as a higher-layer parameter (RRC parameter) through an explicit method, and the UE may identify whether the Rx timing difference is larger or smaller than the value configured as the RRC parameter to determine whether the additional UE capability report is needed.

As described above, the reason why the separate additional UE capability report is needed when the Rx timing difference between two TRPs is larger than, for example, the CP length is described below. Downlink signals (for example, PDSCHs) received from respective TRPs may generate interference due to timing difference between the signals. At this time, when the Rx timing difference is smaller than the CP length, the UE may decode each PDSCH through one processing process (or processing module or processing capability) according to a characteristic of an OFDM signal. However, when the Rx timing difference is larger than the CP length, interference by difference PDSCHs may be larger than the CP length, and thus the UE may not decode all of the two PDSCHs through one processing process due to the interference. That is, in order to decode each PDSCH, a separate processing process (or parallel processing) may be required for each PDSCH.

In consideration of this, when the Rx timing difference between two TRPs is larger than the CP length, the BS may support the UE through a method of receiving a downlink signal, based on DL reference timing for each TRP and a method of controlling uplink transmission timing, based on TA for each TRP only when the UE reports not only the UE capability for supporting TA for each TRP but also the additional UE capability for supporting the case where the RX timing difference is larger than the CP length.

### <Second Embodiment: UE Capability Report Method for Supporting Scheme of Simultaneously Transmitting Multiple Panels Based on Multiple DCI>

The second embodiment discloses a method by which the UE reports a UE feature required for supporting simultaneous uplink transmission using a multi-DCI-based multi-panel (hereinafter, referred to as mDCI-based STxMP) and a UE capability according thereto.

The UE may transmit a plurality of PUSCHs that overlap in a time domain to multiple TRPs through a plurality of DCI. Further, the plurality of PUSCHs that overlap in the time domain may also overlap in a frequency domain. As described above, in order to transmit the plurality of PUSCHs that overlap in the time domain and/or the frequency domain, the UE may need an additional UE capability.

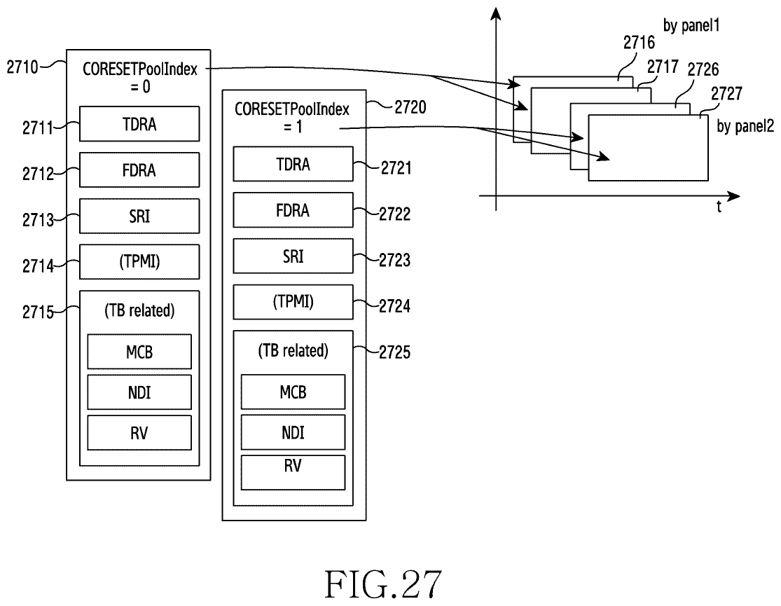

FIG. 27 illustrates an example of scheduling of simultaneous uplink transmission of PDSCHs through respective panels based on multiple DCI according to an embodiment of the disclosure. DCI 2710 received through a CORESET having CORESETPoolIndex of 0 may schedule transmission of PDSCHs 2716 and 2717 through panel 1 to the UE. FIG. 27 illustrates the case where the number of layers of PUSCHs 2716 and 2717 scheduled by the DCI 2710 and transmitted by panel 1 is 2, but case where the number of layers is 2 is only an example and the number of layers is not limited to 2 in various embodiments of the disclosure. For example, the number of layers of PUSCHs 2716 and 2717 scheduled by the DCI 2710 and transmitted by panel 1 may be 1.

DCI 2720 received through a CORESET having CORESETPoolIndex of 1 may schedule transmission of PDSCHs 2726 and 2727 through panel 2 to the UE. FIG. 27 illustrates the case where the number of layers of PUSCHs 2726 and 2727 scheduled by the DCI 2720 and transmitted by panel 2 is 2, but case where the number of layers is 2 is only an example and the number of layers is not limited to 2 in various embodiments of the disclosure. For example, the number of layers of PUSCHs 2726 and 2727 scheduled by the DCI 2720 and transmitted by panel 2 may be 1.

According to an embodiment, the number of layers of each PUSCH scheduled by each DCI 2710 or 2720 may be the same according to implementation and capabilities of the UE. Alternatively, the number of layers of each PUSCH scheduled by each DCI 2710 or 2720 may be different according to implementation and capabilities of the UE. Panel 1 and panel 2 in FIG. 27 are only examples for convenience of detailed description, and uplink transmission may be scheduled by panel 2 (a panel having an ID value larger than that of another panel for panel management of the UE) through the DCI 2710 received by the CORESET having CORESETPoolIndex configured as 0 and uplink transmission may be scheduled by panel 1 (a panel having an ID value smaller than that of another panel for panel management of the UE) through the DCI 2720 received by the CORESET having CORESETPoolIndex configured as 1. The panel ID may not be separately reported to the BS, and the UE may arbitrarily assign and manage an ID from a viewpoint of implementation.

When the UE can support mDCI-based STxMP, the UE may report a UE capability for supporting an mDCI-based STxMP transmission method to the BS, and the BS may configure a higher-layer parameter (RRC parameter) for supporting mDCI-based STxMP transmission in the UE, based on the UE capability reported by the UE. UE features that the UE can support and UE capabilities that UE reports to the BS may include the following content.
UE feature 1) the maximum number of CORESETs that can be configured per BWP for each serving cell (the maximum number of configurable CORESETs including CORESET 0 if CORESET 0 is configured): the corresponding UE feature and the UE report according thereto may be used to be the same as the UE feature for supporting the multi-DCI-based multi-TRP for the downlink and the UE report according thereto. The corresponding feature may be included as one of components reported together with the UE capabilities (for example, multiDCI-STxMP) reported to support mDCI-based STxMP by the UE, and the UE may select one of candidate values (for example, candidate values {2, 3, 4, 5}) for the corresponding components and report the candidate value to the BS.
UE feature 2) the maximum number of CORESETs per CORESETPoolIndex: the corresponding UE feature and the UE report according thereto may be used to be the same as the UE feature for supporting the multi-DCI-based multi-TRP for the downlink and the UE report according thereto. The corresponding feature may be included as one of components reported together with the UE capabilities (for example, multiDCI-STxMP) reported to support mDCI-based STxMP by the UE, and the UE may select one of candidate values (for example, candidate values {1, 2, 3}) for the corresponding components and report the candidate value to the BS.
UE feature 3) support of transmission of PUSCHs fully overlapping in the time domain: the corresponding UE feature may support transmission of PUSCHs that fully overlap in the time domain but do not overlap in the frequency domain. Further, the corresponding UE feature may support transmission of PUSCHs that fully overlap not only in the time domain but also in the frequency domain. For example, when the corresponding UE feature includes information indicating whether transmission of PUSCHs fully overlapping in both the time domain and the frequency domain is supported, “UE feature 6” described below and UE capabilities may be omitted. The corresponding feature may be one of components reported together with the UE capability (for example, multiDCI-STxMP) reported to support mDCI-based STxMP by the UE.
UE feature 4) the maximum number of PUSCHs transmitted per CORESETPoolIndex for each slot: the corresponding UE feature is the maximum number of PUSCHs scheduled by DCI associated with one CORESETPoolIndex that can be processed by the UE within one slot. The corresponding feature may be one of components reported together with the UE capability (for example, multiDCI-STxMP) reported to support mDCI-based STxMP by the UE. At this time, a candidate value that can be reported by the UE capability may be one of {1, 2, 3, 4, 7}.

Alternatively, any natural number between 1 and 7 may be a candidate. Alternatively, any natural number between 1 and 14 may be a candidate. For example, when the UE reports 2 to the BS as the UE report on the UE feature corresponding to 4), this may mean that the corresponding UE can transmit two PUSCHs scheduled by DCI having CORESETPoolIndex of 0 (or CORESETPoolIndex is not configured) or DCI having CORESETPoolIndex of 1 in one slot.
UE feature 5) the maximum number of PUSCHs transmitted for all CORESETPoolIndex per slot: the corresponding UE feature is the maximum number of PUSCHs scheduled by DCI associated with all CORESETPoolIndex that can be processed by the UE within one slot. The corresponding feature may be one of components reported together with the UE capability (for example, multiDCI-STxMP) reported to support mDCI-based STxMP by the UE. At this time, a candidate value that can be reported by the UE capability may be one of {(1), 2, . . . , N}. 1 may not be included in the candidate value. N may be 14 or any natural number.
UE feature 6) support of transmission of PUSCHs fully overlapping in the time domain and the frequency domain: when “UE feature 3” is not the feature for supporting PUSCHs overlapping in the frequency domain, feature 6) may be considered as an additional UE feature and UE capabilities. That is, feature 6) may be a UE feature for supporting the case where a plurality of PUSCHs is transmitted through the completely same RE. At this time, as a prior condition for supporting corresponding “UE feature 6),” “UE feature 3)” may be supported, and FG including UE feature 3) may be configured as a precondition. The UE may report the UE capability for UE feature 6) to the BS through a parameter such as overlapPUSCHsFullyFreqTime (or a parameter for reporting a similar UE capability).
UE feature 7) support of transmission of PUSCHs partially overlapping in the time domain and the frequency domain: the corresponding UE feature is a UE feature for informing whether simultaneous transmission of PUSCHs overlapping in at least one resource element (RE) is possible. When the UE capability associated with this is reported to the BS, the BS may detect that the corresponding UE can simultaneously transmit PUSCHs having partially overlapping resources. At this time, as a prior condition for supporting corresponding “UE feature 7),” “UE feature 6)” may be supported, and FG including UE feature 6) may be configured as a precondition. The UE may report the UE capability for UE feature 7) to the BS through a parameter such as overlapPUSCHsFullyFreqTime (or a parameter for reporting a similar UE capability).
UE feature 8) support of out of order operation of a PUSCH for a PDCCH: before description of the corresponding UE feature, out of order operation is first described. Before the UE completes transmission of PUSCHs scheduled by first received DCI, PUSCHs scheduled by DCI received later may not be first transmitted. However, when out of order operation is supported, the PUSCHs scheduled by the DCI received later may be transmitted by the UE earlier than the PUSCHs scheduled by the DCI received previously. When the UE supports corresponding UE feature 8) and transmits a UE report thereon, PUSCH transmission using mDCI-based STxMP in which out of order operation is possible may be performed. The UE may report the UE capability for UE feature 8) to the BS through a parameter such as outOfOrderOperation (II.forSTxMP (or a parameter for reporting a similar UE capability).
UE feature 9) simultaneous transmission using another type D: the corresponding UE feature indicates whether the UE can support simultaneous uplink transmission through different CAI type-D RSs. That is, it means that, when different RSs are configured as source RSs of CQI type-D, simultaneous uplink transmission can be performed using spatial filters configured for different source RSs. The UE may report the UE capability for UE feature 9) to the BS through a parameter such as simultaneousTransmissionDifflypel) (or a parameter for reporting a similar UE capability).
UE feature 10) support of retransmission of a PUSCH that was scheduled by different CORESETPoolIndex: the corresponding UE feature indicates whether scheduling of retransmission of a PUSCH, which was scheduled by a different CORESETPoolIndex, by DCI associated with different CORESETPoolIndex, rather than DCI associated with CORESETPoolIndex through which the corresponding PUSCH is scheduled is supported. For example, when PUSCH 1 is scheduled by DCI 1 received through a CORESET having CORESETPoolIndex of 0 and PUSCH 2 is scheduled by DCI 2 received through a CORESET having CORESETPoolIndex of 1, the UE may use a UE capability report (for example, supportRetx-Diff-(oresetPool-Multi-DCI-TRP-STxMP) corresponding to UE feature 10) in order to report whether the operation of scheduling retransmission of PUSCH 2 by the DCI received through the CORESET having CORESETPoolIndex of 0 or scheduling retransmission of PUSCH 1 by the DCI received through the CORESET having CORESETPoolIndex of 1 is supported to the BS.
UE feature 11) the maximum number of all layers that can be supported for uplink transmission to the corresponding serving cell when mDCI-based STxMP is supported: the corresponding UE feature is the maximum number of layer that can be transmitted to the corresponding serving cell when mDCI-based STxMP is performed by the UE. This indicates the number of layers that can be supported by the UE only when PUSCHs scheduled by the DCI received through the CORESET having CORESETPoolIndex of 0 (or having no configured value) or having CORESETPoolIndex of 1 are fully or partially (at least one RE) overlap. At this time, the number of layers may be defined as a sum of layers of scheduled PUSCHs that overlap. The UE may use a UE capability report (for example, max TotalMIMO)-LayersForMulti-DCI-mTRP-STxMP) corresponding to UE feature 11) in order to report the maximum number of supportable layers to the BS according to UE feature 11).
UE feature 12) the maximum number of all layers that can be supported for uplink transmission when mDCI-based STxMP is supported: the corresponding UE feature is the maximum number of layer that can be supported for each uplink channel (for example, PUSCH) transmitted for the corresponding serving cell when mDCI-based STxMP is performed by the UE. That is, this indicates the maximum number of layers that can be supported for one PUSCH transmission only when PUSCHs scheduled by the DCI received through the CORESET having CORESETPoolIndex of 0 (or having no configured value) or having CORESETPoolIndex of 1 are fully or partially (at least one RE) overlap. The UE may use a UE capability report (for example, maxMIMO-LayersForMulti-DCI-mTRP-STxMP) corresponding to UE feature 12) in order to report the number of supportable layers per PUSCH to the BS according to UE feature 12). When the corresponding UE capability report (for example, maxMIMO)-LayersForMulti-DCI-mTRP-STxMP) is transmitted, the UE may insert a component for reporting the number of PUSCHs that overlap in the same resources and can be simultaneously transmitted and a component for reporting the maximum number of supportable layers for each PUSCH into the FG and report them together.
UE feature 13) support of the different numbers of layers for respective PUSCHs when PUSCHs are simultaneously transmitted: the corresponding feature indicates whether the case where the numbers of layers of scheduled PUSCHs are different is supported when mDCI-based STxMP is supported. That is, when the UE supports corresponding feature 13) and transmits the corresponding UE report, PUSCHs having the different numbers of layers may be scheduled by DCI received through CORESETs associated with respective CORESETPoolIndex.
UE feature 14) support of one or more SRS resource sets of which the usage is “codebook” or “nonCodebook” to support mDCI-based STxMP: the corresponding UE feature indicates whether the UE supports one or more SRS resource sets of which the usage is “codebook” or “nonCodebook.” In a detailed example, when corresponding UE feature 14) is supported and a maximum of 2 SRS resource sets (of which the usage is “codebook” or “nonCodebook”) is supported, each SRS resource set may be associated with transmission of a PUSCH scheduled by each CORESETPoolIndex. The UE capability report for UE feature 14) may be transmitted through the FG for a separate UE capability report or may be one of components reported together with the UE capability (for example, multiDCI-STxMP) reported to support mDCI-based STxMP by the UE.
UE feature 15) support of the different numbers of SRS resources for SRS resource sets of which the usage is “codebook” or “nonCodebook”: the corresponding UE feature indicates whether the UE supporting UE feature 14 supports the case where the numbers of SRS resources included in respective SRS resource sets are different. For codebook-based PUSCH transmission or noncodebook-based PUSCH transmission, the UE report according to one feature may be transmitted or respective UE reports according to different UE features may be transmitted according to respective transmission types. For example, UE feature 15-1) may indicate that the different numbers of SRS resources can be supported for the SRS resource set of which the usage is “codebook,” and UE feature 15-2) may indicate that the different numbers of SRS resources can be supported for the SRS resource set of which the usage is “nonCodebook.” Alternatively, one value may be selected to indicate whether the corresponding component can be supported in the case where the usage of the SRS resource set is “codebook,” “nonCodebook,” or both thereof like {CB, NCB, both} as the candidate value for the component of the corresponding FG, and the UE capability may be reported to the BS.
UE feature 16) support of the different maximum numbers of SRS ports for SRS resources included in respective SRS resource sets of which the usage is “codebook” to support mDCI-based STxMP: the corresponding UE feature assumes the case where UE feature 14) is supported. The corresponding UE feature is a feature indicating that the maximum number of SRS ports in SRS resources included in the SRS resource set (of which the usage is “codebook) associated with a CORESET having CORESETPoolIndex of 0 may be different from the maximum number of SRS ports in SRS resources included in the SRS resource set (of which the usage is “codebook) associated with a CORESET having CORESETPoolIndex of 1. When the UE support the corresponding UE feature and the UE report therefor, the UE may receive a configuration of a plurality of (two) SRS resource sets of which the usage is “codebook” having the different maximum number of SRS ports from the BS and may support mDCI-based STxMP according thereto. The UE may use a UE capability report (for example, support-diffSRSports-STxMP) corresponding to UE feature 16 in order to report, to the BS, that the different maximum number of SRS ports can be supported for respective SRS resource sets according to feature 16, and may report the maximum number of SRS ports that can be supported by the UE for each SRS resource set through the UE capability report.
UE feature 17) a full power mode supported for an SRS resource set associated with each CORESETPoolIndex in codebook-based PUSCH transmission: the corresponding UE feature may indicate the full power mode that can support each PUSCH transmitted through an SRS resource set associated with each CORESETPoolIndex. At this time, sub features which can be included may indicate whether full power modes that can be supported for a plurality of SRS resource sets (for example, two SRS resource sets) may be the same or may be different. For example, when a plurality of SRS resource sets is supported through the same full power mode, SRS resources within the SRS resource sets configured according to the full power mode may be configured to support the same full power mode. For example, it is allowed for a plurality of SRS resource sets to support full power modes, the corresponding higher-layer parameter may be configured without restrictions on SRS resource sets and SRS resource configurations to support the same full power mode. The UE may use a UE capability report (for example, support-difffullPwrMode-STxMP) corresponding to UE feature 17) in order to report, to the BS, that different full power modes are supported for respective SRS resource sets according to UE feature 17), and may report each of the full power modes that can be supported by the UE for respective SRS resource sets through the UE capability report.
UE feature 18) support of UCI multiplexing for each CORESETPoolIndex when mDCI-based STxMP is supported: for example, when a PUCCH for transmitting UCI overlaps a plurality of PUSCHs supporting mDCI-based STxMP, corresponding UE feature 18) may be used when the UE report, to the BS, whether UCI included in a PUCCH can be multiplexed to a PUSCH associated with the same CORESETPoolIndex or whether UCI included in a PUCCH can be multiplexed to a random PUSCH (in spite of a PUSCH that is not the PUSCH associated with the same CORESETPoolIndex) through comparison between the CORESETPoolIndex associated with the PUCCH and the CORESETPoolIndex associated with the PUSCH.

### Third Embodiment: Method of Operating Multiple TRPs Based on Plurality of TAs and Reporting UE Capability in Consideration of Scheme of Simultaneously Transmitting Multiple Panels

The third embodiment describes a detailed method by which, when the UE supports a multi-TRP transmission and reception scheme based on a plurality of TAs in a multi-DCI-based system and/or supports a multi-panel-based simultaneous uplink transmission scheme in a multi-DCI-based system, the UE reports an additional UE capability for the supported scheme to the BS.

As described in the first embodiment, when the multi-TRP transmission and reception scheme based on the plurality of TAs is supported, the UE may need to perform parallel processing in order to receive a downlink signal according to the order relation between the size of the Rx timing difference according to DL reference timing of each TRP and any value (for example, the CP length according to SCS of the activated BWP of the corresponding serving cell). Similarly, as described in the second embodiment, when multi-panel-based simultaneous uplink transmission based on multiple DCI is supported, the UE may need to individually prepare PUSCHs to transmit PUSCHs scheduled through DCI received from respective TRPs to respective panels and need to perform parallel processing to be transmitted. That is, the UE may need to support parallel processing for downlink signal reception according to Rx timing difference when the multi-TRP transmission and reception scheme is supported based on a plurality of TAs and/or parallel processing for transmitting a PUSCH transmitted to each panel when the multi-panel-based simultaneous uplink transmission scheme is supported. For example, parallel processing may include at least one of parallel baseband processing for receiving a downlink signal in a digital area or parallel baseband processing for transmitting an uplink signal in a digital area. For example, parallel processing may include at least one of parallel RF processing for receiving a downlink signal in a radio frequency (RF) area and parallel RF processing for transmitting an uplink signal in an RF area.

In the disclosure, it is assumed that parallel processing for receiving a downlink signal that may be additionally required when the multi-TRP transmission and reception scheme is supported based on a plurality of TAs includes all of the parallel baseband processing for receiving the downlink signal in the digital area and the parallel RF processing for receiving the downlink signal. Further, in the disclosure, it is assumed that parallel processing for transmitting an uplink signal that may be additionally required when the multi-panel-based simultaneous uplink transmission scheme is supported includes the parallel baseband processing for transmitting the uplink signal in the digital area and the parallel RF processing for transmitting the uplink signal in the RF area. This is the assumption for convenience of description, and the UE may be configured to need only a portion of the parallel baseband processing or the parallel RF processing in order to perform parallel processing for downlink reception or uplink transmission.

For example, when a parallel baseband processor and a parallel RF processor are required to perform parallel processing, the UE may need an additional implementation method for individually performing the parallel processing. For example, an individual discrete Fourier transform (DFT) performance module and an encoding/decoding processor for parallel processing may be required. Alternatively, a low noise amplifier (LNA)/power amplifier (PA)/filter may be required to process an uplink/downlink signal transmitted/received to/from each TRP. That is, due to additional UE implementation to support parallel processing for downlink signal reception according to Rx timing difference when the multi-TRP transmission and reception scheme is supported based on a plurality of TAs and/or parallel processing for transmitting a PUSCH transmitted to each panel when the multi-panel-based simultaneous uplink transmission scheme is supported, UE implementation complexity may increase. Implementation difficulty may increase due to the increased UE implantation complexity, and a UE cost supporting the corresponding function may increase. In order to prevent the UE implementation difficulty and/or the UE cost from increasing, the UE may be implemented to use a parallel processing capability for supporting the multi-TRP transmission and reception scheme based on a plurality of TAs and/or the multi-panel-based simultaneous uplink transmission scheme by sharing the UE capability that requires the existing parallel processing. As a method that requires the exiting parallel processing to share the UE capability that requires parallel processing, carrier aggregation (CA) and dual connectivity (DC) may be considered. That is, some UE capabilities for supporting CA or DC may be used to support the multi-TRP transmission and reception scheme based on a plurality of TAs and/or the multi-panel-based simultaneous uplink transmission scheme.

In embodiment 3-1, a method by which the UE reports a UE capability for supporting the multi-TRP transmission and reception scheme based on a plurality of TAs in consideration of a UE capability for a downlink CA operation is described. In embodiment 3-2, a method by which the UE separately defines the UE capability for supporting the multi-TRP transmission and reception scheme based on a plurality of TAs and the UE capability for the downlink CA operation and reporting the UE capabilities to the BS is described. In embodiment 3-3, a method by which the UE reports a UE capability for supporting the multi-panel-based simultaneous uplink transmission scheme in consideration of a UE capability for an uplink CA operation is described. In embodiment 3-4, a method by which the UE separately defines the UE capability for supporting the multi-panel-based simultaneous uplink transmission scheme and the UE capability for the uplink CA operation and reports the UE capabilities to the BS is described.

### Embodiment 3-1: Method of Reporting UE Capability for Supporting Multi-TRP Transmission and Reception Scheme Based on Plurality of TAs in Consideration of UE Capability for CA Operation

In embodiment 3-1, a detailed method by which the UE reports a UE capability for supporting the multi-TRP transmission and reception scheme based on a plurality of TAs to the BS in consideration of a UE capability for a CA operation is described. For convenience of description, it is assumed that the UE capability for the CA operation is the UE capability for the downlink CA operation.

When the parallel process is needed to support the multi-TRP transmission and reception scheme based on a plurality of TAs (for example, when Rx timing difference is larger than a specific value (for example, the CP length for corresponding downlink reception)), the parallel process for supporting the multi-TRP transmission and reception scheme based on a plurality of TAs may be used by sharing some of the UE capabilities for the downlink CA operation in consideration of the UE implementation complexity and the UE cost as described above. That is, the UE capabilities for parallel processing may be shared and supported to make a sum of the UE capability for the downlink CA operation that is partially shared and the UE capability for supporting the multi-TRP transmission and reception scheme based on a plurality of TAs match the total UE capability for the downlink CA operation supported when the multi-TRP transmission and reception scheme based on a plurality of TAs is not supported by the corresponding UE. [Equation 11] below defines an equation related to downlink carriers which the UE can support when at least some of the UE capabilities for the downlink CA operation are shared and used to support the multi-TRP reception scheme based on a plurality of TAs.

$${N}_{DLtot} = {N}_{DLCA} + ( K - 1 ) \cdot {N}_{DL , 2 TA} . \qquad [ Equation 11 ]$$

In [Equation 11], N_{DLtot} is the maximum number of downlink carriers which the UE can support, which may be the maximum number of parallel processes which the UE can implicitly support to receive downlink signals. Alternatively, N_{DLtot} may be the number of downlink carriers which the UE can support when an additional parallel process is not required since Rx timing difference between all downlink carrier(s) that do not support the multi-TRP transmission and reception scheme based on a plurality of K TAs (for example, K=2 TAs) or supports the multi-TRP transmission and reception scheme based on a plurality of TAs (for example, K=2 TAs) is smaller than any value.

N_{DL,2TA} is the number of downlink carriers between which Rx timing difference is larger than a specific value among the downlink carriers supporting the multi-TRP transmission and reception scheme based on a plurality of TAs (for example, K=2 TAs). That is, it may mean the number ((K−1)·N_{DL2TA}) of parallel processes additionally required for receiving downlink signals for N_{DL,2TA} downlink carrier(s) between which Rx timing difference is larger than the specific value.

NDLCA is the number of downlink carrier supported by the UE when there are downlink carriers that support the multi-TRP transmission and reception scheme based on a plurality of TAs (for example, K=2 TAs) and require the additional parallel process due to Rx timing difference larger than the specific value.

As described above, when the UE capability for the downlink CA operation and the UE capability for supporting the multi-TRP transmission and reception scheme based on a plurality of TAs that requires the additional parallel process are shared by the corresponding UE, the UE features and the UE feature groups (FGs) may be defined as shown in [Table 77] below, and the UE may report UE capabilities to the BS according to the defined UE features and UE FGs.

TABLE 77

| | | | | Field | Parent | Need of | Need of | | |
|---|---|---|---|---|---|---|---|---|---|
| | | | Prerequisite | name in | IE in | FDD/TDD | FR1/FR2 | | |
| | Feature | | feature | TS | TS | differen- | differen- | | Mandatory/ |
| Index | group | Components | groups | 38.331 | 38.331 | tiation | tiation | Note | Optional |
| x-y | Two | 1) Support two | (16- | mTRP- | FeatureSetDown- | n/a | n/a | 2) Rx timing | Optional |
| | TAs for | TAGs for mDCI | 2a) | twoTimingAdvance | linkPerCC-v18xx | | | difference | with |
| | multi- | based mTRP | | | | | | between two | capability |
| | DCI | 2) Support two | | | | | | DL reference | signalling |
| | based | DL reference | | | | | | timings is | |
| | multi- | timing | | | | | | within a CP | |
| | TRP | | | | | | | | |
| x- | Larger | Support larger | x-y | support | FeatureSetDown- | n/a | n/a | Note: DL CC | Optional |
| ya | Rx | Rx timing | | LagerRx | linkPerCC-v18xx | | | for this FG is | with |
| | timing | difference | | TimingDifference- | | | | counded as | capability |
| | difference | between two | | CP | | | | two DL CCs | signalling |
| | than | DL reference | | | | | | on the | |
| | a CP | timings than a | | | | | | support of DL | |
| | | CP | | | | | | CA band | |
| | | | | | | | | combination(s). | |

In [Table 77], for example, an FG having an index of x-y may be referred to as an “FG x-y.” A UE FG x-y indicates a UE FG for supporting a multi-TRP transmission and reception scheme based on multiple DCI and a plurality of TAs. The FG x-y may include a basic feature for supporting the multi-TRP transmission and reception scheme based on multiple DCI and a plurality of TAs that can be identified “Components.” As defined in a second component of the UE FG x-y, the UE needs to support two different DL reference timing, and Rx timing difference between the two DL reference timing may not be larger than the length of a CP for the corresponding CC due to a characteristic of the second component define din “Note.” When the UE can support the corresponding UE FG x-y, the UE may perform a UE capability report on the corresponding FG to the BS. At this time, the UE may report the UE capability to the BS by using a higher-layer parameter (for example, a higher-layer parameter having a name for transmitting “mTRP-twoTimingAdvance” specified in Field name in TS 38.331 for the corresponding FG x-y in [Table 77] or the same or similar UE capability report. In order to support the corresponding UE FG x-y, the UE may need to support a specific FG (for example, UE FG 16-2a) that may be supported based on a precondition.

When the UE can support the multi-TRP transmission and reception scheme based on multiple DCI and a plurality of TAs having Rx timing difference larger than the CP length, the UE may transmit a UE capability report for a UE FG x-ya. At this time, the UE may report the UE capability to the BS by using a higher-layer parameter (for example, a higher-layer parameter having a name for transmitting “supportLagerRxTimingDifference-CP” specified in Field name in TS 38.331 for the corresponding FG x-ya in [Table 77] or the same or similar UE capability report. In order to support the corresponding UE FG x-ya, the UE may need to support the UE FG x-y, based on a precondition. When the UE can support the UE FG x-ya and reports the UE capability for the corresponding UE FG to the BS, it may influence the UE capability for supporting downlink CA and the number of downlink carrier components (DL CCs) that can be supported in consideration thereof as specified in “Note” for the corresponding FG x-ya in [Table 77]. For example, when the UE counts carrier components supporting the corresponding UE FG x-ya and the UE reports a band combination considering the corresponding CC to the BS, the UE may count carrier components (CCs) supporting the corresponding UE FG x-ya (or UE feature within the UE FG x-ya) as 2 (or K), configure a band combination such that the number of DL CCs counted for the DL CCs that can be supported by the UE is not larger than the maximum number of supportable DL CCs, and report the band combination to the BS.

For example, when the maximum number of DL CCs that can be supported by the UE is 16 (N_{DL,tot}=16) and the UE FG x-ya can be supported only for one CC(N_{DL,tTA}=1), the UE may report a band combination including 15 DL CCs (N_{DLCA}=15 or N_{DL,CA}=16−1·(K−1) including CCs that can support the corresponding UE FG x-ya to the BS. Alternatively, the UE may not count the CCs supporting the corresponding UE FG x-ya as 2 (or K) and may report a band combination including the corresponding CCs to the BS. At this time, the BS may count the corresponding CCs as 2 (or K) and configure a CA band combination including DL CCs determined not to exceed the maximum number of DL CCs which can be supported by the UE in the UE. When counting the DL CCs for the CA band combination configured by the BS, the UE may not expect that the number of DL CCs does not exceed the maximum number of DL CCs which the UE can support.

[Table 77] is only one example and may be defined as another name UE FG that performs the same (or similar) function. Further, the UE FG x-ya in [Table 77] may be defined as another component within the UE FG x-y rather than defined as a separate FG. At this time, the UE may configure a value of the component that performs an indication that is the same as the corresponding UE FG x-ya as a value such as “support” (or “yes”) or “not support” (or “no”) and report the value to the BS.

Although only the UE capability for the downlink CA operation has been considered to describe the detailed operation presented in embodiment 3-1, the UE capability for the uplink CA operation may be additionally considered in addition to the UE capability for the downlink CA operation if it is assumed that parallel processing is required to apply a plurality of TAs to respective uplink transmission timing. At this time, by replacing an index “DL” for indicating the downlink in [Table 11] with an index “UL” for indicating the uplink, the equation related to uplink carriers which the UE can support may be defined when some of the UE capabilities for the uplink CA operations are shared and used to support a parallel process for supporting a multi-TRP transmission scheme based on a plurality of & TAs as shown in [Equation 12] below.

$${N}_{ULtot} = {N}_{ULCA} + ( K - 1 ) \cdot {N}_{UL , 2 TA} . \qquad [ Equation 12 ]$$

### Embodiment 3-2: Method of Reporting UE Capability for Supporting Multi-TRP Transmission and Reception Scheme Based on Plurality of TAs Defined Separately from UE Capability for CA Operation

In embodiment 3-2, a detailed method of reporting a UE capability for supporting a multi-TRP transmission and reception scheme based on a plurality of TAs by the UE separately from a UE capability for a CA operation to the BS is described. For convenience of description, it is assumed that the UE capability for the CA operation is the UE capability for the downlink CA operation.

In embodiment 3-1, the UE capability for supporting DL CA and a multi-TRP transmission and reception scheme based on a plurality of TAs according to the UE capability for supporting the limited parallel process in consideration of the UE implementation complexity and the UE cost and the reporting method have been described. However, the UE capable of supporting a further improved function may additionally support a UE capability for supporting a multi-TRP transmission and reception scheme based on a plurality of TAs for the case where a parallel is further required in addition to the UE capability for DL CA that can be previously supported (for example, when Rx timing difference is larger than any value (CP length)).

As described above, when the UE capability for the downlink CA operation is not shared and the UE can support a separate parallel process for supporting the multi-TRP reception scheme based on a plurality of TAs, the UE features and the UE feature groups (FGs) may be defined as shown in [Table 78] below and the UE may report UE capabilities to the BS according to the defined UE features and UE FGs.

TABLE 78

| | | | | Field | Parent | Need of | Need of | | |
|---|---|---|---|---|---|---|---|---|---|
| | | | Prerequisite | name in | IE in | FDD/TDD | FR1/FR2 | | |
| | Feature | | feature | TS | TS | differen- | differen- | | Mandatory/ |
| Index | group | Components | groups | 38.331 | 38.331 | tiation | tiation | Note | Optional |
| x-y | Two | 1) Support two | (16- | mTRP- | FeatureSetDown- | n/a | n/a | 2) Rx timing | Optional |
| | TAs for | TAGs for mDCI | 2a) | twoTimingAdvance | linkPerCC-v18xx | | | difference | with |
| | multi- | based mTRP | | | | | | between two | capability |
| | DCI | 2) Support two | | | | | | DL reference | signalling |
| | based | DL reference | | | | | | timings is | |
| | multi- | timing | | | | | | within a CP | |
| | TRP | | | | | | | | |
| x- | Larger | 1) Support | x-y | support | FeatureSetDown- | n/a | n/a | Note: DL CC | Optional |
| ya | Rx | larger Rx timing | | LagerRx | linkPerCC-v18xx | | | for this FG is | with |
| | timing | difference | | TimingDifference- | | | | counded as a | capability |
| | difference | between two | | CP | | | | DL CC on the | signalling |
| | than | DL reference | | | | | | support of DL | |
| | a CP | timings than a | | | | | | CA band | |
| | | CP | | | | | | combination(s). | |
| | | 2) Support | | | | | | (or there is no | |
| | | additional | | | | | | note) | |
| | | parallel | | | | | | | |
| | | processing for | | | | | | | |
| | | DL reception | | | | | | | |

The UE FG x-y in [Table 78] may be defined to be the same as the UE FG x-y in [Table 77]. Similarly, when the UE can support the corresponding UE FG x-y in [Table 78], the UE may transmit a UE capability report on the corresponding FG to the BS. At this time, the UE may report the UE capability to the BS by using a higher-layer parameter (for example, a higher-layer parameter having a name for transmitting “mTRP-twoTimingAdvance” specified in Field name in TS 38.331 for the corresponding FG x-y in [Table 78] or the same or similar UE capability report. In order to support the corresponding UE FG x-y, the UE may need to support any FG (for example, UE FG 16-2a) that may be supported based on a precondition.

When the UE can support the multi-TRP transmission and reception scheme based on multiple DCI and a plurality of TAs having Rx timing difference larger than the CP length, based on the UE capability for supporting DL CAN and a separate UE capability, the UE may transmit a UE capability report for a UE FGx-ya. At this time, the UE may report the UE capability to the BS by using a higher-layer parameter (for example, a higher-layer parameter having a name for transmitting “supportLagerRxTimingDifference-CP” specified in Field name in TS 38.331 for the corresponding FG x-ya in [Table 78] or the same or similar UE capability report. In order to support the corresponding UE FG x-ya, the UE may need to support the UE FG x-y, based on a precondition. At this time, when the UE can support the UE FG x-ya in [Table 78] unlike the UE FG x-ya in [Table 77], it does not influence the UE capability for supporting downlink CA and the number of supportable downlink carrier components (DL CCs), and the UE may report that an additional parallel process for supporting the multi-TRP transmission and reception based on a plurality of TAs can be supported to the BS. That is, when the UE counts carrier components supporting the corresponding UE FG x-ya and the UE reports a band combination considering the corresponding CC to the BS, the UE may count the number of carrier components (CCs) supporting the corresponding UE FG x-ya (or UE feature within the UE FG x-ya) as 1 and report a band combination including the maximum number of DL CCs (or smaller number of DL CCs) which can be supported by the UE to the BS. For example, when the maximum number of DL CCs that can be supported by the UE is 16 (N_{DL,tot}=10) and the UE FG x-ya can be supported only for one CC (N_{DL2TA}=1), the UE may report a band combination including 16 DL CCs (N_{DL,CA}=16) including CCs that can support the corresponding UE FG x-ya to the BS and may support an additional parallel process for the CCs supporting the UE FG x-ya.

[Table 78] is one example and may be defined as another name UE FG that performs the same (or similar) function. Further, the UE FG x-ya in [Table 78] may not be defined as a separate FG but may be defined as another component within the UE FG x-y as shown in [Table 79].

TABLE 79

| | | | | Field | Parent | Need of | Need of | | |
|---|---|---|---|---|---|---|---|---|---|
| | | | Prerequisite | name in | IE in | FDD/TDD | FR1/FR2 | | |
| | Feature | | feature | TS | TS | differen- | differen- | | Mandatory/ |
| Index | group | Components | groups | 38.331 | 38.331 | tiation | tiation | Note | Optional |
| x-y | Two | 1) Support two | (16- | mTRP- | FeatureSetDown- | n/a | n/a | 2) Rx timing | Optional |
| | TAs for | TAGs for mDCI | 2a) | twoTimingAdvance | linkPerCC-v18xx | | | difference | with |
| | multi- | based mTRP | | | | | | between two | capability |
| | DCI | 2) Support two | | | | | | DL reference | signalling |
| | based | DL reference | | | | | | timings is | |
| | multi- | timing | | | | | | within a CP | |
| | TRP | 3) Support | | | | | | 3) candidate | |
| | | parallel | | | | | | value: {0, 1, | |
| | | processing for | | | | | | 2} | |
| | | DL reception | | | | | | Note: if | |
| | | | | | | | | candidate | |
| | | | | | | | | value of | |
| | | | | | | | | component 3 | |
| | | | | | | | | equal to 0. | |
| | | | | | | | | this means | |
| | | | | | | | | the UE | |
| | | | | | | | | cannot | |
| | | | | | | | | support | |
| | | | | | | | | larger Rx | |
| | | | | | | | | timing | |
| | | | | | | | | difference | |
| | | | | | | | | between two | |
| | | | | | | | | DL reference | |
| | | | | | | | | timings than | |
| | | | | | | | | a CP | |

As shown in [Table 79], the UE FG x-y may include component 3. For example, when the UE configures a value of component 3 of the UE FG x-y as 0 and report the value to the BS, it means that the UE cannot support the multi-TRP transmission and reception scheme based on multiple DCI and a plurality of TAs having Rx timing difference larger than any value (for example, CP length). For example, when the UE configures a value of component 3 of the UE FG x-y as 1 and report the value to the BS, it means that the UE can support the multi-TRP transmission and reception scheme based on multiple DCI and a plurality of TAs having Rx timing difference larger than any value (for example, CP length) and receive a downlink signal, based on two DL reference timing without any additional parallel process. For example, when the UE configures a value of component 3 of the UE FG x-y as 2 and report the value to the BS, it means that the UE can support the multi-TRP transmission and reception scheme based on multiple DCI and a plurality of TAs having Rx timing difference larger than any value (for example, CP length), based on an additional parallel process.

Alternatively, component 3 in [Table 79] may be defined as “Support additional parallel processing for DL reception,” and the UE may configure one of {0, 1} as a candidate value for component 3 and report a UE capability to the BS. When the candidate value for component 3 is configured as “0,” it may mean that the UE cannot support the multi-TRP transmission and reception scheme based on multiple DCI and a plurality of TAs having Rx timing difference larger than any value (for example, CP length). Alternatively, it may mean that the UE can support the multi-TRP transmission and reception scheme based on multiple DCI and a plurality of TAs having Rx timing difference larger than any value (for example, CP length) and receive a downlink signal, based on two DL reference timing without any additional parallel process. The same candidate value may have different meanings, but may be predefined between the BS and the UE to perform only one operation according to a determined rule. For example, when a candidate value for component 3 is configured as “1,” it may mean that the UE can support the multi-TRP transmission and reception scheme based on multiple DCI and a plurality of TAs having Rx timing difference larger than any value (for example, CP length), based on an additional parallel process.

In the above embodiment, it is assumed that K=2, but the candidate values may be defined based on the assumption that K is an integer larger than 2.

The UE FG defined in embodiment 3-1 and the UE FG defined in embodiment 3-2 are defined and described as separate UE FGs. However, this is only for convenience of description, and the UE may report UE capability for one or both of the UE FG defined in embodiment 3-1 and the UE FG defined in embodiment 3-2 to the BS in consideration of both the two UE FGs. At this time, higher-layer parameters for the UE capabilities for the UE FG defined in embodiment 3-1 and the UE FG defined in embodiment 3-2 may have different names.

### Embodiment 3-3: Method of Reporting UE Capability for Multi-DCI Multi-Panel-Based Simultaneous Uplink Transmission Scheme in Consideration of UE Capability for Uplink CA Operation

In embodiment 3-3, a detailed method by which the UE reports UE capabilities for supporting a multi-DCI multi-panel-based simultaneous uplink transmission scheme to the BS in consideration of the UE capability for the uplink CA operation is described.

The UE needs a parallel process to simultaneously transmit uplink signals through multiple panels in a multi-DCI system. Therethrough, the UE may receive scheduling of respective PUSCHs from respective TRPs, and a separate process is required to prepare and perform respective PUSCH transmission. Particularly, when a plurality of (for example, two) PUSCHs scheduled from respective TRPs overlap in the time domain, a plurality of (for example, two) parallel processes may be needed to perform multi-panel-based simultaneous transmission.

As described above, the parallel process for performing multi-DCI multi-panel-based simultaneous uplink transmission may be used by sharing some of the UE capabilities for the uplink CA operation in consideration of the UE implementation complexity and the UE cost. That is, the UE capabilities for parallel processing may be shared and supported to make a sum of the UE capability for the uplink CA operation that is partially shared and the UE capability for supporting the multi-DCI multi-panel-based simultaneous uplink transmission scheme match the UE capability for the total uplink CA operation supported when the multi-DCI multi-panel-based simultaneous uplink transmission scheme is not supported by the corresponding UE. [Equation 13] below defines an equation related to uplink carriers which the UE can support when some of the UE capabilities for the uplink CA operation are shared and used to support the multi-DCI multi-panel-based simultaneous uplink transmission scheme.

$${N}_{UL , tot} = {N}_{UL , CA} + ( K - 1 ) \cdot {N}_{ULSTxMP} . \qquad [ Equation 13 ]$$

In [Equation 13], N_{UT,tot} is the maximum number of uplink carriers which the UE can support, which may be the maximum number of parallel processes which the UE can implicitly support to transmit uplink signals. Alternatively, N_{UL,tot} may be the number of uplink carriers which the UE can support when the multi-DCI multi-panel-based simultaneous uplink transmission scheme is not supported. N_{UL,STxMP} is the number of uplink carriers supporting the multi-DCI multi-panel-based simultaneous uplink transmission scheme. That is, it may mean the number (K−1)·N_{UL,STxMP}) of parallel processes additionally required to simultaneously transmit uplink signals for N_{ULSTxMP} uplink carrier(s). K (K being a positive integer larger than or equal to 2) is the number of uplink signals which the UE can simultaneously transmit, and (K−1)·N_{ULSTxMP} parallel processes may be additionally needed. N_{ULCA} is the number of uplink carriers supported by the UE when there are uplink carriers supporting the multi-DCI multi-panel-based simultaneous uplink transmission scheme.

As described above, when the UE capability for the uplink CA operation and the UE capability for supporting the multi-DCI multi-panel-based simultaneous uplink transmission scheme that requires an additional parallel process are shared by the corresponding UE, UE features and UE feature groups (FGs) may be defined as shown in [Table 80] below, and the UE may report UE capabilities to the BS according to the defined UE features and UE FGs.

TABLE 80

| | | | | Field | Parent | Need of | Need of | | |
|---|---|---|---|---|---|---|---|---|---|
| | | | Prerequisite | name in | IE in | FDD/TDD | FR1/FR2 | | |
| | Feature | | feature | TS | TS | differen- | differen- | | Mandatory/ |
| Index | group | Components | groups | 38.331 | 38.331 | tiation | tiation | Note | Optional |
| x-y | UL | 1) Support | (16- | UI_mTRP_simulta- | FeatureSetUp- | n/a | n/a | Note: UL CC | Optional |
| | simultaneous | multi-DCI | 2a) | neous | linkPerCC-v18xx | | | for this FG is | with |
| | transmission | based UL | | Tx-r18 | | | | counded as | capability |
| | in | simultaneous | | | | | | two UL CCs | signalling |
| | the | transmission | | | | | | on the | |
| | same | 2) Support | | | | | | support of UL | |
| | carrier | parallel | | | | | | CA band | |
| | | processing for | | | | | | combination(s). | |
| | | UL | | | | | | | |
| | | transmission | | | | | | | |

In [Table 80], the UE FG x-y indicates a UE FG for supporting the multi-DCI multi-panel-based simultaneous uplink transmission scheme. The corresponding FG may include a basic feature for supporting the multi-DCI multi-panel-based simultaneous uplink transmission scheme that can be identified “Components.” As defined in a second component of the UE FG x-y, the UE may support a parallel process for uplink transmission, which may influence the UE capability for supporting uplink CA and the number of uplink carrier components (UL CCs) that can be supported in consideration thereof as specified in “Note.” That is, when the UE counts carrier components (CCs) supporting the corresponding UE FG x-y and the UE reports a band combination considering the corresponding CCs to the BS, the UE may count carrier components (CCs) supporting the corresponding UE FG x-y as 2 (or K), configure a band combination such that the number of UL CCs counted for the UL CCs that can be supported by the UE is not larger than the maximum number of supportable UL CCs, and report the band combination to the BS.

For example, when the maximum number of UL CCs that can be supported by the UE is 16 (N_{UL,tot}=16) and the UE FG x-y can be supported only for two CCs (N_{ULSTxMP}=2), the UE may report a band combination including 14 UL CCs (N_{UL,CA}=14 or N_{UL,CA}=16−2·(K−1) including CCs that can support the corresponding UE FG x-y to the BS. Alternatively, the UE may not count the CCs supporting the corresponding UE FG x-y as 2 (or K) and may report a band combination including the corresponding CCs to the BS. At this time, the BS may count the corresponding CCs as 2 (or K) and configure a CA band combination including UL CCs determined not to exceed the maximum number of UL CCs which can be supported by the UE in the UE. When counting the UL CCs for the CA band combination configured by the BS, the UE may not expect that the number of UL CCs exceed the maximum number of UL CCs which the UE can support. When the UE can support the corresponding UE FG x-y, the UE may perform a UE capability report on the corresponding FG to the BS. At this time, the UE may report the UE capability to the BS by using a higher-layer parameter (for example, a higher-layer parameter having a name for transmitting “Ul_mTRP_simultaneousTx-r18” specified in Field name in TS 38.331 for the corresponding FG x-y in [Table 80] or the same or similar UE capability report. In order to support the corresponding UE FG x-y, the UE may need to support any FG (for example, UE FG 16-2a) that may be supported based on a precondition.

[Table 80] is only one example and may be defined as another name UE FG that performs the same (or similar) function.

### Embodiment 3-4: Method of Reporting UE Capability for Multi-DCI Multi-Panel-Based Simultaneous Uplink Transmission Scheme Defined Separately from UE Capability for Uplink CA Operation

In embodiment 3-4, a detailed method of reporting a UE capability for supporting a multi-DCI multi-panel-based simultaneous uplink transmission scheme to the BS separately from a UE capability for an uplink CA operation is described.

In embodiment 3-3, the UE capability for supporting UL CA and the multi-DCI multi-panel-based simultaneous uplink transmission scheme, based on a UE capability for supporting a limited parallel process in consideration of the UE implementation complexity and the UE cost and the reporting method have been described. However, the UE which can support a further improved function may additionally support the UE capability for supporting the multi-DCI multi-panel-based simultaneous uplink transmission scheme that further requires a parallel process in addition to the UE capability for UL CA which can be previously supported by the UE.

As described above, a separate parallel process for supporting the multi-DCI multi-panel-based simultaneous uplink transmission scheme can be supported by the UE without sharing of the UE capability for the uplink CA operation, UE features and UE feature groups (FGs) may be defined as shown in [Table 81] below, and the UE may report UE capabilities to the BS according to the defined UE features and UE FGs.

TABLE 81

| | | | Prereq- | Field | Parent | Need of | Need of | | |
|---|---|---|---|---|---|---|---|---|---|
| | | | uisite | name in | IE in | FDD/TDD | FR1/FR2 | | |
| | Feature | | feature | TS | TS | differen- | differen- | | Mandatory/ |
| Index | group | Components | groups | 38.331 | 38.331 | tiation | tiation | Note | Optional |
| x-y | UL | 1) Support | (16- | UI_mTRP_simulta- | FeatureSetUp- | n/a | n/a | Note: UL CC | Optional |
| | simultaneous | multi-DCI | 2a) | neousTx-r18 | linkPerCC- | | | for this FG is | with |
| | transmission | based UL | | | v18xx | | | counded as | capability |
| | in the | simultaneous | | | | | | two UL CCs | signalling |
| | same | transmission | | | | | | on the | |
| | carrier | 2) Support | | | | | | support of UL | |
| | | parallel | | | | | | CA band | |
| | | processing for | | | | | | combination(s). | |
| | | UL | | | | | | | |
| | | transmission | | | | | | | |
| x- | Additional | 1) Support | x-y | UI_additionaPar- | FeatureSetUP- | n/a | n/a | Note: If this | Optional |
| ya | UL | additional | | allelProcess_{—} | linkPerCC- | | | FG is | with |
| | parallel | parallel | | STxMP-r18 | v18xx | | | supported. | capability |
| | processing | processing for | | | | | | UL CC is | signalling |
| | for | UL | | | | | | counded as | |
| | UL | transmission | | | | | | one UL CC | |
| | simultaneous | | | | | | | on the | |
| | transmission | | | | | | | support of UL | |
| | | | | | | | | CA band | |
| | | | | | | | | combination(s). | |

The UE FG x-y in [Table 81] may be defined to be the same as the UE FG x-y in [Table 80]. Similarly, when the UE can support the corresponding UE FG x-y in [Table 81], the UE may transmit a UE capability report on the corresponding FG to the BS. At this time, the UE may report the UE capability to the BS by using a higher-layer parameter (for example, a higher-layer parameter having a name for transmitting “Ul_mTRP_simultaneousTx-r18” specified in Field name in TS 38.331 for the corresponding FG x-y in [Table 81] or the same or similar UE capability report. In order to support the corresponding UE FG x-y, the UE may need to support any FG (for example, UE FG 16-2a) that may be supported based on a precondition. For example, when the UE can support the multi-DCI multi-panel-based simultaneous uplink transmission scheme, based on the UE capability for supporting UE CA and the separate UE capability, the UE may transmit a UE capability report on the UE FG x-ya. At this time, the UE may report the UE capability to the BS by using a higher-layer parameter (for example, a higher-layer parameter having a name for transmitting “Ul_additionaParallelProcess_STxMP-r18” specified in field name in TS 38.331 for the corresponding FG x-ya in [Table 81] or the same or similar UE capability report.

In order to support the corresponding UE FG x-ya, the UE may need to support the UE FG x-y, based on a precondition. At this time, when the UE FG x-ya in [Table 81] can be supported, it may not influence the UE capability for supporting uplink CA and the number of supportable uplink carrier components (UL CCs), and the UE may report that an additional parallel process for supporting the multi-DCI multi-panel-based simultaneous uplink transmission scheme can be supported to the BS. That is, when the UE counts carrier components supporting the corresponding UE FG x-ya and the UE reports a band combination considering the corresponding CC to the BS, the UE may count the number of carrier components (CCs) supporting the corresponding UE FG x-ya (or UE feature within the UE FG x-ya) as 1 and report a band combination including the maximum number of UL CCs (or smaller number of UL CCs) which can be supported by the UE to the BS. For example, when the maximum number of UL CCs that can be supported by the UE is 16 (N_{UL,tot}=16) and the UE FG x-ya can be supported only for two CCS (N_{ULSTxMP}=2), the UE may report a band combination including 16 UL CCs (N_{UL,CA}=16) including CCs that can support the corresponding UE FG x-ya to the BS and may support an additional parallel process for the CCs supporting the UE FG x-ya.

[Table 81] is one example and may be defined as another name UE FG that performs the same (or similar) function. Further, the UE FG x-ya in [Table 81] may be defined as another component within the UE FG x-y as shown in [Table 82] rather than defined as a separate FG.

TABLE 82

| | | | Prereq- | Field | Parent | Need of | Need of | | |
|---|---|---|---|---|---|---|---|---|---|
| | | | uisite | name in | IE in | FDD/TDD | FR1/FR2 | | |
| | Feature | | feature | TS | TS | differen- | differen- | | Mandatory/ |
| Index | group | Components | groups | 38.331 | 38.331 | tiation | tiation | Note | Optional |
| x-y | UL | 1) Support | (16- | UI_mTRP_simultan- | FeatureSetUP- | n/a | n/a | 2) candidate | Optional |
| | simultaneous | multi-DCI | 2a) | eousTx-x18 | linkPerCC- | | | value: {1, 2} | with |
| | transmission | based UL | | | v18xx | | | | capability |
| | in the | simultaneous | | | | | | | signalling |
| | same | transmission | | | | | | | |
| | carrier | 2) Support | | | | | | | |
| | | parallel | | | | | | | |
| | | processing for | | | | | | | |
| | | UL | | | | | | | |
| | | transmission | | | | | | | |

As shown in [Table 82], the UE FG x-y may include component 2. Unlike component 2 of the UE FG-xy in [Table 81], the UE may report a candidate value of the number of parallel processes required to support the multi-DCI multi-panel-based simultaneous uplink transmission scheme to the BS. For example, when the UE configures the value for component 2 of the UE FG x-y as 1 and reports the value to the BS, it means that the UE may support the multi-DCI multi-panel-based simultaneous uplink transmission scheme and simultaneously transmit uplink signals without any additional parallel process. For example, when the UE configures the value for component 3 of the UE FG x-y as 2 and reports the value to the BS, it means that the UE may support the multi-DCI multi-panel-based simultaneous uplink transmission scheme, based on the additional parallel process.

Alternatively, component 2 in [Table 82] may be defined as “Support additional parallel processing for UL transmission,” and the UE may configure one of {0, 1} as a candidate value for component 2 and report a UE capability to the BS.

When the candidate value for component 2 is configured as “0,” it may mean that the UE may support the multi-DCI multi-panel-based simultaneous uplink transmission scheme without the additional parallel process. For example, when the candidate value for component 2 is configured as “1,” it may mean that the UE may support the multi-DCI multi-panel-based simultaneous uplink transmission scheme, based on the additional parallel process.

In the above embodiment, it is assumed that K=2, but the candidate value may be defined based on the assumption that K is an integer larger than 2.

The UE FG defined in embodiment 3-3 and the UE FG defined in embodiment 3-4 are defined and described as separate UE FGs. However, this is only for convenience of description, and the UE may report UE capability for one or both of the UE FG defined in embodiment 3-3 and the UE FG defined in embodiment 3-4 to the BS in consideration of both the two UE FGs. At this time, higher-layer parameters for the UE capabilities for the UE FG defined in embodiment 3-3 and the UE FG defined in embodiment 3-4 may have different names.

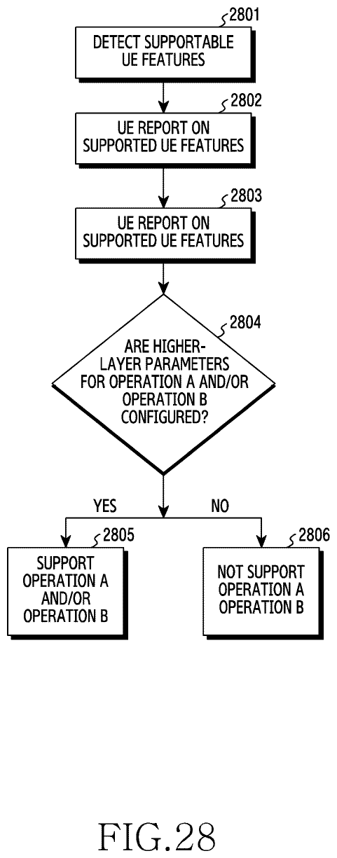

FIG. 28 illustrates a flowchart of an operation of a UE for supporting a multi-TRP transmission and reception scheme based on a plurality of TAs (operation A) or a multi-panel-based simultaneous uplink transmission scheme (operation B) in a multi-DCI system according to an embodiment of the disclosure.

The UE detects UE features which the UE can support among UE features for supporting operation A and/or operation B in the multi-DCI system in operation 2801. At this time, the UE may include not only the UE features described in the third embodiment but also all of the UE features described in the second embodiment and any UE feature that can be associated with the operation described in the first embodiment to consider supportable UE features. The UE may consider other UE features that have not been mentioned in the disclosure as the supportable UE features. Thereafter, the UE transmits a UE capability report on supported UE features in operation 2802. At this time, the UE may configure a candidate value of a higher-layer parameter for the UE report on the corresponding UE feature or configure a field of the corresponding higher layer as a value such as “supported” or “yes” and report the candidate value to the BS. Thereafter, the UE may receive higher-layer parameters for transmission and reception in an NR system from the BS in operation 2803. At this time, the UE may identify whether higher-layer parameters for the operation A and/or higher-layer parameters for the operation B are included in the received higher-layer parameters in operation 2804. For example, when the higher-layer parameters for the operation A and/or higher-layer parameters for the operation B are included in the higher-layer parameters configured by the BS, the UE may support the operation A and/or the operation B in operation 2805. For example, when the higher-layer parameters for the operation A or higher-layer parameters for the operation B are not included in the higher-layer parameters configured by the BS in operation 2804, the UE may not support the operation A or the operation B in which the higher-layer parameters to support the operation are not configured in operation 2806.

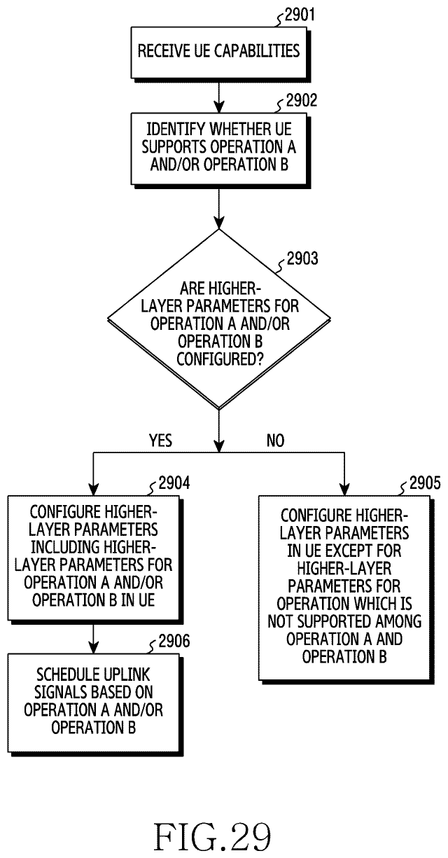

FIG. 29 illustrates a flowchart of an operation of a BS for supporting a multi-TRP transmission and reception scheme based on a plurality of TAs (operation A) or a simultaneous uplink transmission scheme based on multiple panels (operation B) in a multi-DCI system.

The BS may receive UE capabilities from the UE in operation 2901. The BS may identify whether the UE can support operation A and/or operation B, based on the UE capabilities received from the UE in operation 2902. When the BS determines that the corresponding UE can support the operation A and/or the operation B, the BS may determine whether to configure higher-layer parameters for supporting the operation A and/or the operation B in the corresponding UE in operation 2903. At this time, even though the corresponding UE reports UE capabilities to indicate that the operation A or the operation B can be supported, the BS may not configure the higher-layer parameters for supporting the corresponding functions in the UE. Of course, the BS may not configure higher-layer parameters for the corresponding functions in a UE which cannot support the corresponding functions. For example, when the BS determines to configure the higher-layer parameters for the operation A and/or the operation B in the UE, the BS may configure higher-layer parameters including the corresponding parameters in the UE in operation 2904. For example, when the UE determines not to configure the higher-layer parameters for the operation A and/or the operation B in the UE, the BS may configure higher-layer parameters in the UE except for the higher-layer parameters for the operation that is not supported in operation 2905. For example, when the BS has configured the higher-layer parameters for the operation A and/or the operation B in the UE in operation 2904, thereafter, the BS may schedule uplink signals for multi-TRP transmission and reception based on a plurality of TAs or schedule uplink signals simultaneously transmitted based on multiple panels in the multi-DCI system in operation 2906.

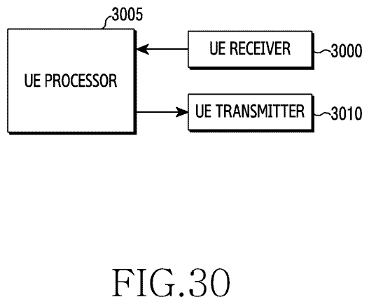

FIG. 30 illustrates a structure of a UE in a wireless communication system according to an embodiment of the disclosure.

Referring to FIG. 30, the UE may include a transceiver, which refers to a UE receiving unit 3000 and a UE transmitting unit 3010 as a whole, a memory (not illustrated), and a UE processing unit 3005 (or UE controller or processor). The UE transceiver 3000 and 3010, the memory, and the UE processing unit 3005 may operate according to the above-described communication methods of the UE. Components of the UE are not limited to the above-described example. For example, the UE may include a larger or smaller number of components than the above-described components. Furthermore, the transceiver, the memory, and the processor may be implemented as a single chip.

The transceiver may transmit/receive signals with the base station. The signals may include control information and data. To this end, the transceiver may include an RF transmitter configured to up-convert and amplify the frequency of transmitted signals, an RF receiver configured to low-noise-amplify received signals and down-convert the frequency thereof, and the like. This is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the UE. In addition, the memory may store control information or data included in signals transmitted/received by the UE The memory may include storage media such as a ROM, a RAM, a hard disk, a CD-ROM, and a DVD, or a combination of storage media. In addition, the UE may include multiple memories.

In addition, the processor may control a series of processes so that the UE can operate according to the above-described embodiments. For example, the processor may control components of the UE to receive DCI configured in two layers so as to simultaneously receive multiple PDSCHs. The UE may include multiple processors, and the processors may perform the UE's component control operations by executing programs stored in the memory.

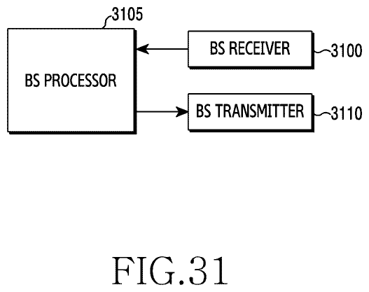

FIG. 31 illustrates a structure of a base station in a wireless communication system according to an embodiment of the disclosure.

Referring to FIG. 31, the base station may include a transceiver, which refers to a base station receiving unit 3100 and a base station transmitting unit 3110 as a whole, a memory (not illustrated), and a base station processing unit 3105 (or base station controller or processor). The base station transceiver 3100 and 3110, the memory, and the base station processing unit 3105 may operate according to the above-described communication methods of the base station. Components of the base station are not limited to the above-described example. For example, the base station may include a larger or smaller number of components than the above-described components. Furthermore, the transceiver, the memory, and the processor may be implemented as a single chip.

The transceiver may transmit/receive signals with the UE. The signals may include control information and data. To this end, the transceiver may include an RF transmitter configured to up-convert and amplify the frequency of transmitted signals, an RF receiver configured to low-noise-amplify received signals and down-convert the frequency thereof, and the like. This is only an embodiment of the transceiver and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the base station. In addition, the memory may store control information or data included in signals transmitted/received by the base station. The memory may include storage media such as a ROM, a RAM, a hard disk, a CD-ROM, and a DVD, or a combination of storage media. In addition, the base station may include multiple memories.

The processor may control a series of processes so that the base station can operate according to the above-described embodiments of the disclosure. For example, the processor may control components of the base station to configure DCI configured in two layers including allocation information regarding multiple PDSCHs and to transmit the same. The base station may include multiple processors, and the processors may perform the base station's component control operations by executing programs stored in the memory.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Furthermore, a plurality of such memories may be included in the electronic device.

Moreover, the programs may be stored in an attachable storage device which may access the electronic device through communication networks such as the Internet, Intranet, local area network (LAN), wide LAN (WLAN), and storage area network (SAN) or a combination thereof. Such a storage device may access the electronic device via an external port. Furthermore, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. That is, it will be apparent to those skilled in the art that other variants based on the technical idea of the disclosure may be implemented. Furthermore, the above respective embodiments may be employed in combination, as necessary. For example, one embodiment of the disclosure may be partially combined with other embodiments to operate a base station and a terminal. As an example, embodiment 1 and 2 of the disclosure may be combined with each other to operate a base station and a terminal. Furthermore, although the above embodiments have been described based on the FDD LTE system, other variants based on the technical idea of the embodiments may be implemented in other systems such as TDD LTE, 5G, or NR systems.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

Furthermore, in methods of the disclosure, some or all of the contents of each embodiment may be combined without departing from the essential spirit and scope of the disclosure.

Various embodiments of the disclosure have been described above. The above description of the disclosure has been given by way of example, and embodiments of the disclosure are not limited to the embodiments disclosed herein. Those skilled in the art will appreciate that the disclosure may be easily modified into other specific forms without departing from the technical idea or essential features of the disclosure. The scope of the disclosure is defined by the appended claims, rather than the above detailed description, and the scope of the disclosure should be construed to include all changes or modifications derived from the meaning and scope of the claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
transmitting, to a base station, UE capability information indicating that the UE is capable of supporting a receiving (Rx) timing difference larger than a cyclic prefix (CP) length; and
performing a parallel processing for operations of multi-transmission and reception points (TRPs), wherein each of the multi-TRPs is associated with a respective timing advance (T_{A}), and
wherein the Rx timing difference is identified as a period between a first downlink (DL) reference timing and a second DL reference timing.

2. The method of claim 1, wherein the UE capability information further includes carrier aggregation band combination information configured based on a carrier component (CC) supporting the Rx timing difference larger than the CP length.

3. The method of claim 1, wherein the UE capability information indicates that the UE is capable of supporting the parallel processing for the operations of the multi-TRPs.

4. The method of claim 1, further comprising:
receiving, from the base station, a plurality of downlink control information (DCI) scheduling a plurality of uplink (UL) transmissions in an overlapping time period; and
performing a simultaneous transmission across multi-panel (STxMP) based on the plurality of DCI,
wherein the UE capability information indicates that the UE is capable of supporting the STxMP.

5. A method performed by a base station in a wireless communication system, the method comprising:
receiving, from a user equipment (UE), UE capability information indicating that the UE is capable of supporting a receiving (Rx) timing difference larger than a cyclic prefix (CP) length;
scheduling operations of multi-transmission and reception points (TRPs) for the UE; and
performing a communication with the UE based on the scheduled operations of the multi-TRPs,
wherein the Rx timing difference is identified as a period between a first downlink (DL) reference timing and a second DL reference timing.

6. The method of claim 5, wherein the UE capability information further includes carrier aggregation band combination information configured based on a carrier component (CC) supporting the Rx timing difference larger than the CP length.

7. The method of claim 6, wherein the UE capability information indicates that the UE is capable of supporting a parallel processing for the operations of the multi-TRPs.

8. The method of claim 7, further comprising:
transmitting, to the UE, a plurality of downlink control information (DCI) scheduling a plurality of uplink (UL) transmissions in an overlapping time period for a simultaneous transmission across multi-panel (STxMP),
wherein the UE capability information indicates that the UE is capable of supporting the STxMP.

9. A user equipment (UE) in a wireless communication system, the UE comprising:
at least one transceiver; and
at least one controller coupled with the at least one transceiver and configured to:
transmit, to a base station, UE capability information indicating that the UE is capable of supporting a receiving (Rx) timing difference larger than a cyclic prefix (CP) length, and
perform a parallel processing for operations of multi-transmission and reception points (TRPs), wherein each of the multi-TRPs is associated with a respective timing advance (T_{A}),
wherein the Rx timing difference is identified as a period between a first downlink (DL) reference timing and a second DL reference timing.

10. The UE of claim 9, wherein the UE capability information further includes carrier aggregation band combination information configured based on a carrier component (CC) supporting the Rx timing difference larger than the CP length.

11. The UE of claim 9, wherein the UE capability information indicates that the UE is capable of supporting the parallel processing for the operations of the multi-TRPs.

12. The UE of claim 9, wherein the at least one controller is further configured to:
receive, from the base station, a plurality of downlink control information (DCI) scheduling a plurality of uplink (UL) transmissions in an overlapping time period; and
perform a simultaneous transmission across multi-panel (STxMP) based on the plurality of DCI,
wherein the UE capability information indicates that the UE is capable of supporting the STxMP.

13. A base station in a wireless communication system, the base station comprising:
at least one transceiver; and
at least one controller coupled with the at least one transceiver and configured to:
receive, from a user equipment (UE), UE capability information indicating that the UE is capable of supporting a receiving (Rx) timing difference larger than a cyclic prefix (CP) length,
schedule operations of multi-transmission and reception points (TRPs) for the UE, and
perform a communication with the UE based on the scheduled operations of the multi-TRPs,
wherein the Rx timing difference is identified as a period between a first downlink (DL) reference timing and a second DL reference timing.

14. The base station of claim 13, wherein the UE capability information further includes carrier aggregation band combination information configured based on a carrier component (CC) supporting the Rx timing difference larger than the CP length.

15. The base station of claim 13, wherein the UE capability information indicates that the UE is capable of supporting a parallel processing for the operations of the multi-TRPs.

16. The base station of claim 13, wherein the at least one controller is further configured to:
transmit, to the UE, a plurality of downlink control information (DCI) scheduling a plurality of uplink (UL) transmissions in an overlapping time period for a simultaneous transmission across multi-panel (STxMP),
wherein the UE capability information indicates that the UE is capable of supporting the STxMP.
